(19) United States
(12) Patent Application Publication
(10) Pub. No.: US 2004/0230549 A1
(43) Pub. Date: Nov. 18, 2004

(54) Systems and methods for behavioral modification and behavioral task training integrated with biofeedback and cognitive skills training

(75) Inventors: Peter A. Freer, Asheville, NC (US); Gwen S. Freer, Asheville, NC (US); Richard A. Clemenzi, Asheville, NC (US)

Correspondence Address: STEVEN C. SCHNEDLER, CARTER SCHNEDLER & MONTEITH, PA, 56 CENTRAL AVE., SUITE 101, PO BOX 2985, ASHEVILLE, NC, 28802, US

(73) Assignee: Unique Logic and Technology, Inc., Asheville, NC

(21) Appl. No.: 10/771,123

(22) Filed: Feb. 3, 2004

Related U.S. Application Data
(60) Provisional application No. 60/444,819, filed on Feb. 3, 2003.

(51) Int. Cl. G06N 5/04; G06F 15/18; G06F 17/00; G06N 5/02

(52) U.S. Cl. 706/61; 706/46

(57) ABSTRACT

Computerized training apparatus which combines electroencephalograph (EEG) based biofeedback attention training with behavior modification support, coaching support, or both.

### CROSS-REFERENCE TO RELATED APPLICATION

The benefit of U.S. Provisional Patent Application Ser. No. 60/444,819 filed Feb. 3, 2003 is claimed.

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### BACKGROUND OF THE INVENTION

The invention relates to electroencephalograph (EEG) based biofeedback attention training, including the disclosures of Freer U.S. Pat. No. 6,097,981 titled “Electroencephalograph Based Biofeedback System And Method;” and Freer U.S. Pat. Nos. 6,402,520 and 6,626,676 titled “Electroencephalograph Based Biofeedback System For Improving Learning Skills.”

### SUMMARY OF THE INVENTION

In one aspect, the invention is embodied in computerized training apparatus including a computer system having a display, an input device and a sound output device; an attention training subsystem including a device for measuring electrical activity of the brain of a. user and software within the computer system to provide real time feedback to the user of the user's state of attention; a behavior modification support subsystem including a database within the computer system for storage of data relating to behavior and behavioral goals, and computer software that presents automated forms for entry of the data into the database and retrieval and reporting the data from the database, the data including data to support one or more of behavioral rating scales, goal setting records, session journals, and progress charts; and a coaching support subsystem including one or more of software within the computer system to generate coaching audio prompts through the sound output device, software within the computer system to generate training audio prompts through the sound output device, and software within the computer system to generate letters and e mail messages for teambuilding support.

In another aspect, the invention is embodied in computerized training apparatus including a computer system including a display and an input device; an attention training subsystem including a device for measuring electrical activity of the brain of a user and software within the computer system to provide real time feedback to the user of the user's state of attention; and a behavior modification support subsystem including a database within the computer system for storage of data relating to behavior and behavioral goals, and computer software that presents automated forms for entry of the data into the database and retrieval and reporting the data from the database, the data including data to support one or more of behavioral rating scales, goal setting records, session journals, and progress charts.

In yet another aspect, the invention is embodied in computerized training apparatus including a computer system having a display, an input device and a sound output device; an attention training subsystem including a device for measuring electrical activity of the brain of a user and software within the computer system to provide real time feedback to the user of the user's state of attention; and a coaching support subsystem including one or more of software within the computer system to generate coaching audio prompts through the sound output device, software within the computer system to generate training audio prompts through the sound output device, and software within the computer system to generate letters and e mail messages for teambuilding support.

### BRIEF DESCRIPTION OF THE DRAWINGS

FIG. 1 is a representation of a computerized training apparatus embodying the invention;

FIG. 2 is a simplified block diagram including a representation of software and data stored in computer memory within the apparatus of FIG. 1;

FIG. 3 is a screen image of a Voice Prompt Control dialog box;

FIG. 4 is a screen image of a Voice Prompt Control Advanced dialog box;

FIG. 5 is a screen image of a System Administrator Login dialog box;

FIG. 6 is a screen image of a System Administration/Registered User List dialog box;

FIG. 7 is a screen image of a General Site Info (Site Record) dialog box;

FIG. 8 is a screen image of a Hardware Configuration dialog box;

FIG. 9 is a program flowchart representing User Login operations;

FIG. 10 is program flowchart representing: Start Session operations;

FIG. 11 is a screen image of a User Login dialog box;

FIG. 12 is a screen image of a User Record: General Info dialog box;

FIG. 13 is a screen image of a User Record: Contact Info dialog box;

FIG. 14 is a screen image of a Coach Record: General Info dialog box;

FIG. 15 is a screen image of a Coach Record: Coach Controls dialog box;

FIG. 16 is a screen image of a Coach's Session Rating Scale (CSRS) dialog box;

FIG. 17 is a screen image of a CSRS—After Game Play Version dialog box;

FIG. 18 is a screen image of a CSRS—With Behavior Selected dialog box;

FIG. 19 is a screen image of a CSRS—Review Existing Form dialog box;

FIG. 20 is a screen image of a CSRS—With OnTask Data Identified dialog box;

FIG. 21 is a screen image of a Session Progress Chart dialog box;

FIG. 22 is a screen image of a Progress Chart & Journal dialog box;

FIG. 23 is a screen image of a Main Menu dialog box;

FIG. 24 is a screen image of a progress Chart & Journal With Info dialog box;

FIG. 25 is a screen image of a User Status Summary dialog box;

FIG. 26 is a screen image of an Action Needed dialog box;

FIG. 27 is a screen image of a Baseline display;

FIG. 28 is a screen image of a data display;

FIG. 29 is a screen image of the game Glider;

FIG. 30 is a screen image of the game Diver;

FIG. 31 is a screen image of the game Skitter;

FIG. 32 is a screen image of the game Hopper;

FIG. 33 is a screen image of the game Tower Builder;

FIG. 34 is a screen image of the game MindMaze;

FIG. 35 is a screen image of the game Starflyer

FIG. 36 is a screen image of a User Data Menu dialog box;

FIG. 37 is a screen image of a Level 1 Trend Data Graph dialog box;

FIG. 38 is a screen image of a Level 4 Trend Data Graph dialog box;

FIG. 39 is a screen image of a Data Output Selection: All Records dialog box;

FIG. 40 is a screen image of a Display All Data (Text) dialog box;

FIG. 41 is a screen image of a Display Session Data dialog box;

FIG. 42 is a screen image of a Data Output Selection: Level 4 dialog box;

FIG. 43 is a screen image of a Data Output Selection: Level 4 dialog box;

FIG. 44 is a screen image of a Level 4 Data Graph dialog box;

FIG. 45 is a screen image of an Admin Menu dialog box;

FIG. 46 is a screen image of a Compare User Data: File Selection dialog box;

FIG. 47 is a screen image of a Compare User Data: Level 4 Combined Graph dialog box;

FIG. 48 is a screen image of an Edit User Info Menu Selection dialog box;

FIG. 49 is a screen image of a User Record: General Info dialog box;

FIG. 50 is a screen image of a User Record: Contact Info dialog box;

FIG. 51 is a screen image of a User Record: Address dialog box;

FIG. 52 is a screen image of an Import/Export Selection dialog box;

FIG. 53 is a screen image of an Import File Selection dialog box;

FIG. 54 is a screen image of a Close User Data Warning dialog box;

FIG. 55 is a screen image of a Select Directory dialog box;

FIG. 56 is a screen image of a Site Log dialog box;

FIG. 57 is a screen image of a Tech Support E-Mail dialog box;

FIG. 58 is a screen image of a Communications Test dialog box;

FIG. 58A is a screen image of a Communications Test Graph dialog box;

FIG. 59 is a screen image of an Admin Help dialog box;

FIG. 60 is a screen image of a Coach Menu dialog box;

FIG. 61 is a screen image of a CSRS Notes Form dialog box;

FIG. 62 is a screen image of a Parent/Teacher Rating Scale dialog box;

FIG. 63 is a screen image of a Parental Permission Form dialog box;

FIG. 64 is a screen image of a Print Coach Forms dialog box;

FIG. 64A is a screen image of a Display All Coach Records dialog box;

FIG. 65 is a screen image of a Parent/Teacher Contact Menu dialog box;

FIG. 66 is a screen image of a View All Data dialog box;

FIG. 67 is a screen image of an Action Needed dialog box;

FIG. 68 is a screen image of a Parent/Teacher Letter dialog box;

FIG. 69 is a screen image of a Parent/Teacher Letter Notice dialog box;

FIG. 70 is a screen image of a Parent/Teacher E-Mail dialog box;

FIG. 71 is a screen image of a Parent/Teacher Contact Record dialog box;

FIG. 72 is a screen image of an EduSupport Request dialog box;

FIG. 73 is a screen image of a Coach Help dialog box;

FIG. 74 is a program flowchart representing Baseline operations;

FIG. 75 is a program flowchart representing Game Play operations;

FIG. 76 is a s program flowchart representing Logout operations;

FIG. 77 is a screen image of a Time To Begin Objectives dialog box;

FIG. 78 is a screen image of a Coach Introduction dialog box;

FIG. 79 is a screen image of a User Rules dialog box;

FIG. 80 is a screen image of a No Objective Warning dialog box;

### DETAILED DESCRIPTION

### Attention Training System Overview

The invention disclosed herein is embodied in current versions of the Play Attention® integrated attention training system, which is a product of Unique Logic and Technology, Inc. (UL+T). Aspects of the Play Attention® integrated attention training system are disclosed in the above-identified Freer U.S. Pat. No. 6,097,981 titled “Electroencephalograph Based Biofeedback System And Method” and Freer U.S. Pat. Nos. 6,402,520 and 6,626,676 titled “Electroencephalograph Based Biofeedback System For Improving Learning Skills,” the entire disclosures of which are hereby expressly incorporated by reference. For convenience of description, embodiments of the invention are sometimes referred to hereinbelow as “Play Attention.” Attention training exercises, which have a resemblance to computer games, but which actually are educational exercises, are implemented. The attention training exercises are sometimes referred to herein as “games.” Specific names of the games, all described in detail hereinbelow, are “Glider,” “Diver,” “Skitter,” “Hopper,” “Tower Builder,” “Mind Maze” and “Starflyer.”

The invention is embodied in computerized training apparatus which combines electroencephalograph (EEG) based biofeedback attention training with behavior modification support, coaching support, or both, in a manner which facilitates transfer and generalization of attention skills and behavioral changes into the general environment of a user, also referred to herein as the trainee or the student.

More particularly, the invention is embodied in a system which integrates and automates a program of biofeedback enhanced attention training exercises with a complete behavior modification regimen to systematically modify or shape behavior in order to enhance the effectiveness of such attention training. Computerized training apparatus embodying the invention provides multidimensional support for aspects of attention training needed to effectively, consistently, and predictably obtain transfer and generalization of attention and behavioral learnings from the direct training environment so as to substantially improve the likelihood of ultimate success in changing the student's attention skills in all environments.

The behavior modification component, also referred to herein as Behavioral Modification Support, involves training goal-oriented self-control through operant conditioning which provides immediate positive and negative reinforcers. A program of incremental objective-based training is effected to one-by-one eliminate or reduce those behaviors or habits which limit the student's ability to pay focused attention, and to improve behaviors and habits necessary for successful attention skills. Behavioral objectives are set by mutual agreement between the student and a coach, and the identified behavior is observed and the number of occurrences recorded by the coach during training with review and follow-up both subsequent to and during training. The objectives and learnings are also communicated with the student's parents and teachers to create a total environment to support and extend the changes achieved in the direct training session to the student's broader life.

The behavioral modification/shaping portion of embodiments of the invention includes:

(a) integrated monitoring tools;

(b) integrated assessment tools;

(c) external monitoring tools; and

(d) personal evaluation components.

Experience with the use of a less structured form of behavioral modification with attention training in numerous school, professional, and home sites has shown that ultimate success, as measured by transfer and integration of the learned attention skills into the student's life, is directly proportional to the thoroughness of the coach in applying the requisite behavioral modification techniques. Additional experience from clinical use of biofeedback-based attention training without a systematic behavior modification component indicates even a lower rate of ultimate success of skill transfer. Embodiments of the invention represent a significant improvement in the practice of attention training by formalizing and regulating the integration of behavioral modification and teamwork in a format that most likely guarantees success. Portions of embodiments of the invention that support this formalization and regulation in the practice of attention training are also referred to herein as Coaching Support, which furthermore includes the portions providing support for teamwork.

A representative comprehensive system embodying the invention includes the following general components:

1. An automated biofeedback-based attention training system;

2. A rating scale for typical aberrant behaviors and habits exhibited by attention challenged individuals to be used during attention training sessions by the coach;

3. Guidelines and tools to build a support team framework of coach, parents, teachers to support generalization of learned skills;

4. A system of periodic behavior ratings by each support team member;

5. An automated system to record and store attention training data, training session behavior data, and periodic support team rating data;

6. A system to provide reflection of training session behavioral data both for the current session and to compare multiple sessions;

7. A system to facilitate easy communication and coordination between team members;

8. A status review component which indicates to the coach any component of the integrated attention/behavior modification regimen which has not been completed or is not current, and which allows the coach to easily complete that missing component;

9. A session management component which forces completion of required and prerequisite components at the appropriate times and in the correct order within each session;

10. A training management component which forces the coach to perform specific components of the specified training regimen on a schedule based on either the number of trainings, the number of hours of training, and elapsed time in days or months; and

11. An integrated coach training program including tutorial voice prompts to teach the coach how and when to interact with the student for maximum success.

In some embodiments of the invention, the effects of practice with the computerized training equipment are further enhanced or reinforced during execution of attention training exercises (game playing) through use of attention training exercises resembling games or game systems that are designed to foster similar or complementary skills or characteristics.

A representative comprehensive system embodying the invention more particularly includes the following:

1. Computerized training equipment for enhancing mental skills, physical or physiological activity, or behavioral characteristics, through the user's interactions with the system;

2 External behavioral assessment apparatus for monitoring and quantifying the trainee's behaviors;

3. Control software integral to, or separate from but connected to, computer software of the computerized training equipment, which

(i) calculates time of use and initiates the setting of specific behavioral goals dependent on the trainee's success at the training tasks,

(ii) allows input of external quantified behavioral data (QBD) to be stored in the trainee's database,

(iii) outputs the quantified behavioral data to provide the trainee through visual, auditory or other means a means of examining QBD to provide an immediate positive or negative reinforcer,

(iv) stores QBD in a designated trainee database,

(v) outputs the stored QBD to provide the administrator through visual, auditory or other means a means of examining QBD over several sessions or more to provide a long term evaluation of the trainee's behavior, and

(vi) outputs the stored QBD to provide the trainee through visual, auditory or other means a means of examining QBD over several sessions or more to provide positive or negative reinforcer of the trainee's behavior over time;

4. A subsystem which enables the trainee to summarize and reflect on the training, which subsystem is operational upon logging out of training to provide the trainee through visual, auditory or other means:

(i) closure and documentation of the learned lesson as a behavioral reinforcer, and

(ii) a way to define behavioral goals to be established for the next training session;

5. A subsystem which enables the trainee to continue modifying the previous behavioral objective or setting a new behavioral objective which is operational upon the subsequent login of the trainee to provide the trainee through visual, auditory or other means continuity of training and behavioral augmentation and act as an initial reinforcer;

6. A subsystem which enables the trainee to play a computer game or video game, such as game software, hardware, and user input device (This game subsystem may be separate from but connected to the computerized training equipment, or alternatively, game software may run on the same computer and utilize the same input methods as the computerized training equipment.); and

7. A means of controlling the game subsystem, including hardware and/or software, to enable and disable the game subsystem at appropriate times, and to further regulate or control the user interaction with the game subsystem so as to enhance or reinforce the effects of practice with the computerized training equipment.

A representative comprehensive method embodying the invention more particularly comprises:

1. Continuous numerical calculation according to a predetermined software algorithm of earned game play time, based on the quality of the trainee's (user's) training task performance with the computerized training equipment;

2. Provision of automated or manual behavioral information input device to store data regarding behaviors exhibited during training;

3. Provision of continuous or intermittent information to the trainee via visual, auditory or other means, in the form of a behavioral graph, chart, or other embodiment directly reflecting the ability or inability to control the behavioral goal providing immediate positive or negative reinforcement;

4 Invitation to the trainee via visual, auditory or other means, to actively participate in the modification and control of behaviors exhibited during training;

5. Provision of continuous or intermittent information to the trainee during game play about the quality of game play, through auditory, visual or other means;

6. Reactivation of the computerized training tasks (when appropriate) after game play is terminated; and

7. Control of the game playing session to enhance or reinforce the effects of practice with the computerized training equipment.

### Hardware and Software Overview

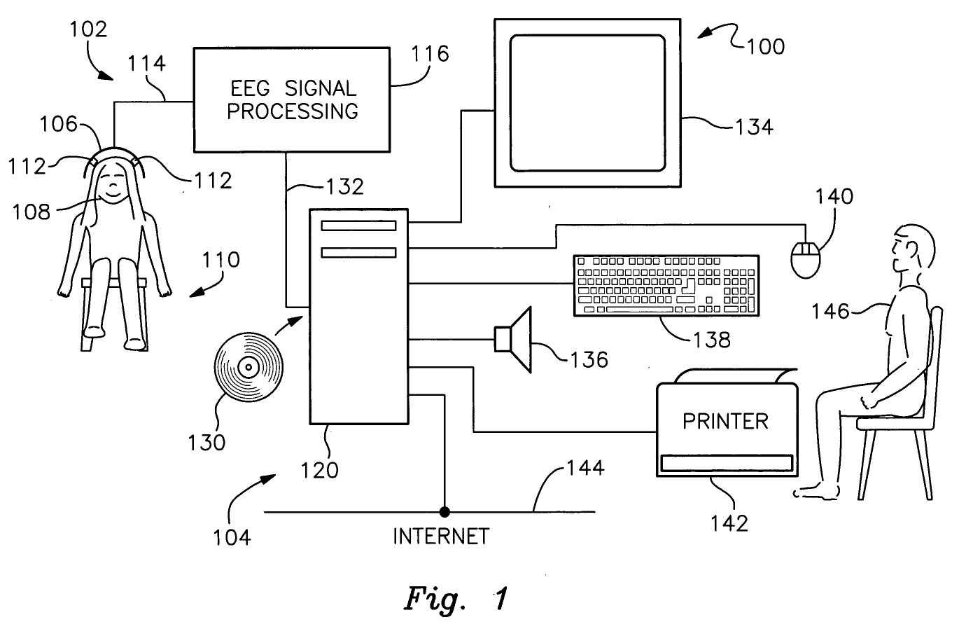

Referring now to FIG. 1, exemplary computerized training apparatus embodying the invention is generally designated 100. For biofeedback, the apparatus 100 includes electroencephalograph (EEG) hardware 102, as well as a computer system 104, such as a personal computer system (PC) 104. The computer system 104 is a programmed computer system including both hardware and software. The terms “programming” and “software” are employed interchangeably herein.

Details of the EEG hardware 102, as well as details of attention training exercises implemented by the EEG hardware 102 and software executing within the computer system 104, are described in the above-incorporated Freer U.S. Pat. Nos. 6,097,981, 6,402,520 and 6,626,676. Briefly, the EEG hardware 102 includes a helmet 106, such as a modified bicycle helmet 106, placed over the head 108 of a user 110. The helmet 106 has appropriately located electrodes 112 for sensing electrical (brainwave) activity of the user 108, in particular electrical activity which is indicative of levels of focus and cognitive processing. The electrodes 112 are connected via a line 114 to EEG signal processing hardware 116, which includes circuit components such as amplifiers and filters. Portions of the requisite EEG signal processing may be accomplished by software executing within the computer system 104.

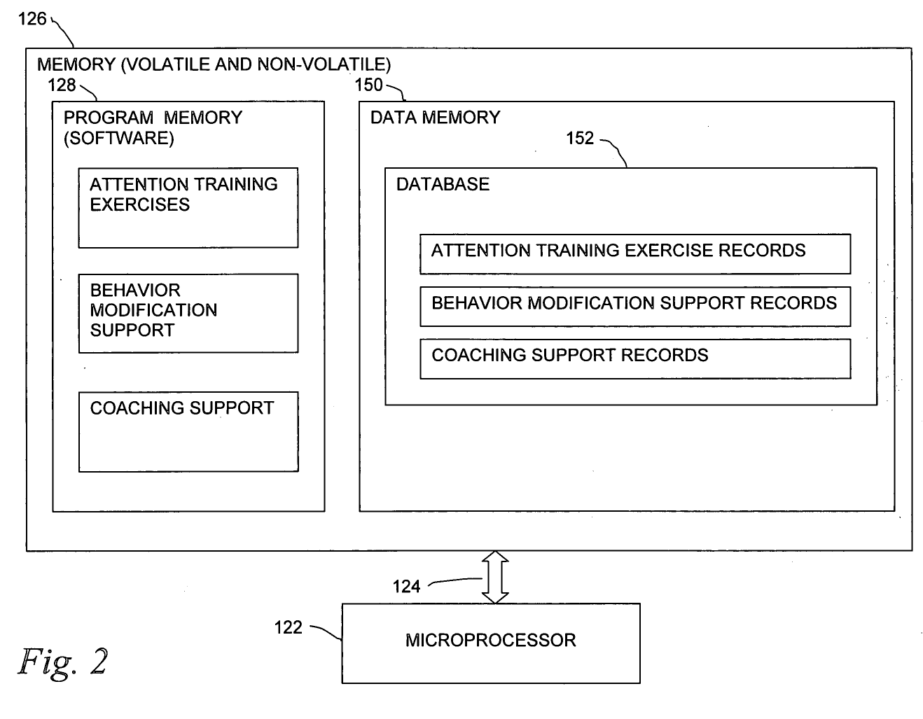

The computer system 104 may include a computer running Microsoft Windows 95-2000 or XP, or an Apple Macintosh OS9-10, or a Unix system, as examples. The computer system 104 includes a conventional CPU box 120. Referring additionally to FIG. 2, the CPU box 120, contains a microprocessor 122, connected via a bus 124 to memory represented generally at 126 and which is a conventional combination of volatile (e.g. RAM) memory and non-volatile memory (e.g. a hard disk drive). The computer memory 126 conceptually is organized to include program memory 128 which contains computer software, typically initially embodied in a computer readable media 130 (FIG. 1), such as a magnetic disk or a CD-ROM, and loaded into the computer system 104 by insertion into an appropriate slot or drive (not shown) in the CPU box 120 in a conventional manner.

The EEG signal processing hardware 114 is connected to an input port on the CPU box 120 via a line 132. The computer system 104 includes several peripheral devices connected to the CPU box 120, including a display screen 134 for output and a sound output device 136 in the form of a speaker 136. Input devices include a computer keyboard 138 and a mouse 140. For outputting letters and printed reports in general, a printer 142 is connected to the CPU box 120. For communication purposes, in particular for sending e-mail messages to parents and teachers as is described hereinbelow, the computer system is connected to the internet, represented at 144.

Also represented in FIG. 1, in addition to the user 110, is a representation of a coach 146. Coaching support is an aspect of the invention, as is further described hereinbelow.

Referring more particularly to FIG. 2, the program memory 128 contains, among other things, software for implementing attention training exercises, such as the attention training exercises disclosed in the above-incorporated Freer U.S. Pat. Nos. 6,402,520 and 6,626,676, software for implementing behavior modification support including behavioral rating scales, goal setting records, session journals and progress charts; and software for implementing coaching support; all described in detail hereinbelow.

The memory 126 conceptually is further organized to include data memory 150, in turn containing a database 152. Data stored within the database 152 includes records in support of attention training exercises, behavior modification support and coaching support, all described in detail hereinbelow.

### Introduction to Play Attention ©2003 Unique Logic and Technology, Inc

The Play Attention Interactive Learning Tool is to be incorporated as an integral component of an overall plan to develop attention and metacognitive skills with children and adults. It is intended to assist the individual in developing and understanding his/her potential in controlling attention and behavior. By using Play Attention combined with an appropriate learning environment, positive reinforcement, study skills, coping skills, and other programs, the user learns to greatly improve attention and behavior. This use of Play Attention is also herein referred to generally as Attention Training.

### How Play Attention Works ©2003 Unique Logic and Technology, Inc

Play Attention includes a fin helmet similar to the ones commonly used for roller-blading, biking, etc., and game-like video exercises that run on almost any computer. The Play Attention helmet includes the electrodes 112 for sensing electrical (brainwave) activity of the user 108, in particular electrical activity which is indicative of levels of focus (attentive state) and cognitive processing. By maintaining an attentive state, the user moves and controls screen characters. Attention is no longer an abstract concept: Attention is now concrete and controllable.

Using Play Attention is often the first time a person has ever seen his attentive state in real-time. That is because while these specially adapted games are played by the user, the helmet electrodes 1 12, in combination with the signal processing hardware 1 14 and associated software, measure levels of attention and transmit this information back to software implementing the attention training exercises (games). This software allows the games to provide immediate feedback about attention levels. And, over time, the user learns how it feels to focus and develops the skills that can help him or her concentrate and become a successful learner.

Feedback is given to the user by the images on the screen and tones.

Primary levels I-V have been developed to teach the user how to use Play Attention to pay better attention. The user is taught not only to pay attention to the computer, but more importantly, to become more aware of his or her physical and brain states most conducive to attention.

### Using Play Attention—Overview

### Levels ©2003 Unique Logic and Technology, Inc

Even though they are listed as “Levels” to delineate distinct cognitive skill building activities, Levels I-V are not hierarchical and therefore do not require mastery of one before moving to another. These cognitive skill building activities are herein also referred to as Attention Training Exercises based on their application in conjunction with attention training protocol EEG-based feedback.

Each level has its own student goals and objectives, and are defined herein with reference to Level I, Level II, Level III, Level IV, and Level V. However, an underlying goal for all levels is to gradually and progressively assist the student to play each level for a full five minutes without interruption. Most students fatigue quickly and must work through many sessions to achieve this. Other students may be able to play for a full five minutes immediately and then regress over time to slowly build back up to the full five minutes.

### Beginner, Intermediate and Advanced Skill Options ©2003 Unique Logic and Technology, Inc

Beginner, Intermediate and Advanced skill options are available in all levels. Level I, Glider or Diver Intermediate and Advanced skill options present opposing screen characters at random intervals flying in a collision course from the right side of the screen. These distracters must be intercepted with the use of the spacebar. Level II, Skitter or Hopper, presents a dragonfly distracter at random intervals which must be acknowledged by pressing the spacebar. Tower Builder's Intermediate and Advanced skill options require more blocks and increased time for completion as well as distracters in the form of flashing blocks and auditory prompts to which the user must press the spacebar in response. Mind Maze's Intermediate and Advanced skill options begin with three and four blocks respectively, however, the sequencing practice remains the same. Starflyer's Beginner skill option has a black background and asteroids that approach from the center of the screen. Intermediate skill option incorporates a star field for distraction while the asteroids approach from the center of the screen. Starflyer's Advanced skill option displays asteroids flying from random edges of the computer screen coupled with a simulated star field for greater distraction.

If a student is consistently achieving good results on his current skill option (usually 80% on-task or greater), it may be time to move to the next skill option. If a student is subject to attention fatigue, the coach should wait until the student consistently demonstrates stamina and success on his current skill option before advancing to the next skill option. The student should be assessed over four to five sessions to determine whether the student is ready to begin the next skill option. If the student has transitioned properly from one skill option to the next, it is usually not necessary to return to the previous skill option. It is detrimental to allow the student to randomly select skill options, as this practice often leads to frustration and inconsistency. Therefore, if the coach determines that the student should move to the next skill option, the student should be advanced and not returned to the previous skill option unless the student finds his current level too difficult. If the student's ability is assessed correctly, return to previous skill options is seldom required.

### Voice Prompts

Voice prompts are used throughout Play Attention, generated by software within the computer system 104 and output via the speaker 136. There are two distinct types of voice prompts. Training voice prompts are directed to the coach 146. Coaching voice prompts are primarily directed to the user 110, and additionally serve to train the coach 146. In general, both the user 110 and the coach 146 hear all the voice prompts. Thus, the coaching voice prompts are intended to assist or replace the coach in performing his or her role in the attention training regimen. Training prompts are included to initially train the coach in proper use of the attention training system. These include directions on how to fill out a specific form or set a parameter correctly. The coaching voice prompts are used to help the student identify objectives or understand the rules by which he will use Play Attention.

For proper use of Play Attention certain voice prompts are used at each session and cannot be turned off. Many voice prompts are intended to be training aids for both the student and coach. Once the coach and student have become familiar with using Play Attention, those voice prompts may be turned off. This can be done in two ways. The first and simplest way to turn off coaching prompts is to click on a speaker icon in the upper corner of the form currently being viewed which produces a audio prompt control form with all the necessary options for controlling prompts individually, on a session basis, or permanently.

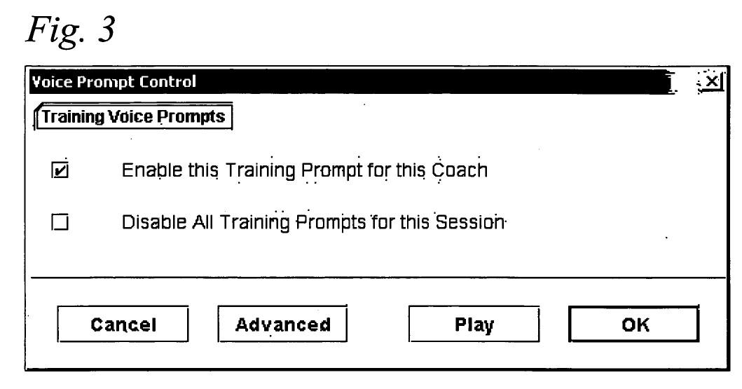

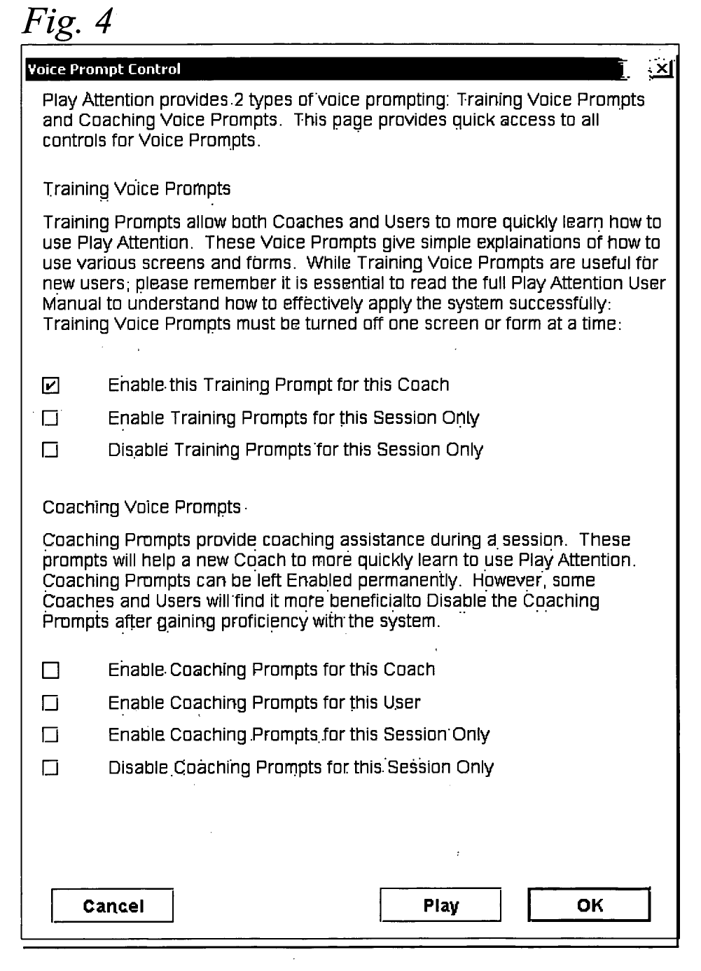

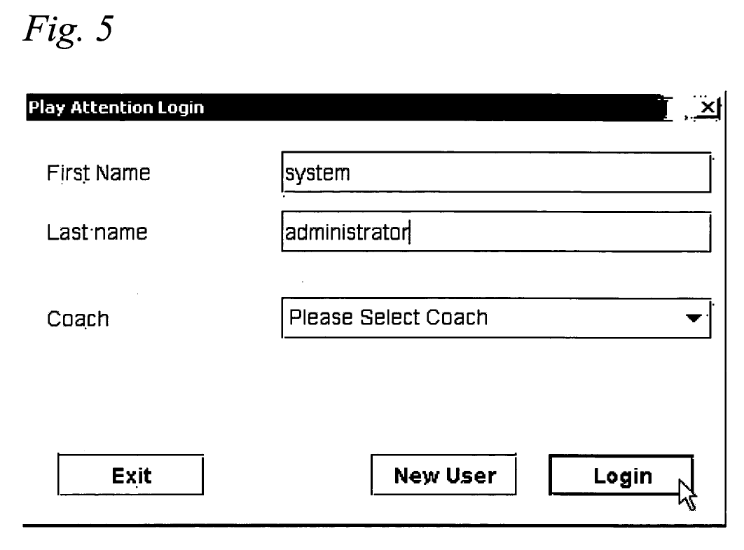

Clicking on the speaker icon produces the menu of FIG. 3. Clicking on the box next to Disable All Training Prompts for this Session turns off the coach's audio prompts. Clicking <Cancel> returns to the form without changing any defaults. Clicking on<Advanced> results in the menu of FIG. 4. The Advanced menu includes various selections regarding both training and coaching prompts. For example, the coach may decide to turn off training prompts for the current session or turn off training prompts entirely for every session. Since the prompts are implemented to train the coach in the proper use of Play Attention, they should not be turned off unless the coach has fully mastered Play Attention.

### System Administration

To fully edit all site information, a person can login as a System Administrator in the manner illustrated in FIG. 5 and described below. It is important that this login not be disclosed to students, because all site record information can be altered and or deleted from this login. Once logged as a System Adminisirator, a person is able to edit all site information including adding or deleting coaches, changing site contact information, editing student contact information, and changing coaching control parameters.

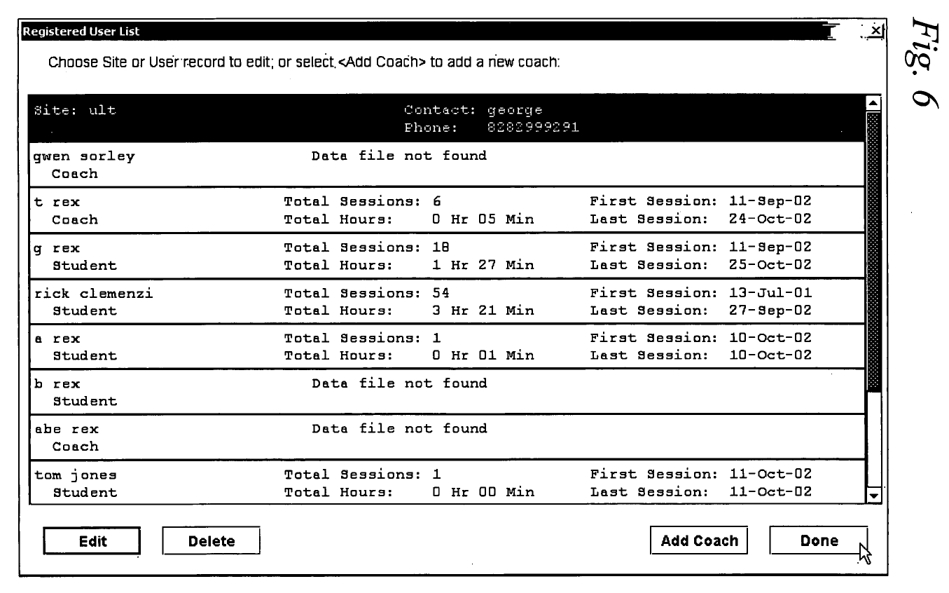

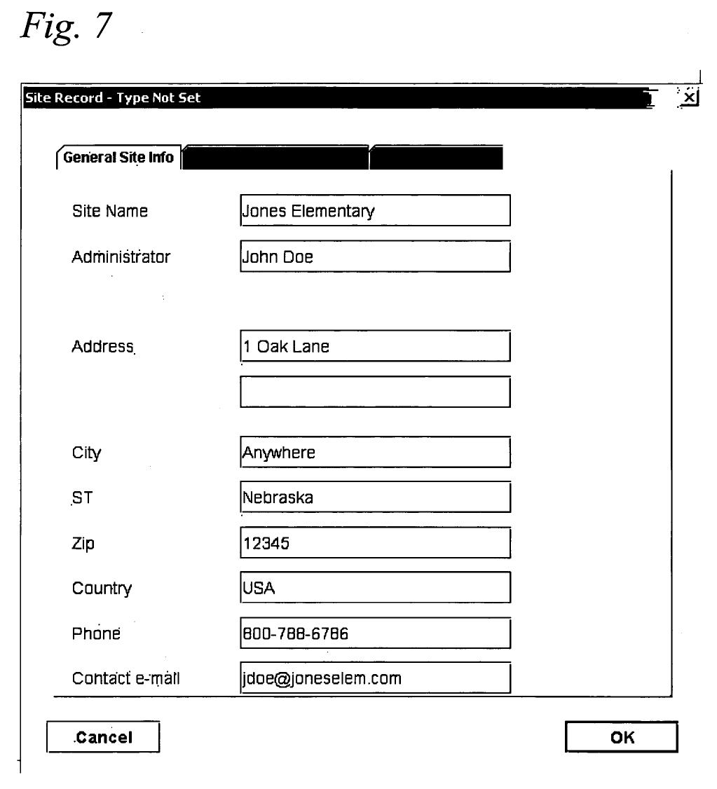

The software displays a list of all current users, coaches, and site record information that was input at program startup after installation, as represented by FIG. 6. Editing instructions are: double click on the user or coach you wish to edit or single click to highlight and click <Edit>. Related information will be displayed. You may modify this information as needed. To delete a coach or student, single click on a particular student or coach or use the up and down arrows to highlight the coach or student, then click <Delete>. This action is not reversible. To add a coach, simply click <Add Coach> and enter the coach's information in the appropriate areas. When you are finished editing site information, click <Done>.

The first item in the list defaults to Site: xxxx indicating your site information. Double clicking on this information, which was originally completed during startup after installation, will produce menus in which you can edit site information. Site Information is discussed next below.

### Editing Site Information

Double clicking on Site: xxxx produces the menu of FIG. 7. The information may be edited as needed. Three tabs are displayed on the menu of FIG. 7. They are General Site Info, Default Coaching Controls, and HW-Multi-station. Clicking on each tab produces a different menu with controls for coaching functions and hardware. The following sections address the Default Coaching Controls and HW-Multi-station menu selections.

### Default Coaching Controls

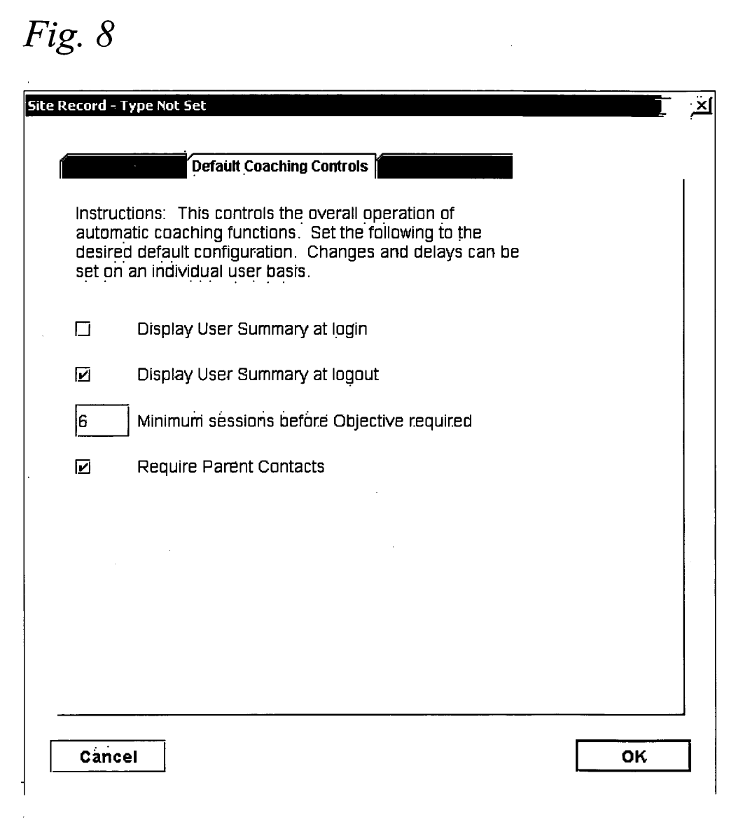

Clicking on the Default Coaching Controls tab produces the menu of FIG. 8. The Display User Summary at login and logout settings may be changed here, but it is highly recommended that they be left unchanged. This screen contains parameters for controlling when certain forms are presented, when Behavioral Objectives must be set.

### Login

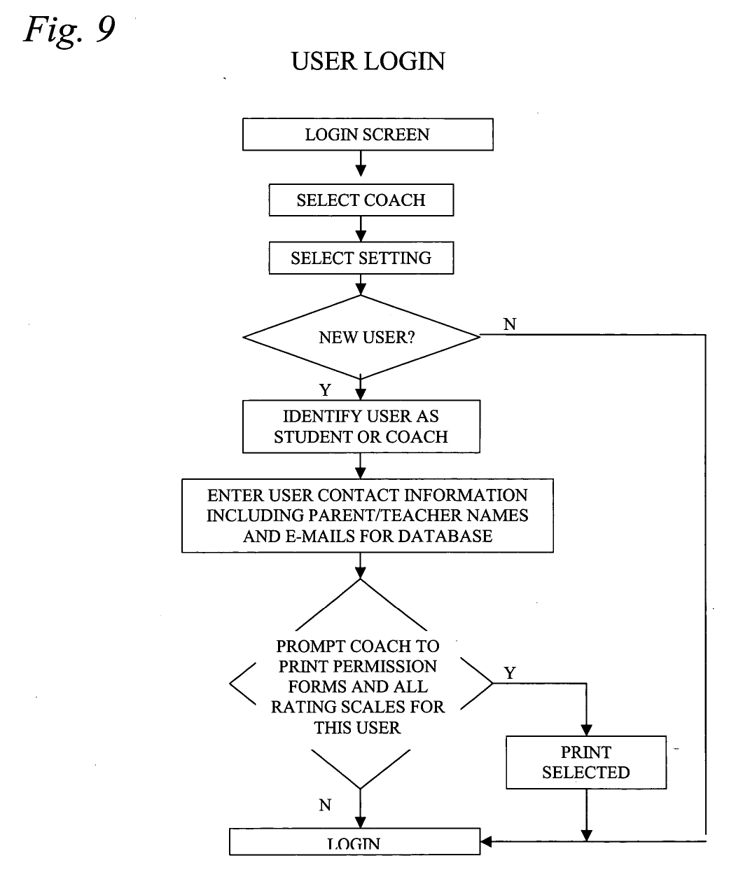

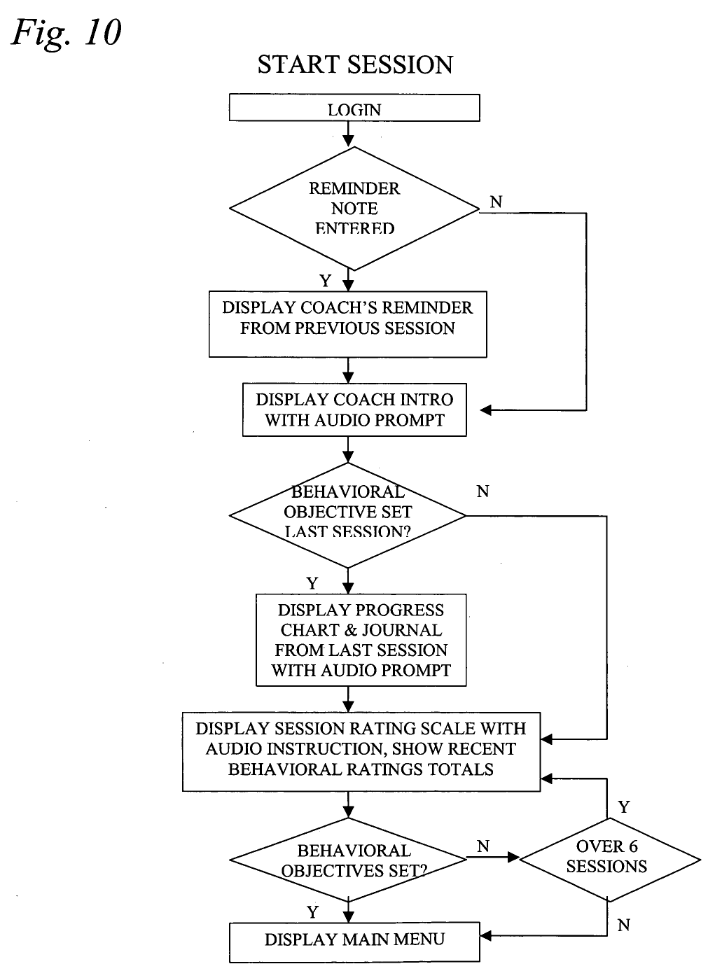

FIG. 9 is a program flowchart captioned “User Login” representing operations performed and directed by the software during user login, and FIG. 10 is a program flowchart captioned “Start Session” representing operations subsequent operations performed and directed by the software, as described next below with reference to exemplary screens presented by the software.

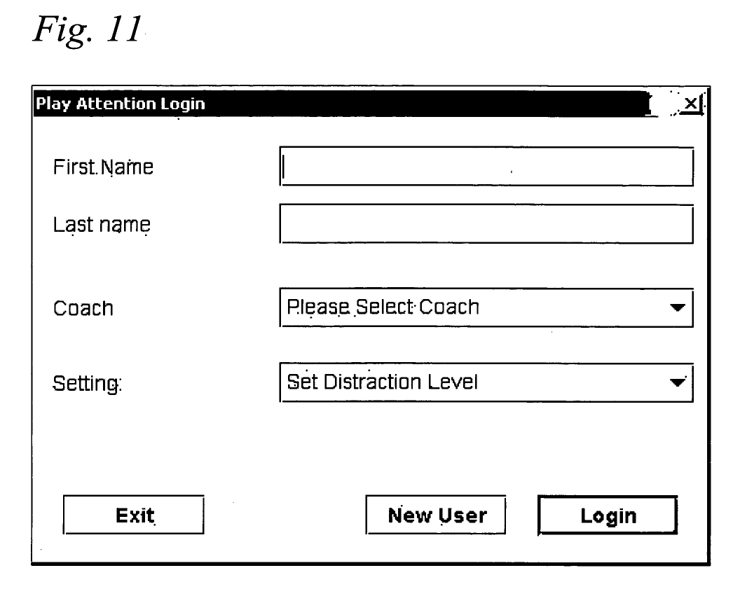

FIG. 11 shows a login screen which requires a user to login each time Play Attention is started. This allows the software to save the user's data in a specific file. This file can be accessed in the future to examine and print a detailed progress report.

Instructions are: Click on the down arrow located next to Coach and Setting. Select the person who will serve as coach for the current user by clicking on the appropriate name. Select the Distraction Level appropriate for the training location. Remember to begin in a very low to no distraction location for best results. The Distraction Level will be indicated in the student's data. Also note that if you are logging in as a Coach, you will not need to select a coach or distraction level. If the user has logged in before, simply click on<Login> to begin. If the user has not logged in before, click on<New> for Play Attention to recognize and accept the user. New Login is described next.

### New Student or Coach Login

When <New User> has been selected in the login screen of FIG. 1, a menu is displayed requesting the user to identify himself as either a student or a coach. Select the desired identification and login.

If the student or coach is logging in for the first time, a menu is displayed requesting information. It is important to enter the information as correspondence with parents, teachers, and Play Attention educational and technical support is facilitated by this information. Completing information requests at this juncture greatly reduces future work and increases the likelihood of program success.

When a new student is logged in, menus display the General, Contact, Address, and Coach Control information tabs. Each tab is accessed by clicking on it. Each tab requires separate and distinct information.

### General Information

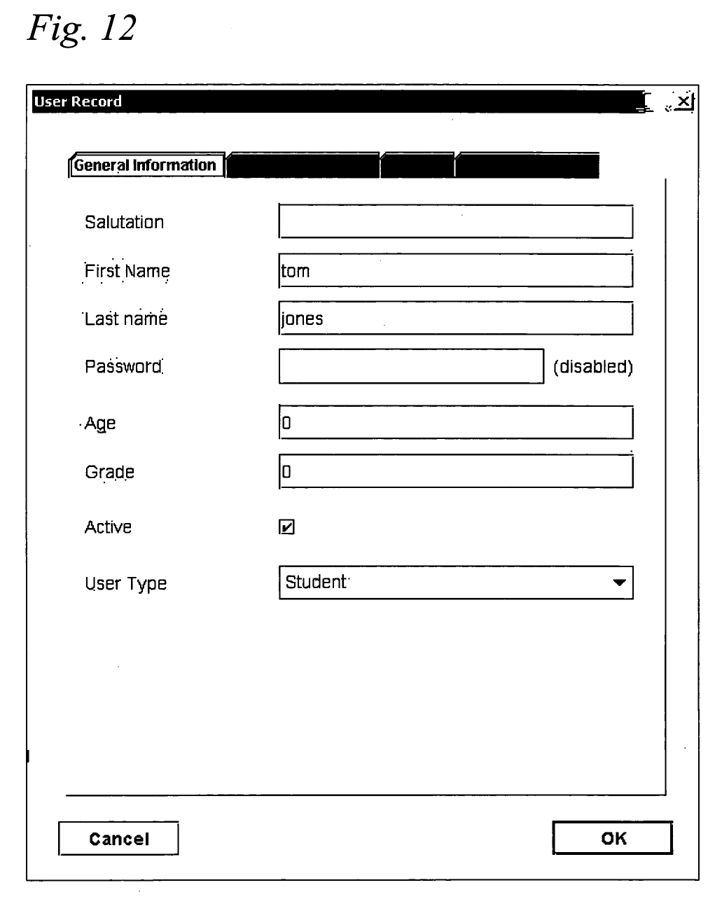

FIG. 12 shows the General Information tab. Complete the name, age, and grade of the current student (user). A password is not required nor recommended unless data need to be secured in a multi-user condition. Most home and institutional users will not need a password. Be certain a check is placed in the box next to the Active menu selection. In the User Type field, identify the user as a coach or student.

### Contact Information

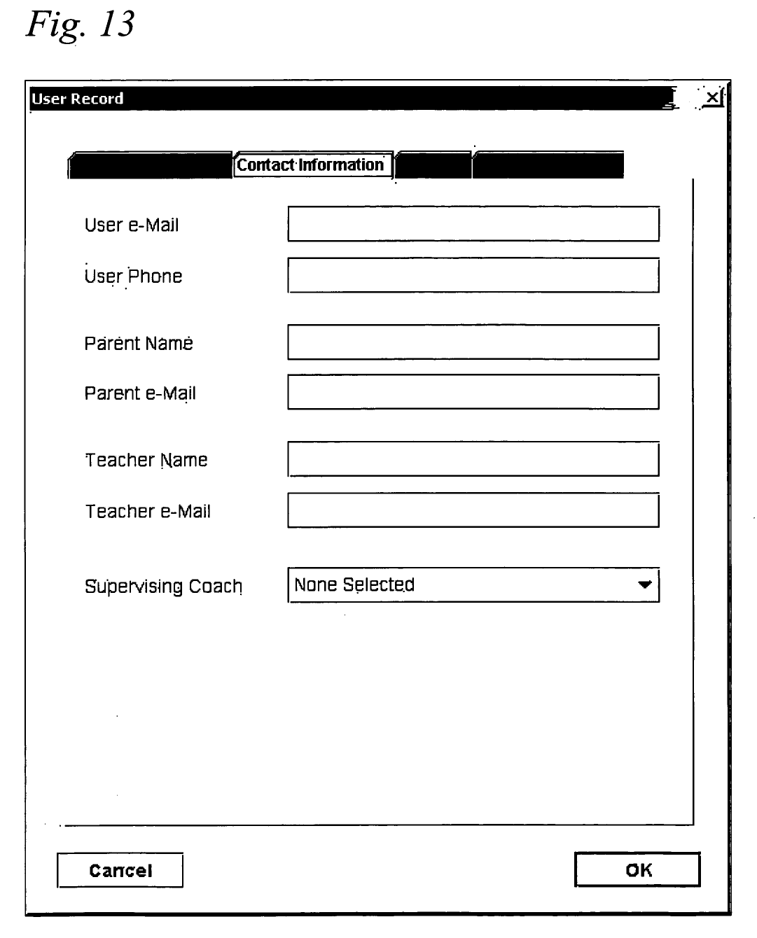

FIG. 13 shows the Contact Information tab. Be certain to complete the user's name, telephone, and e-mail information. Complete the parent and teacher information if applicable. A supervising coach should also be selected. This ensures that all parties responsible for the student are kept informed of student progress. This also helps ensure transfer, generalization, and reinforcement of Play Attention training.

### Coach Control Information

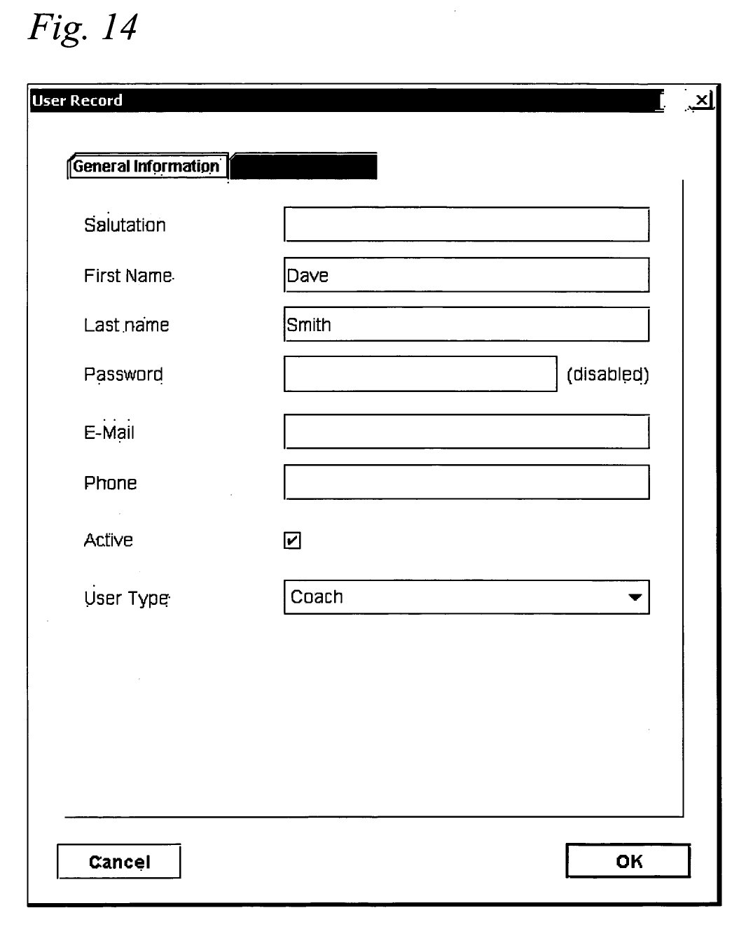

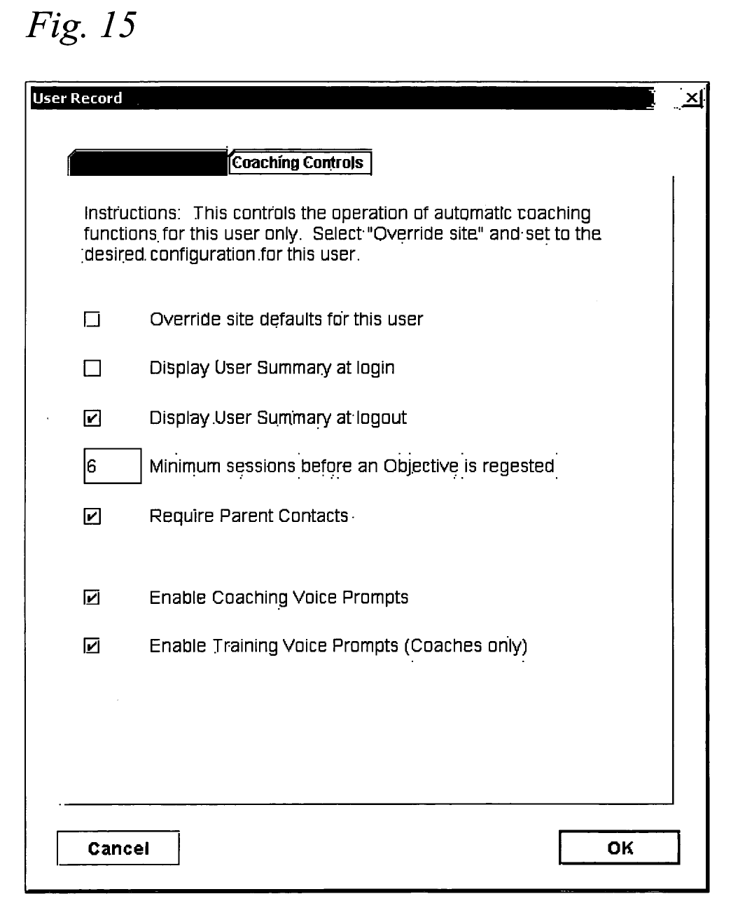

FIG. 14 depicts a screen where a Coach's General Information is entered. FIG. 15 depicts a screen where Coach Control Information is entered. Play Attention is delivered with presets that provide the opportunity for greatest success, and in general the presents should not be changed. However, if the coach desires to change the defaults, it can be done on the screen of FIG. 15. Click “Override Site Defaults” to customize the program for the current user.

If the new user is logged in as coach, Play Attention will require the coach to input information. At various times, Play Attention will send product updates, patches, educational support messages, and valuable information to the coach. It is essential that this information be completed to provide the student the best possible opportunity for success.

### Address Information

A screen (not shown) is presented for entering student address information. Type the address to which student rewards will be mailed. At pre-determined intervals, Play Attention automatically prompts the coach to send an e-mail to Unique Logic and Technology, Inc. to retrieve student rewards.

### Coach Login

A person who trains other students is called a “coach.” Play Attention distinguishes the coach from students. Every time a student logs in, Play Attention requests the student to select his/her coach. Clicking on the Coach menu allows the student to select a coach. For management of data files and the best possible teaching environment, it is highly recommended that the same coach train the same student for the duration of Play Attention training. Once the coach has been selected, click <Login>. An unlimited number of coaches can be logged in for practice, but their data is saved for only five sessions.

### Coach's Session Rating Scale ©2003 Unique Logic and Technology, Inc

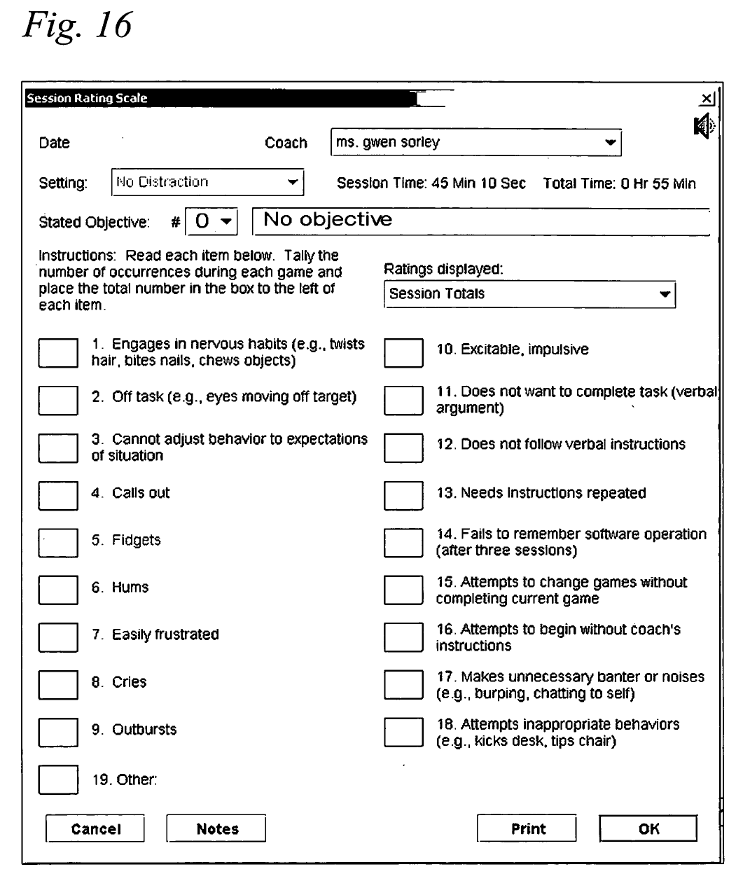

Once the student is logged in, the Coach's Session Rating Scale (CSRS) is displayed, as represented in FIG. 16. The CSRS is also referred to herein more generally as a Behavioral Rating Scale. The CSRS is used to assess student behaviors that are demonstrated during a Play Attention session. Utilizing the CSRS assists the coach in understanding and later augmenting student behaviors not conducive to learning. The CSRS is the primary instrument used to shape behaviors. For optimum results, it is essential that the CSRS be used from the very first Play Attention session to the very last Play Attention session. An audio prompt encourages use of the CSRS.

With reference to FIG. 16, by default, the only behavioral objective set is learning to use Play Attention. This is maintained until the student has achieved fundamental mastery of the software. This usually occurs after five to six sessions. Play Attention automatically prompts the coach to set objectives after the default time of six sessions.

Ideally, training should begin in a sound attenuated environment (quiet area) and progress to more distracting environments as the student improves and masters the necessary skills. An audio prompt explains the CSRS. Clicking on the icon in the upper right corner of the form allows toggling of the sound between off and on.

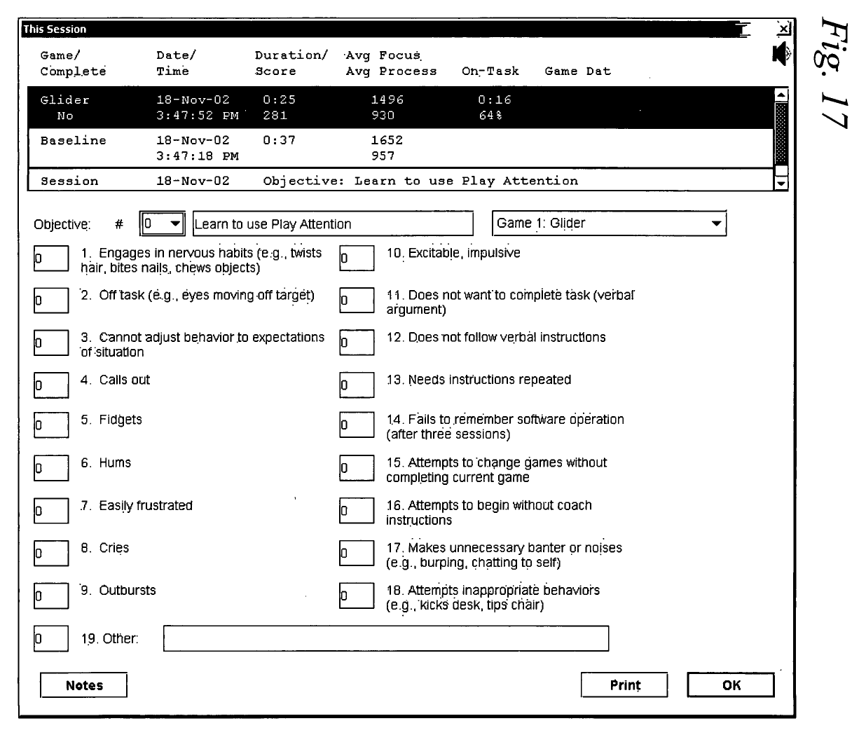

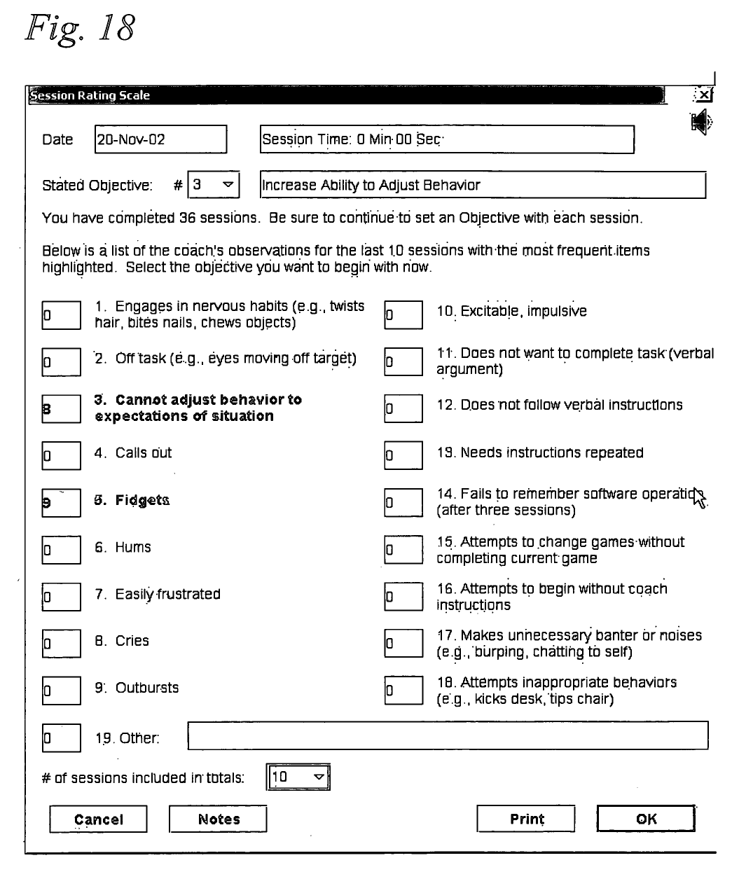

The Play Attention package comes with a wet-erase version of the CSRS that should be used from the very first day of training. Instructions for the coach are: Observe your student carefully while he performs the games in the various Play Attention Levels. Place a tally mark on the board next to a specific listed behavior each time you witness that behavior. These behaviors that are seen are herein also referred to as Exhibited Behaviors. After the student has completed a game, total the tally marks on your wet erase board, and place that number on the electronic form that is displayed on the screen, as represented in FIG. 17. This procedure is continued for all Play Attention sessions.

For the first six sessions, the CSRS is not used to augment behaviors. It is used to clarify specific behaviors that the student exhibits most frequently during Play Attention sessions.

### Setting Behavioral Objectives ©2003 Unique Logic and Technology, Inc

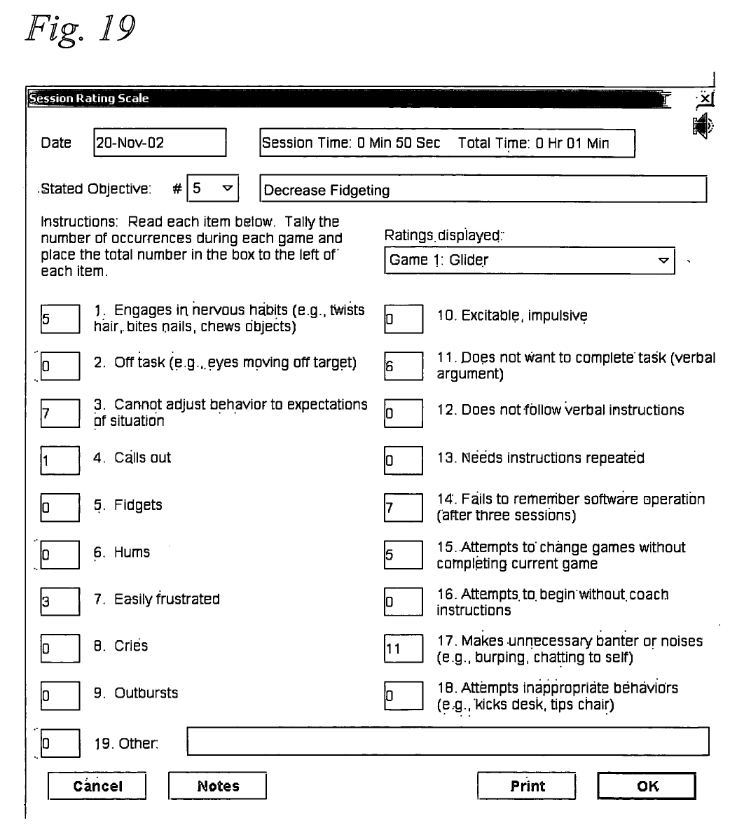

A special CSRS as represented in FIG. 18 is displayed after the initial six sessions indicating the total number of instances the coach documented each behavior. By providing these totals, the coach and student can clearly distinguish the behaviors that occur most frequently during Play Attention sessions. Instructions for the coach: Do not be troubled if many behaviors have totals placed in the boxes. Do pay particular attention to the greatest totals as these are the behaviors that the student is also most likely exhibiting in the classroom setting. They are therefore most likely to be the behaviors causing interference in the student's learning process.

Empowered with this information, the coach begins assisting the student in extinguishing behaviors not conducive to learning. To begin, the coach sets a behavioral objective related to behaviors that the coach has observed and charted on the CSRS. Specific anecdotal notes may be added by clicking <Notes>.

To help the student understand why it is necessary to extinguish a behavior, it is appropriate to discuss the correlation between behavior and attention. An example is provided below:

“Do you notice that you tend to squirm in your seat a lot during our sessions? What happens to the screen character when you squirm?”

(Discussion—character does not perform correctly because student is self-distracted. Student does this in class and fails to hear the lesson).

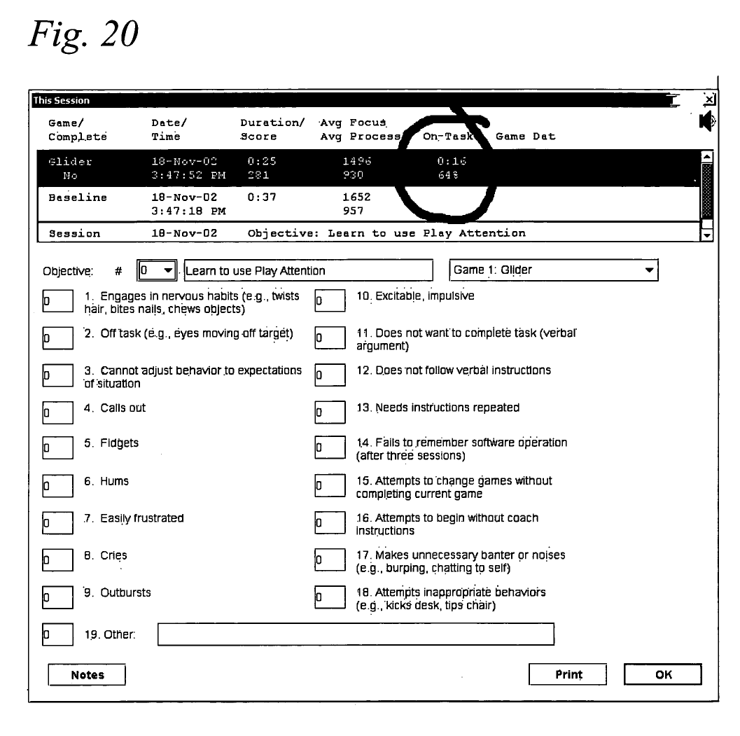

“Let's try to work today and decrease the amount of fidgeting. This should help you in class.” FIG. 19 shows the Stated Objective: Decrease Fidgeting.

It is important to note that some students do not exhibit behaviors that need modification. Particularly, these students do not fidget or call out, but rather simply daydream too much, have poor organizational skills, or cannot complete tasks. For these students, the coach should stress the importance of time on-task. The stated objective would be “Increase Time on-task.” This is accomplished by the student learning to gradually prolong his ability to attend to the Play Attention games for a full five minutes each without interruption. Another objective to consider for these students is to increase attention stamina, i.e., to teach the student to maintain focus for longer periods of time.

FIG. 20 shows the manner in which Time on-task data is reported in all game data at the top of the CSRS.

It is further recommended that the student utilize the “Academic Bridge” which integrates Play Attention with actual homework assignments. The “Academic Bridge” is discussed briefly hereinbelow in the section captioned “Level III.”

Students learn at various rates. An individual student may take two months or longer to extinguish the behavior and reach his objective. Do not set another behavioral objective until the current one is reached. Stick with the current objective until the student reaches it, then set others if necessary.

The CSRS is a powerful tool if used properly. Shaping behaviors can be simple, rewarding, fun, and empowering. Frequently, a student's self-esteem increases as he learns that he can control his behaviors.

### Progress Charts ©2003 Unique Logic and Technology, Inc

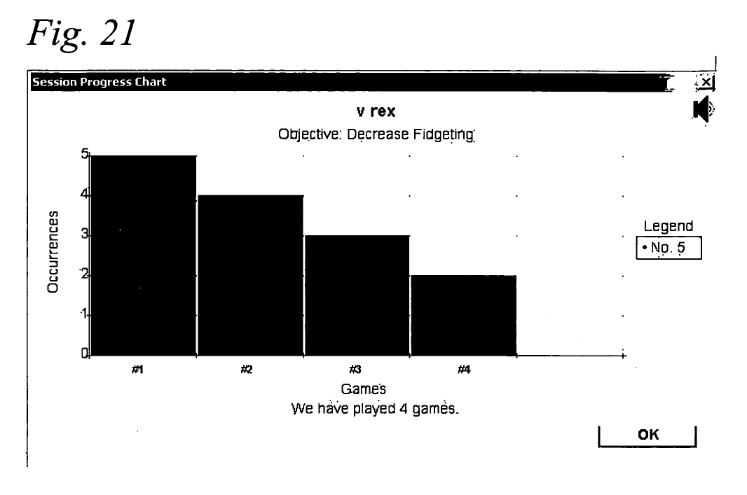

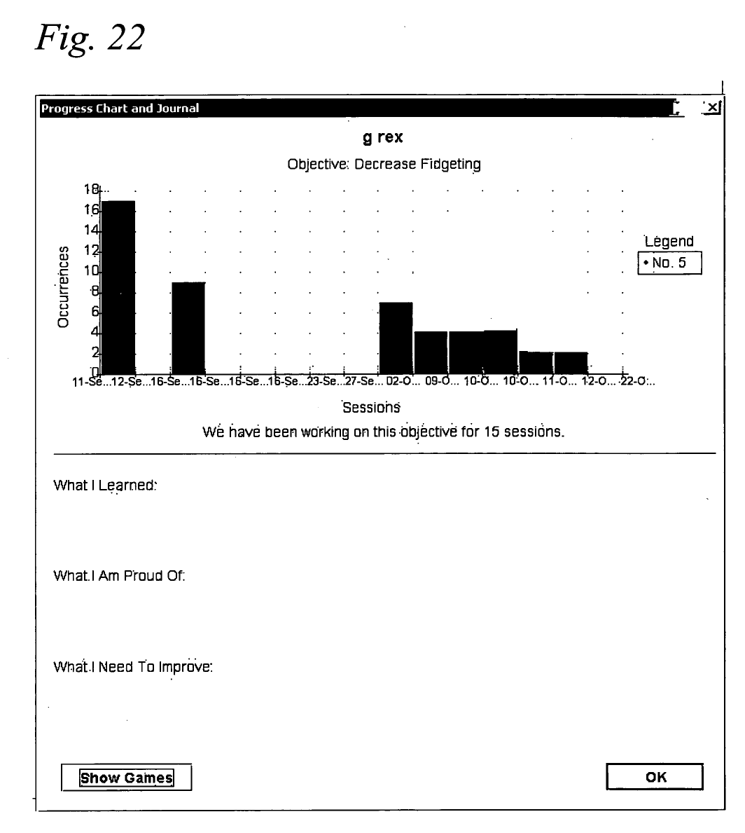

Two progress charts are used to clearly define student behaviors exhibited during Play Attention training as referenced in FIGS. 21 and 22. They are the Session Progress Chart and Progress Chart (Sessions). These charts automatically display after each game and during logout once behavioral objectives have been established and entered in the Coach's Session Rating Scale. They can also be accessed by clicking on User Data, and then selecting Progress Chart and Journal.

The Session Progress Chart (FIG. 21) shows that the selected objective for student VRex was to “Decrease Fidgeting.” As the coach entered information on the Coach's Session Rating Scale, it was automatically transferred to the Session Progress Chart. The chart clearly demonstrates that VRex controlled his fidgeting, progressively reducing it during each game. The Session Progress Chart is significant because it:

(a) Offers student and coach immediate visual evidence of behavioral control;

(b) Positively reinforces the student, encouraging further behavior progress;

(c) Can increase student self-esteem; and

(d) Empowers the student by demonstrating that he is in control of himself and his future.

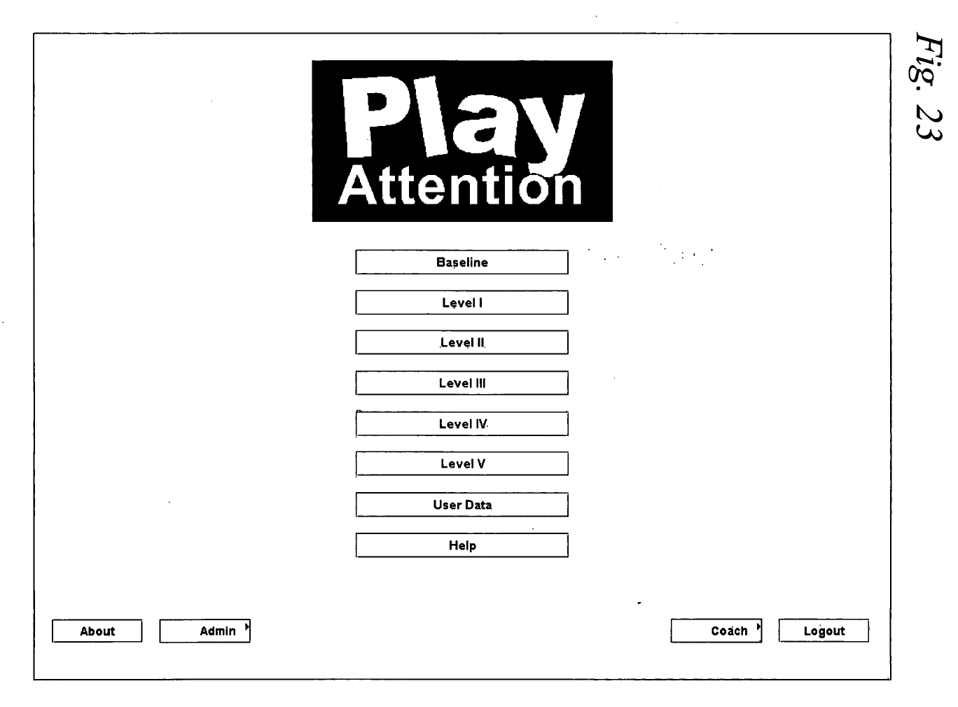

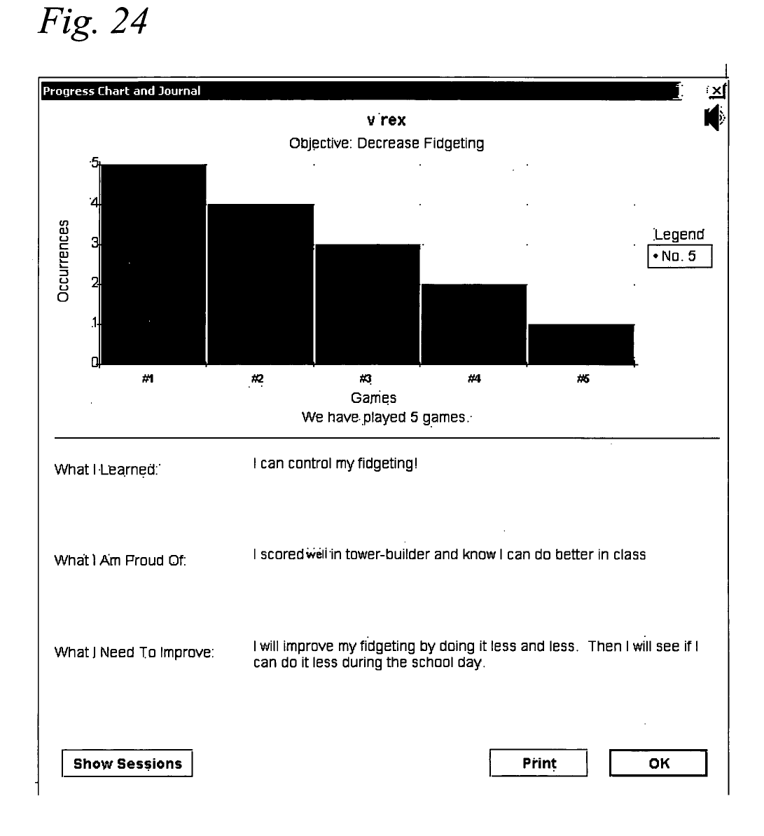

The same chart is displayed at logout with the addition of journal entries as referenced in FIG. 23. The student should fill in short entries about “What I learned today,” “What I am Proud of,” and “What I need to work on next session.” To ensure consistency and continuity, these are displayed upon the student's next login.

### Progress Chart (Sessions)

To view progress over longer periods of time, click on the <Show Sessions> button in the lower left corner of the screen. This will display a chart depicting progress of two or more sessions rather than just the current session (FIG. 22). Using Progress Chart and Journal (Sessions) is a very effective method of demonstrating progress (behavioral control) over multiple sessions. This display is a valuable tool to present to parents, teachers, and administrators.

### Logout

Clicking on Logout as depicted in FIG. 23 terminates the current session and allows the coach to login a new user without having to restart Play Attention.

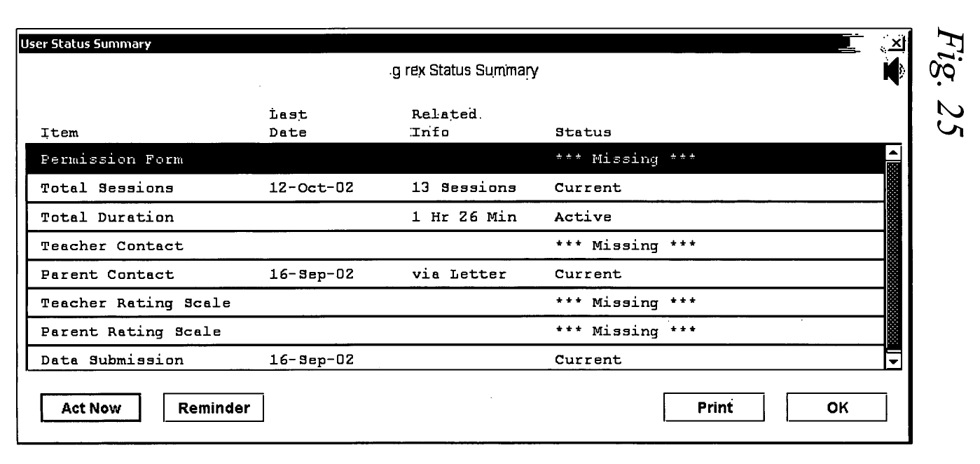

During logout, Play Attention prompts the student to complete a journal entry as represented in FIG. 24. Have the student complete “What I learned,” “What I am proud of”, and “What I need to improve” to provide reflection and closure. Full details regarding reflection and closure can be viewed under the Coaching to Shape Behavior, How to Coach, and Reflection & Reinforcement sections.

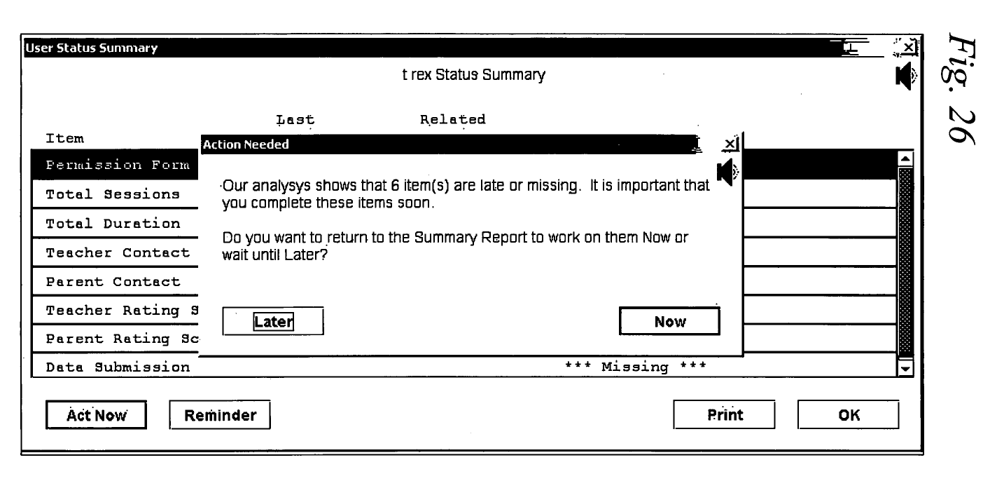

If any recommended or required coaching information for the current user has not been completed, a User Status Summary report as depicted in FIG. 25 will be displayed. This report tells the coach the current status of each coaching support item for the current user. To complete the information that is displayed as ***Missing***, simply double click on the missing item or highlight the missing field and click Act Now to complete the information. The coach may also select Reminder to have Play Attention prompt to have this data completed at a later time. Upon leaving this report, a prompt as referenced in FIG. 26 will request that the coach complete the necessary information if any is late or missing.

### Rules ©2003 Unique Logic and Technology, Inc

It is essential that the student is told the rules prior to each Play Attention session. This ensures that the student fully understands the parameters by which he will achieve success and be evaluated behaviorally. Therefore, Play Attention states the rules prior to each Baseline. The rules are also presented via an audio prompt.

There are three primary rules when using Play Attention:

1. Speak only after the game is finished.

2. Move or fidget as little as possible during game play.

3. Relax and have fun.

These rules should be posted above the game computer and adhered to consistently by student and coach.

### Baseline ©2003 Unique Logic and Technology, Inc

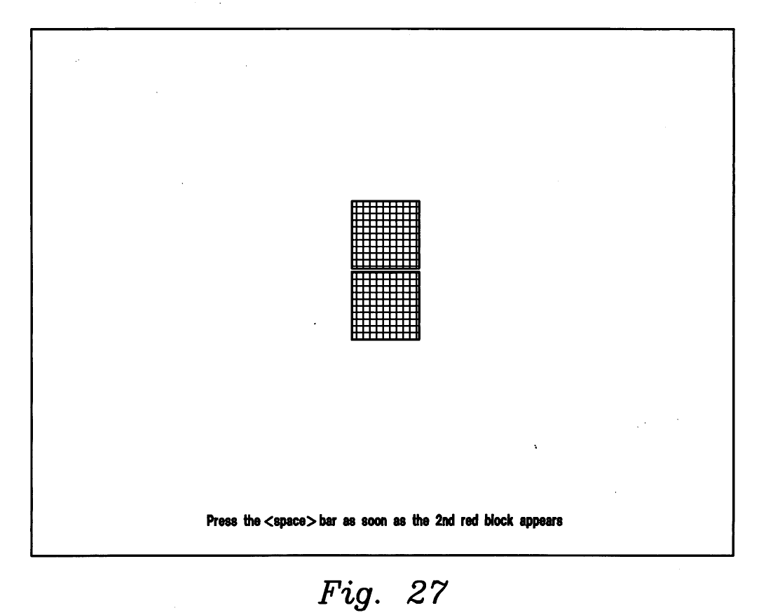

Baseline is the method in which Play Attention ascertains each user's current maximum state of attention. Baseline allows Play Attention to assess the user's current level of focus and customize these settings to the attention enhanced games. Since all games respond according to baseline data, each new user must begin with the Baseline process. After attaching the helmet and placing it on the user's head a Baseline operation is performed. In the FIG. 23 main menu, “Baseline” is selected on Baseline and a screen as shown in FIG. 27 appears, after which a voice prompt states the rules for the user. A black screen displays and begins to fill with yellow blocks. User instructions: Focus on the screen paying as much attention as possible. Do this from normal sitting distance. Be distracted as little as possible. Play Attention will do the rest. Focus visually and mentally on the screen, and press the <Space> bar as each red block appears. There are a total of three red blocks which appear at random intervals. If the <Space> bar is pressed too early, a voice prompt will say, “Wait for the red block.” If the student fails to respond a short while after a red block appears, Play Attention will require the student to take another baseline.

It is important to blink normally and relax as much as possible during the use of Play Attention and especially at Baseline. Excessive blinking may cause inaccurate data readings. Also, it is important not to tense the muscles the neck and forehead during the use of Play Attention. Tension may cause inaccurate data readings.

If for any reason the user has been distracted or unable to pay reasonable attention during Baseline, it is important to re-take Baseline. Incorrect Baseline readings will affect the play of the games and offer less fun and challenge to the user. After acquiring good baseline data, the user will be ready to go to the other games.

If the user is in a very distractible or agitated state, Play Attention should not be used, as incorrect or inaccurate readings may result providing much less fun and minimal learning. The user may return later when more relaxed and alert.

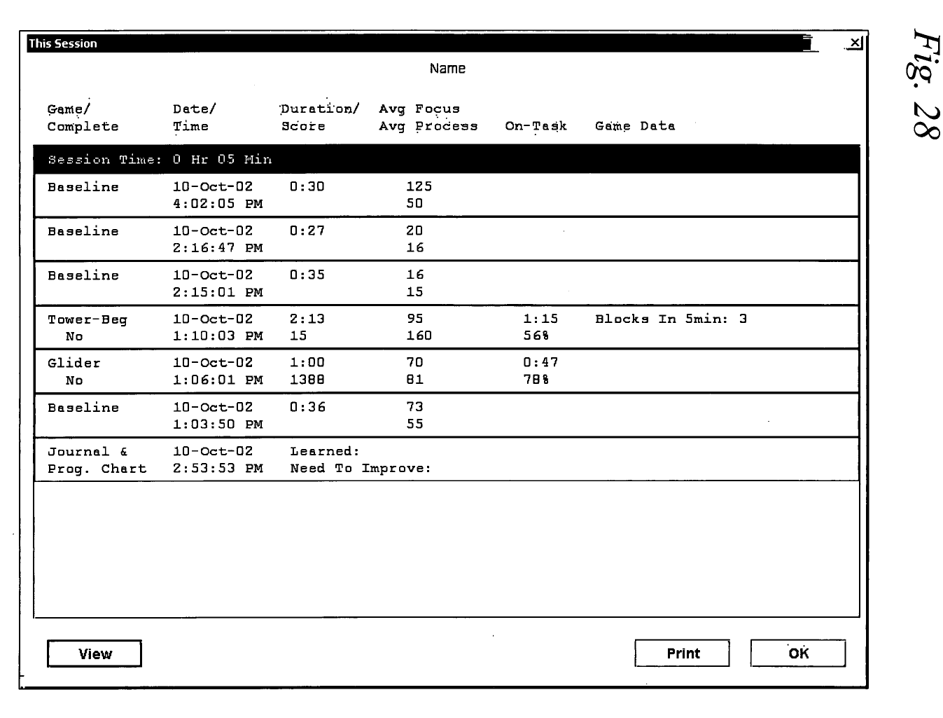

When Baseline is completed, a data screen displays the total Session Time, Average Focus and Processing scores, Duration and the time and date as referenced in FIG. 28. The Average Focus and Average Processing scores are used solely for the computer to determine the current user's level of focus. They are not to be used for comparison or diagnosis.

During the attention training exercises, regardless of Level, the baseline can be readjusted if necessary. If the student is exhibiting the ability to maintain attention 100% of the time, the <Page Up> key on the keyboard 138 is used to adjust the baseline to make play more challenging. If a game is too difficult to accomplish the goal, and so long as the student is truly working, the <Page Down> key on the keyboard 138 is used to reset Play Attention and determine a baseline again. The <Page Down> key should not be used if the student is not trying, or is off-task.

### Level I ©2003 Unique Logic and Technology, Inc

Educational Objective: Increasing sustained attention. For persons with attention challenges, sustaining attention for more than a few seconds is difficult. Level I attention training exercises, if practiced consistently, can increase attention stamina. All games in Level I last five minutes and shut down automatically. However, initially most users will not be able to sustain attention for more than a minute or two. If the user indicates that he is fatigued, press the <Esc> to end the game. Rest a short period and proceed with the next level. Gradually increase the user's attention stamina by setting a goal to slightly exceed the current time at the next session. A goal is to eventually sustain attention for a full five minutes without rest. Also, because of the initial novelty of the software, a person with an attention challenge may appear not to have any difficulty focusing for the first few sessions. After this, the user may actually appear to regress. It is important to keep training during this period, as it is the time when true learning begins and is assimilated.

Before beginning any level, the user should relax as much as possible. To assist with this, the user should take a few deep breaths and feel the muscles in the body relax and loosen. The user should still the body as much as possible throughout the entire session. This information is in the Help menu and the introductory menus.

After taking the Baseline the user can begin Level I. The user must simply pay as much attention to the character on screen as possible.

In Level I there are two games: Glider and Diver. Each has Beginner, Intermediate, and Advanced Skill options. Always begin by using the Beginner Level. If your student is consistently achieving good results on his current level (usually 80% on-task or greater) it may be time to move to the next level. If your student is subject to attention fatigue, wait until he consistently demonstrates stamina and success on his current level before advancing to the next level. Assess the student over four to five sessions to determine whether the student is ready to begin the next level. If you have transitioned properly from one level to the next, it is usually not necessary to return to the previous level. It is detrimental to allow the student to randomly select levels as this practice often leads to frustration and inconsistency. Therefore, if you determine that the student should move to the next level, advance the student and do not return to the previous level unless the student finds his current level too difficult. If you assess your student's ability correctly, you seldom have to return to previous levels.

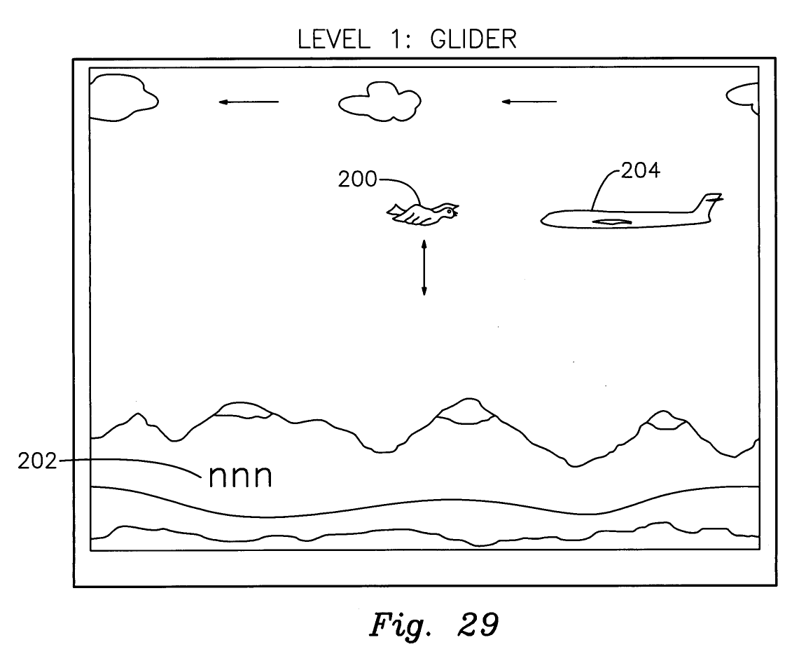

Glider is a character 200 as depicted in FIG. 29. Once baseline is obtained and the character is selected, the character appears mid-screen. The screen character sails to the top of the screen just below the clouds if attention is maintained to a high degree. The greater the attention of the user, the higher the character soars. The character receives power pills as rewards for greater levels of cognitive processing. A counter 202 keeps score at the bottom of the screen. The score is time based and is motivational for some students.

If maximum attention is not maintained, the character begins to fall and eventually glides just above the mountains. If the student is truly trying and not succeeding, use <Page Down> to reset Play Attention. If the student is exhibiting the ability maintain attention 100% of the time, or if the game is too difficult to accomplish the goal, pressing the <Page Down> key will always reset Play Attention to the student's proper level. Do not use the <Page Down> key if the student is not trying or is off-task.

The Beginner level allows the student to simply focus and fly the screen character to the top of the screen with no distracters. The Intermediate and Advanced skill options differ from the Beginner by presenting a distracter 204 on the screen at random intervals. The Advanced option presents the distracters 204 faster and at differing angles than the Intermediate. The student must press the spacebar to avoid colliding with the oncoming screen character as quickly as possible. The use of the spacebar provides interactivity, challenge, and greater visual attention practice.

If the spacebar is not pressed for deflection, a collision occurs and fifty points are deducted from the student's score. Fifty points are added for proper deflection. Ten points are deducted if multiple presses of the spacebar are detected for one distracter. Ten points are deducted for impulsive presses of the spacebar when no distracter appears on screen. Upon the second consecutive instance of non-deflection, the game halts, and a screen advises the student to press the spacebar to deflect the oncoming character. An audio prompt reinforces this advisory screen.

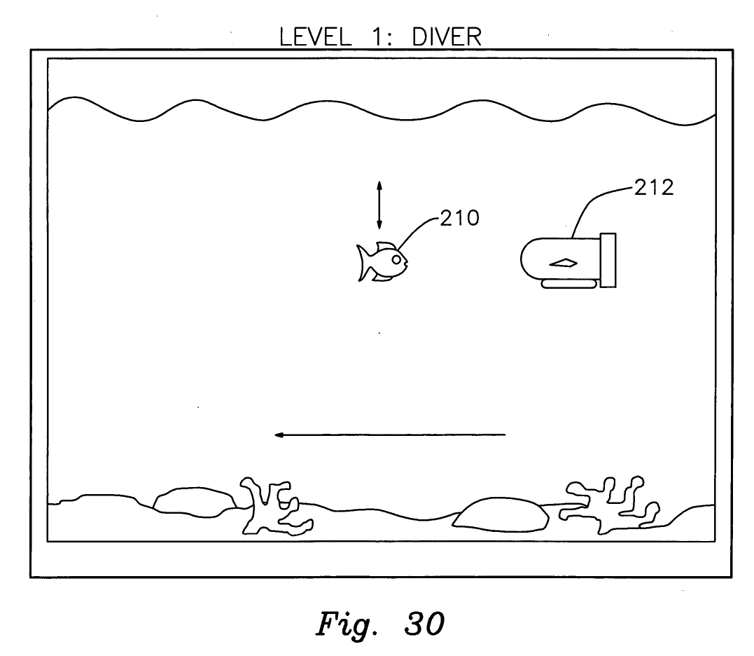

Diver is a character as referenced in FIG. 30 that swims to just above the ocean floor if attention is maintained to a high degree.

If a proper baseline was obtained, the character 210 begins at the very top middle of the screen. The greater the attention of the user, the lower the character swims. This gives the user feedback related to the degree of attention paid.

It is important to push the character as low as the user can comfortably accomplish that particular session. It is equally important to encourage the user to maintain the higher level of attention as long as possible. This may be a matter of seconds or perhaps longer intervals. The character will flash and receive power pills as reward for greater attention levels and for higher levels of cognitive processing. A counter keeps score at the bottom of the screen. The score is time based and is motivational for some students.

Just as in Glider, the Intermediate and Advanced skill options differ from the Beginner by presenting a distracter 212 on the screen at random intervals. The Advanced option presents the distracters 212 faster and at differing angles than the Intermediate. The student must press the spacebar to avoid colliding with the oncoming screen character as quickly as possible. Diver uses the same point system as Glider.

Upon the second consecutive instance of non-deflection, the game halts, and a screen advises the student to press the spacebar to deflect the oncoming character. An audio prompt reinforces this advisory screen.

### Level II ©2003 Unique Logic and Technology, Inc

Educational Objective: Visual tracking. Visual Tracking is the ability to sustain attention to a target while the target is moving. A classroom teacher is a primary example. Persons with attention challenges have difficulty maintaining attention to a moving target if the target is low-stimuli. Practicing Level II attention training exercises increases the ability to Visually Track with attention.

All games in Level II last five minutes and shut down automatically. However, initially most users are not able to sustain attention for more than a minute or two. If the user indicates that he is fatigued, press the <Esc> to end the game. Rest a short period and proceed with the next level. Gradually increase the user's visual tracking by setting a goal to slightly exceed the current time and score at the next session. Your goal is to eventually visually track the screen character for a full five minutes without rest.

Also, because of the initial novelty of the software, a person with an attention challenge may appear not to have any difficulty focusing for the first few sessions. After this, the user may actually appear to regress (see Important Notice Regarding Training in the Interpreting User Data section). It is important to keep training during this period, as it is the time when true learning begins and is assimilated.

After taking the Baseline, the user can begin Level II. The user must simply pay as much attention to the character on screen as possible. The games in Level II are not more difficult than in Level I. However, the user's score in Level II is dependent upon attention and cognitive processing. A combination of the two produces success. Level I depends upon attention alone.

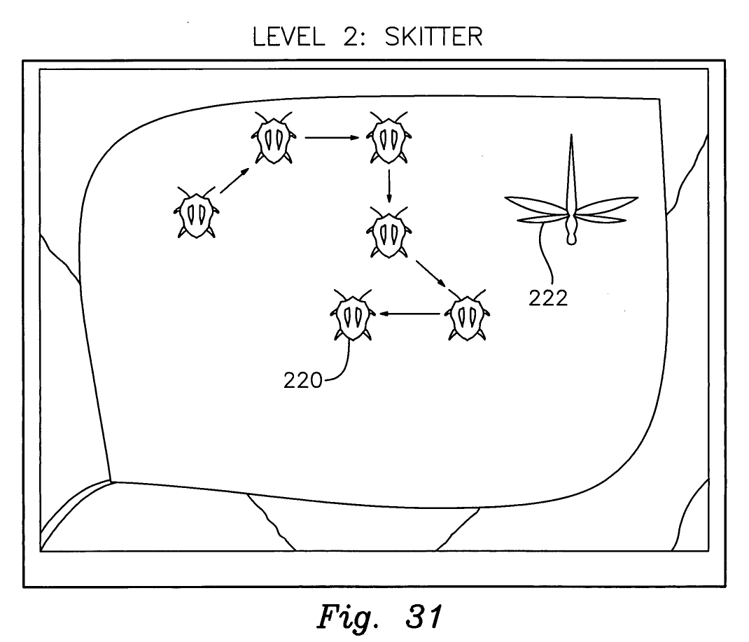

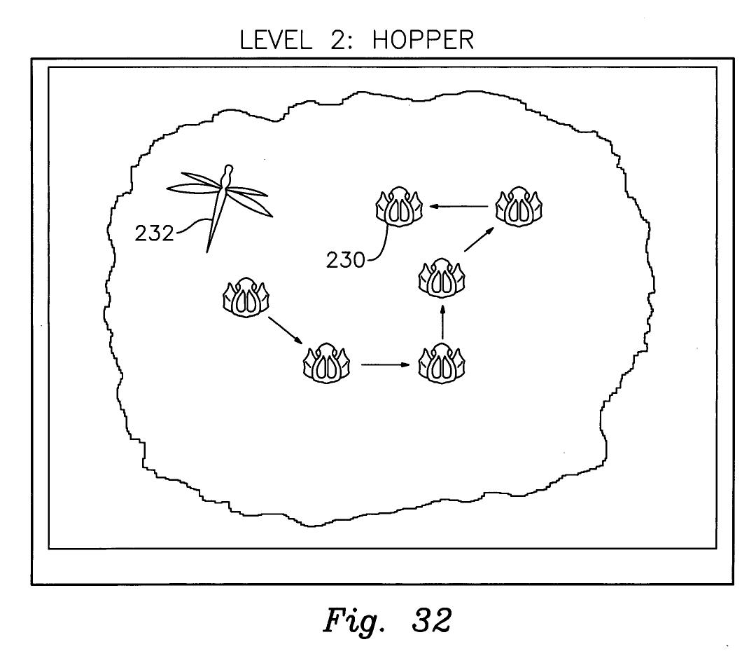

In Level II there are two games, Skitter and Hopper as referenced in FIGS. 31 and 32, respectively. Skitter 220 is a bug that is mentally pushed around the screen by the use of higher attention levels and higher levels of cognitive processing. The bug 220 moves over a leaf in random motion. If a proper baseline was obtained, the bug 220 begins in a stationary position. The greater the attention of the user, the more quickly the bug moves. This gives the user feedback relating to the degree of attention paid. It is important to prompt the user to mentally push the bug as quickly and as much as the user can comfortably accomplish that particular session. It is equally important to encourage the user to maintain the higher level of attention while tracking the screen character for as long as possible. This may be a matter of seconds or perhaps longer intervals. The bug beeps and fans its wings as a reward for greater attention and cognitive processing. A counter keeps score for the user.

The Intermediate and Advanced versions of Skitter present a dragonfly distracter 220 at random intervals. The Advanced skill option presents the dragonfly for a much shorter period than the Intermediate. The student must deflect the dragonfly by pressing the spacebar upon the dragonfly's appearance. Fifty points are deducted for non-deflection. Ten points are deducted for each impulsive or multiple spacebar press. Upon the second consecutive instance of non-deflection/non-response, the game halts, and a screen advises the student to press the spacebar to deflect the oncoming character. An audio prompt reinforces this advisory screen.

Hopper (FIG. 32) is a frog 230 that is mentally pushed around the screen by the use of higher attention levels and higher levels of cognitive processing. The frog 230 moves over a leaf in random motion. If a proper baseline was obtained, the frog begins in a stationary position.

The greater the attention of the user, the more quickly the frog will move. This gives the user feedback relating to the degree of attention paid. It is important to prompt the user to mentally push the as quickly and as much as the user can comfortably accomplish that particular session. It is equally important to encourage the user to maintain the higher level of attention while tracking the screen character for as long as possible. This may be a matter of seconds or perhaps longer intervals. As coach, it is important to remember to encourage the student to pay attention and play longer at each session if the student is unable to play for a full five minutes without interruption. By setting small, achievable goals, the students can stay motivated and be rewarded to achieve their long-term goals. This takes careful planning on the coach's behalf

To ensure transfer, it is important to remind the student to relate this activity to watching the teacher move about the room during a classroom lesson.

If the student processes data above the threshold set in baseline, the frog blinks as reinforcement.

The Intermediate and Advanced versions of Hopper present a dragonfly distracter 232 at random intervals for the frog 230 to eat. The Advanced skill option presents the dragonfly 232 for a much shorter period than the Intermediate. The student must capture the dragonfly by pressing the spacebar upon the dragonfly's appearance. Fifty points are deducted for non-deflection. Ten points are deducted for each impulsive or multiple spacebar press. Upon the second consecutive instance of non-deflection/non-response, the game halts, and a screen advises the student to press the spacebar to deflect the oncoming character. An audio prompt reinforces this advisory screen.

### Level III ©2003 Unique Logic and Technology, Inc

Educational Objective: Time on-task. Time on-task is the ability to begin a task quickly and maintain attention to the task until its completion. Persons with attention challenges often find it difficult to finish tasks. Training in Level III attention training exercises increases time on-task. Games in Level III have no time limit. However, initially most users are not able to sustain attention for more than a minute or two. If the user indicates that he is fatigued, press the <Esc> to end the game. Rest a short period and proceed with the next level. Gradually increase the user's time on-task by setting a goal to build the tower in less than five minutes. Initially, if the user cannot build the tower without fatiguing, try to exceed the current time of play at the next session. The goal is to eventually build the tower in less than five minutes.

Also, because of the initial novelty of using the system, a person with an attention challenge may appear not to have any difficulty focusing for the first few sessions. After this, the user may actually appear to regress (see Important Notice Regarding Training in the Interpreting User Data section). It is important to keep training during this period, as it is the time when true learning begins and is assimilated.

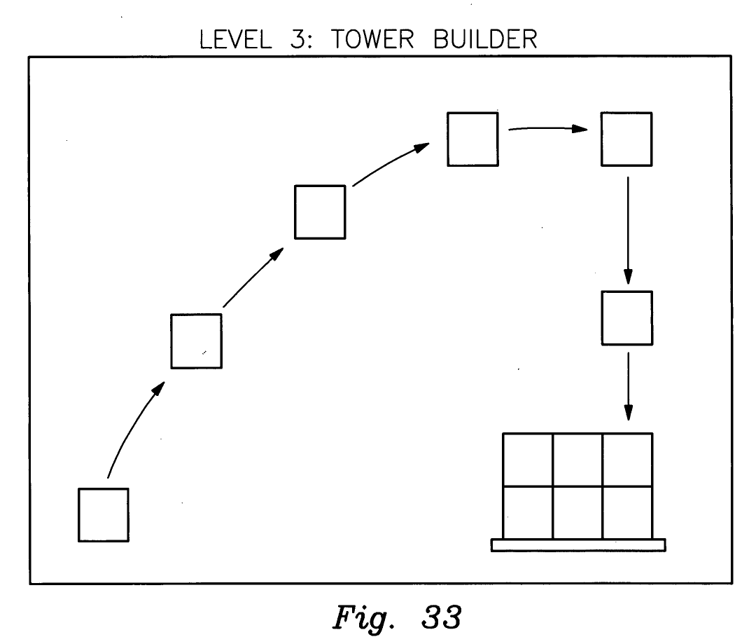

Three levels of Tower Builder comprise Level III. Tower Builder as referenced in FIG. 33 allows the user to move a gold block from the left side of the screen to the base on the right side of the screen until a tower is built. Tower Builder charts time on task. In the ascent, the blocks will move in the opposite direction should the user fall off task. In the descent, the blocks will freeze until the user resumes on-task behavior. The object of the game is to focus on the block to move them to the opposite side of the screen until the tower is complete. The Intermediate and Advanced skill options present a flashing red block and auditory prompt at random intervals as distracters. When the moving block flashes red or when the student hears the word, “Now,” the student is required to press the spacebar. This prompts the student to be more attentive both auditorily and visually.

If the student does not press the spacebar, an auditory warning (beep) prompts the student to respond. Upon the second consecutive non-response, the Play Attention halts, and a screen describes the use of the spacebar. An auditory prompt accompanies the visual prompt.

The Intermediate and Advanced Levels have the same objectives; however they utilize greater numbers of blocks, distracters, and more challenging time constraints.

Tower Builder Beginner has 13 blocks and a target time of five minutes.

Tower Builder Intermediate has 16 blocks and a target time of six minutes.

Tower Builder Advanced has 19 blocks and a target time of seven minutes.

Academic Bridge: Edufeedback is founded in the premise that skills practiced must closely simulate actual classroom tasks. This helps to ensure generalization. Although the games in Play Attention increase students' skills, research has demonstrated that transference/generalization can be increased if the student practices actual classroom tasks during Play Attention. Since Play Attention measures attention, it can be used while performing an academic task. The student may read, practice spelling, math, etc. while wearing the Play Attention helmet. If the student is very focused on his subject matter, the screen characters will perform correctly indicating that the student is on-task. This is known as an Academic Bridge. Since it is silent, it is recommended that Tower Builder be used to perform the Academic Bridge. Have the student work on a five minute, level appropriate assignment from his classroom while letting Tower Builder continue. If the student maintains focus on his assignment, the blocks will move correctly. He may peer up occasionally to see that he is on-task. Furthermore, this teaches the student to stay on-task, begin his assignment immediately, and finish it within an appropriate amount of time.

### Level IV ©2003 Unique Logic and Technology, Inc

Educational Objective: Short-term memory sequencing. The average person can manipulate up to seven data chunks in short-term memory. A person with an attention challenge usually can manipulate only two to three data chunks in short-term memory. Practicing Level IV attention training exercises will increase the user's ability to chunk data. This increases the ability to follow multi-step directions and assimilate data into long-term memory. The Beginner Level shuts off in five minutes. Intermediate and Advanced games in Level IV have no time limits. However, initially most users are not able to sustain attention for more than a minute or two. If the user indicates that he is fatigued, press the <Esc> to end the game. Rest a short period and proceed with the next level. Gradually increase data sequencing by setting a goal to increase the data sequence by one to two during the next session. Eventually, the user should be able to chunk up to seven or more data bits.

Also, because of the initial novelty of the software, a person with an attention challenge may appear not to have any difficulty focusing for the first few sessions. After this, the user may actually appear to regress (see Important Notice Regarding Training in the Interpreting User Data section). It is important to keep training during this period, as it is the time when true learning begins and is assimilated.

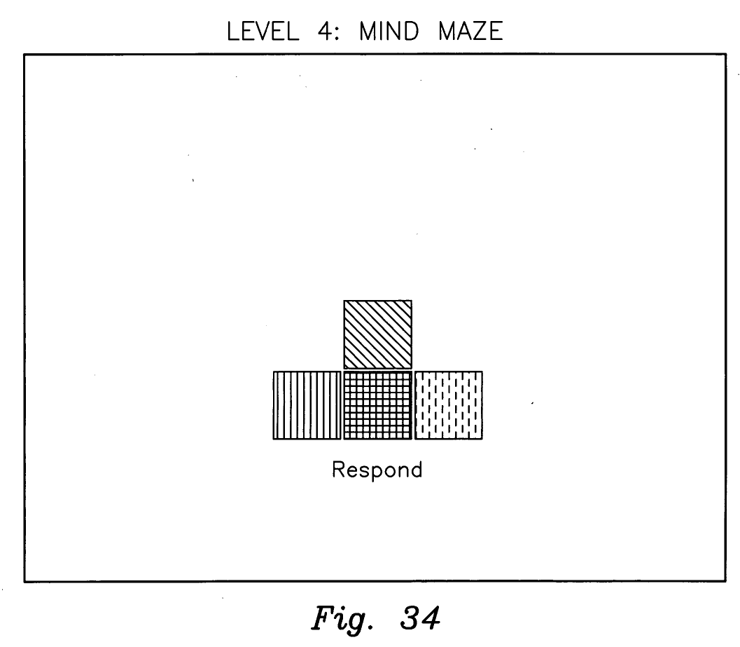

Level IV games as depicted in FIG. 34 require the user to focus to begin. When maximum focus is attained, Mind Maze begins. Mind Maze allows the user to sequence auditory and visual data streams. The screen displays distinctly colored squares, each of which is associated with a distinct tone. The squares light and sound their distinct tones in progressively more complex (longer) sequences.

The player should keep a hand on or near the arrow keys on the keyboard that correspond to the screen squares. After the screen squares light and sound, it prompts the user to respond. The user should replicate the sequence using the arrow keys. Should the user lose focus, the game halts and prompts the user to FOCUS to resume play.

Mind Maze monitors, records, and reports the success and attempts during the program.

Mind Maze Beginner starts with sequences of two and has a five-minute time limit.

Mind Maze Intermediate starts with sequences of three and has no time limit.

Mind Maze Advanced starts with sequences of four and has no time limit.

### Level V ©2003 Unique Logic and Technology, Inc

Educational Objective: Discriminatory processing. Discriminatory processing refers to the act of placing data in particular categories for storage in the brain while filtering out unnecessary or distracting stimuli. The ability to process data into categories for storage allows one to recall and retrieve data for later use. Persons with attention challenges usually have an inability to process data into categories while filtering. This results in lessened recall of facts, names, and other important information. Practicing Level V attention training exercises can increase discrimination during processing and reduce impulsivity. All games in Level V last five minutes and shut down automatically. However, initially most users are not able to sustain attention for more than a minute or two. If the user indicates that he is fatigued, press the <Esc> to end the game. Rest a short period and proceed with the next level. Gradually increase the user's discriminatory processing time by setting a goal to slightly exceed the current time and score at the next session. The goal is to eventually process data with a reduced or extinguished errors and impulsive strikes for a full five minutes without rest.

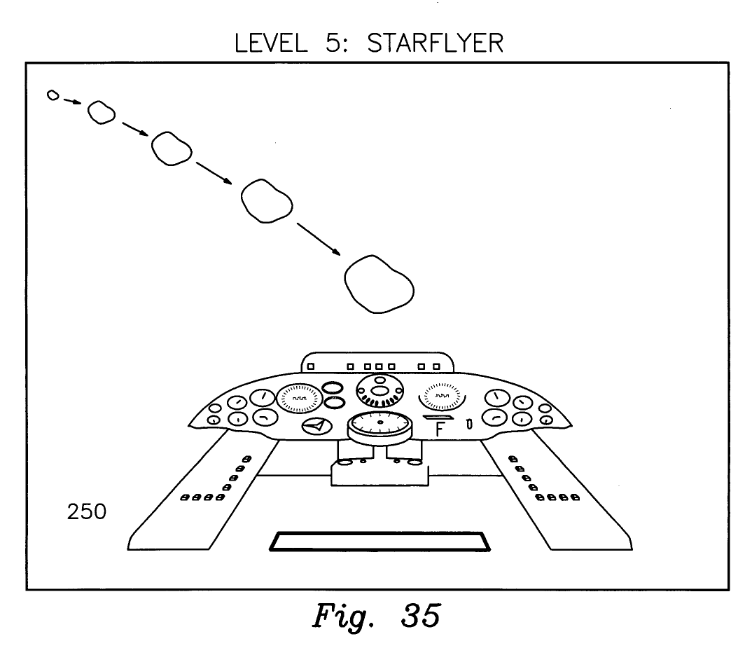

Level V of Play Attention is devoted to developing discriminatory processing. During Starflyer, as referenced in FIG. 35, the user sits in the cockpit of a cyber starship. When maximum attention is achieved, asteroids hurl toward the ship. The user must deflect certain colored asteroids while not deflecting others. This is an exercise in information processing while reducing impulsive strikes.

Level V games include Starflyer Beginner, Intermediate, and Advanced. The object of these games is to increase focus and visual discriminatory processing. When the user reaches maximum attention, Starflyer begins traveling through an asteroid field. Asteroids fly at the ship at various speeds and intervals. With hand ready at the spacebar, the user presses it as fast as possible once the white asteroid is perceived. This raises deflector shields, and the asteroid does not damage the ship. The user attempts to deflect the asteroid while it is in motion, always employing the fastest reaction speed. Five points are scored for every asteroid that is deflected. If an asteroid hits the ship, five points are lost. Do not press the spacebar if the asteroid is red. Red asteroids are friendly and score ten extra points if allowed to come aboard. Ten points are deducted for deflecting a red asteroid. If maximum attention is not maintained, the word FOCUS displays until maximum focus is again achieved.

Starflyer Beginner—No stars and asteroids come from center screen

Starflyer Intermediate—Stars in the background and asteroids come from center screen

Starflyer Advanced—Stars in the background and asteroids come from various areas on screen

### User Data

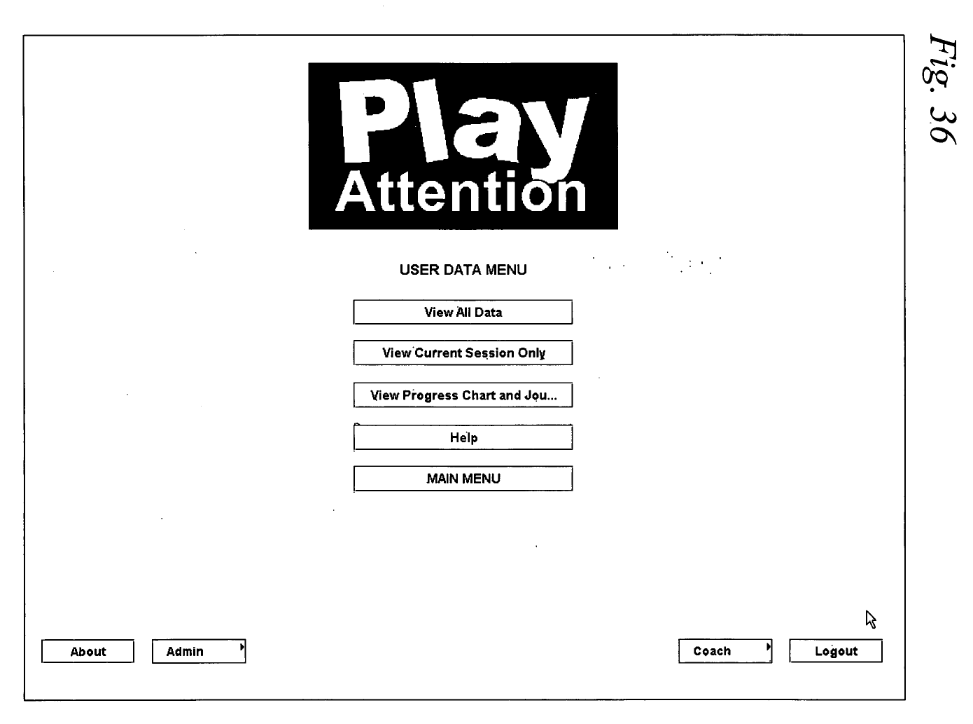

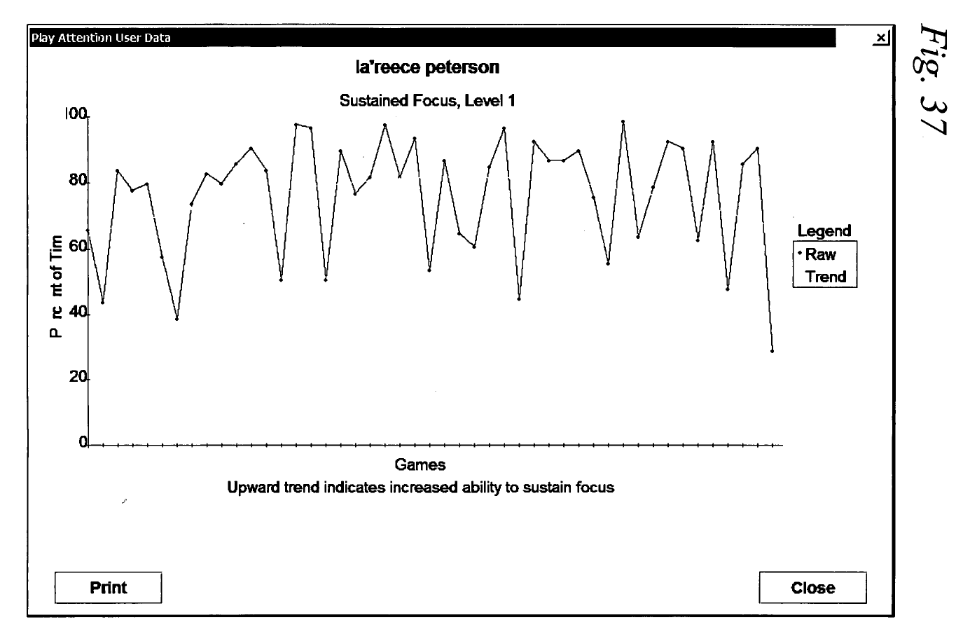

By selecting <User Data> from the Main Menu as referenced in FIG. 36, options are presented to View All Data, View Current Session Data, or View Progress Chart and Journal.

### Normal Learning Curves ©2003 Unique Logic and Technology, Inc

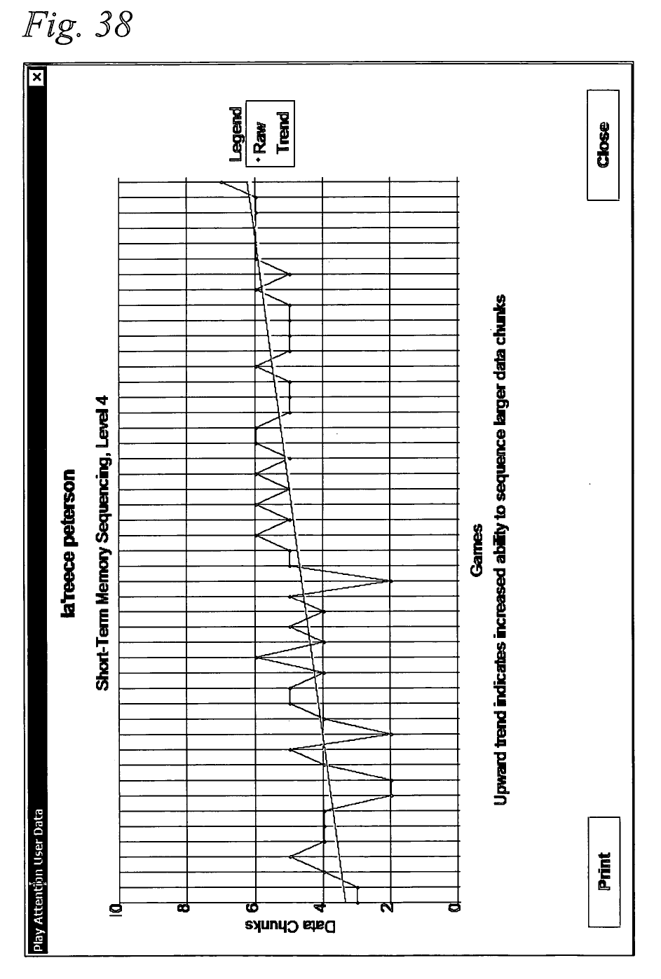

Typically, two trends appear in attention stamina and time-on task data. The first trend as referenced in FIG. 37 finds the student performing steadily for the first few sessions and then regressing for a period. It is important not to abandon training, as the regressed period is where true learning occurs, and the trend typically improves with consistent training.

The second trend as referenced in FIG. 38 typically begins at a low performance level and increases over time. Both trends are normal. The one the student exhibits will depend on his particular learning style.

### View All Data

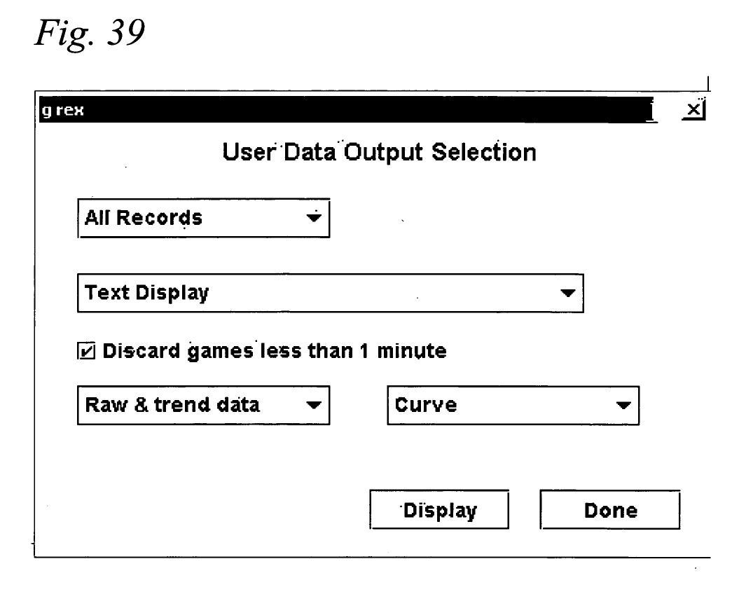

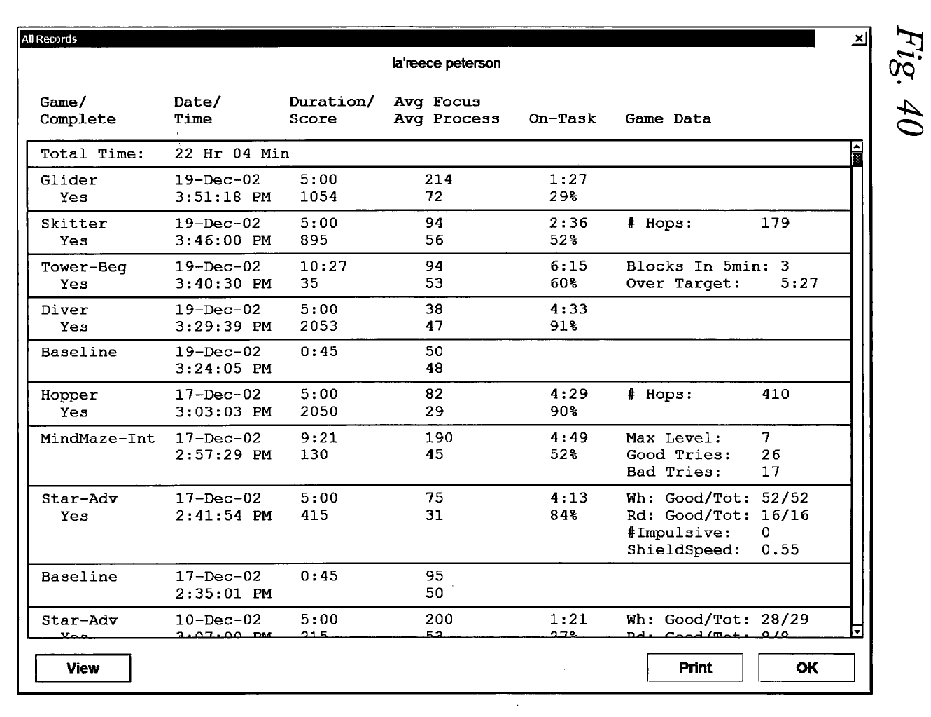

Clicking on View All Data allows a person to view all session data of the current user. The menu is displayed as referenced in FIG. 39. Selecting <Display> displays the following screen as referenced in FIG. 40. All data for all sessions of the current user is displayed. Furthermore, double clicking on any one of the records displayed will automatically open that specific record.

### View Current Session Only ©2003 Unique Logic and Technology, Inc

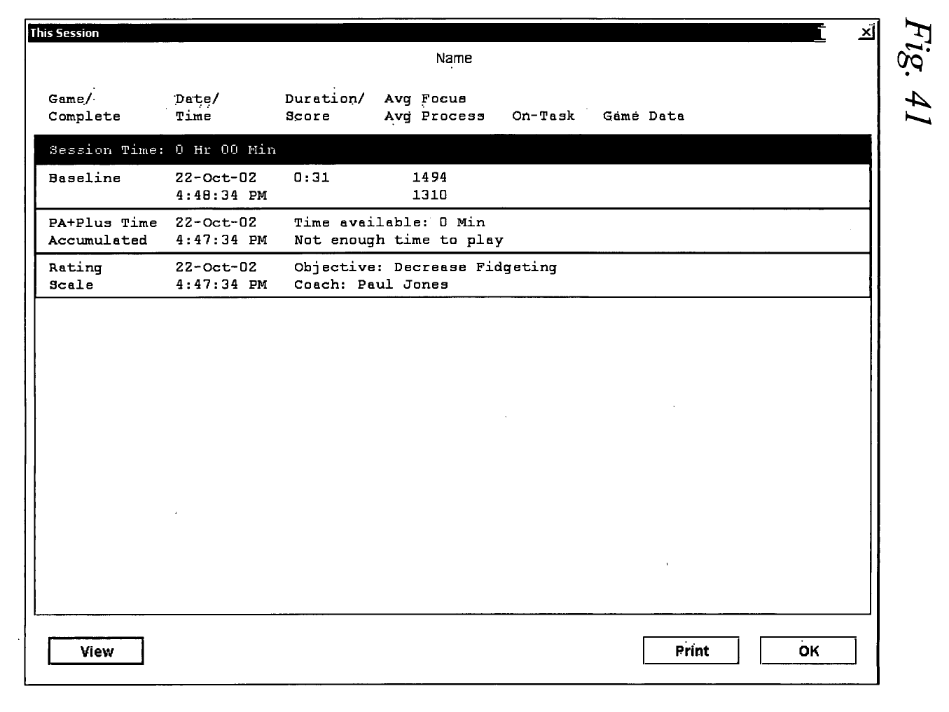

By selecting View Current Session Data, a menu displays information as referenced in FIG. 41.

The top left menu corner displays current time. Game/Complete displays the game played and whether it was played for five minutes (yes or no). Levels I, II, IV, and V are completed if played for five minutes. Level III is completed if tower is built in its entirety. Session Time displays the total time the student has actually worked with the games. Date/Time displays the current date and the time of day the student played that game. Duration/Score displays the actual time played on the current game and its relative score.

Average Focus & Avg. Processing scores are the relative baseline scores and are only used as computer reference points. These scores vary daily and are used by the computer as a reference source. Since these scores are relative to each student, there is no normal score. Do not fixate on these computer reference scores or use them as assessments.

On-task displays the actual time in minutes and seconds that the student maintained maximum attention as well as the percentage of time relative to the total time played on the current game.

Game Data display information regarding levels II, III, IV, & V. Level II displays the number of hops. Level III displays the number of blocks moved under five minutes for Beginner, six minutes for Intermediate, seven minutes for Advanced as well as the amount of time spent over or under target time.

Level IV displays the maximum successful level, good tries, and bad tries. Level V displays white and red asteroid good strikes over the total number of white and red asteroids, impulsive strikes (hitting the spacebar at an inappropriate time) and the time taken to strike the spacebar (shield speed or reaction time).

All user data is tracked by Play Attention. It is stored in a data file. To edit this data as referenced in FIG. 41, a person double clicks to select the data that he wishes to edit. This allows the person to alter data or input data that has not been registered. To edit all data, click on<View All Data> and select the data one wishes to edit.

### View Progress Charts and Journal ©2003 Unique Logic and Technology, Inc

Two progress charts are used to clearly define student behaviors exhibited during Play Attention training. They are the Session Progress Chart and Progress Chart (Sessions) as referenced in FIGS. 21 and 23 respectively. These charts automatically display after each game and during logout once behavioral objectives have been established and entered in the Coach's Session Rating Scale (FIG. 19). They can also be accessed by clicking on User Data, and then selecting Progress Chart and Journal. The Session Progress Chart as referenced in FIG. 21, shows that the selected objective for student VRex was to “Decrease Fidgeting.” As the coach entered information on the Coach's Session Rating Scale, it was automatically transferred to the Session Progress Chart. This clearly demonstrates that VRex controlled the student's fidgeting, progressively reducing it during each game. The Session Progress Chart is significant because it:

(a) Offers student and coach immediate visual evidence of behavioral control;

(b) Positively reinforces the student encouraging further behavior progress;

(c) Can increase student self-esteem; and

(d) Empowers the student by demonstrating that he is in control of himself and his future.

The same chart is displayed at logout with the addition of journal entries (FIG. 24). Have the student fill in short entries about “What I learned today,” “What I am Proud of,” and “What I need to work on next session.” To ensure consistency and continuity, these will be displayed upon the student's next login.

### Progress Chart and Journal (Sessions)

To view progress over longer periods of time, click on the <Show Sessions> button in the lower left corner of the screen as referenced in FIG. 24. This display sa chart depicting progress of two or more sessions rather than just the current session. Using Progress Chart and Journal (Sessions) is a very effective method of demonstrating progress (behavioral control) over multiple sessions. This display is a valuable tool to present to parents, teachers, and administrators.

Toggle between current session and multiple sessions by clicking in the lower left corner of the chart (FIGS. 22 and 24).

### Graphing Data

Graphing student data is perhaps the most effective method to determine and evaluate student progress. Play Attention graphs and prints student data so both student and teacher can set goals and see improvement over time. To this end, Play Attention can produce a trend indicating data curve imposed over the raw data scores. A brief trend legend is also provided below each graph to make analysis quick and easy.

Levels I-V have a specific educational correlate; Level I is increasing attention stamina, Level II is increasing visual tracking, Level III is increasing time on-task, Level IV is increasing short-term memory sequencing, and Level V is increasing discriminatory processing.

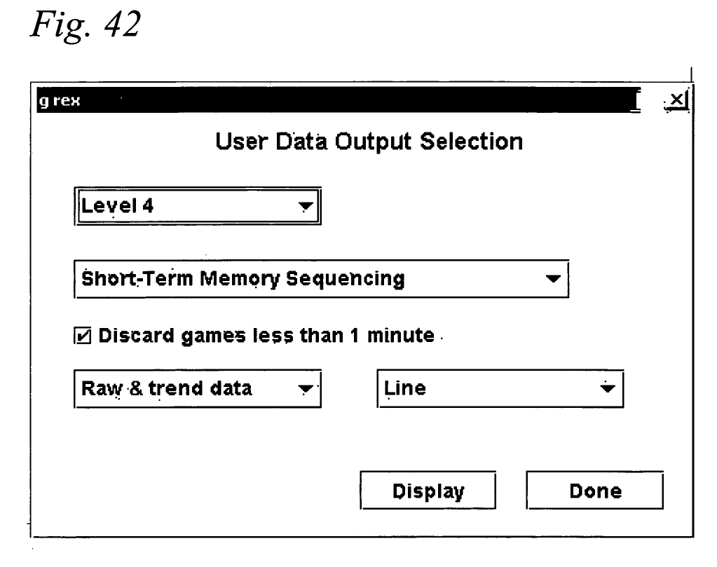

After selecting View All Data at the Main Menu (FIG. 23), click on the down arrow located at the end of the All Records button, and the menu is displayed as referenced in FIG. 42.

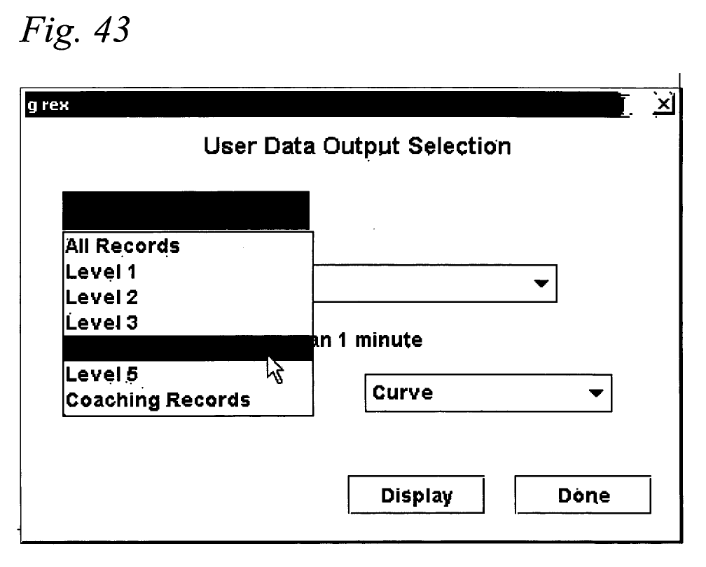

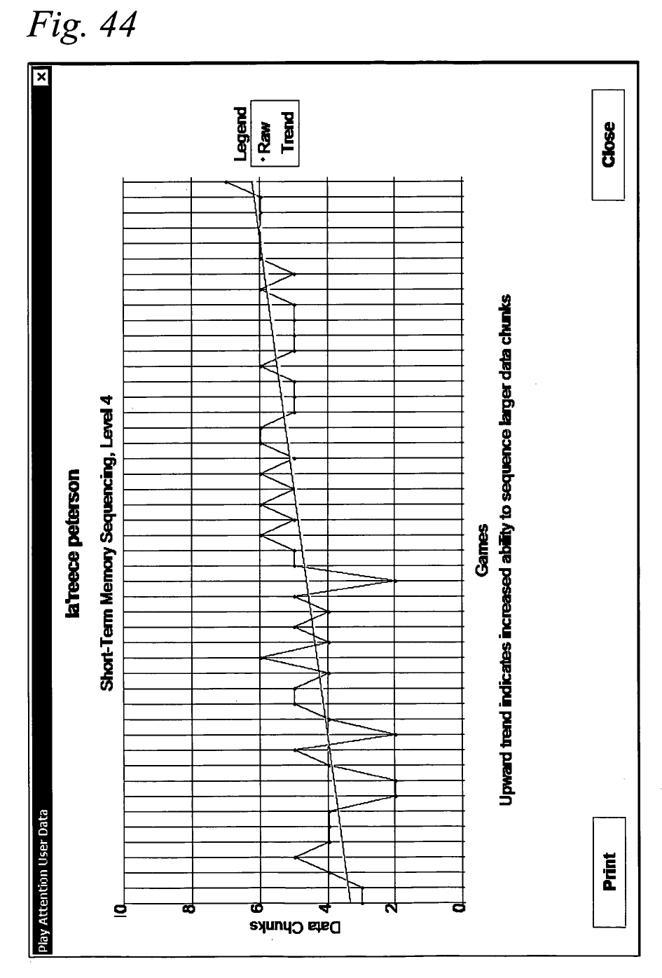

Select the level you wish to graph (for demonstration purposes, we have selected Level 4) as referenced in FIG. 43. Click <Display> and a graph of the current user's data is displayed and can be printed as shown in FIG. 44.

Note that by clicking on the educational correlate located just below the Level button you may view and graph text data and sub elements of the current level if appropriate.

### Admin

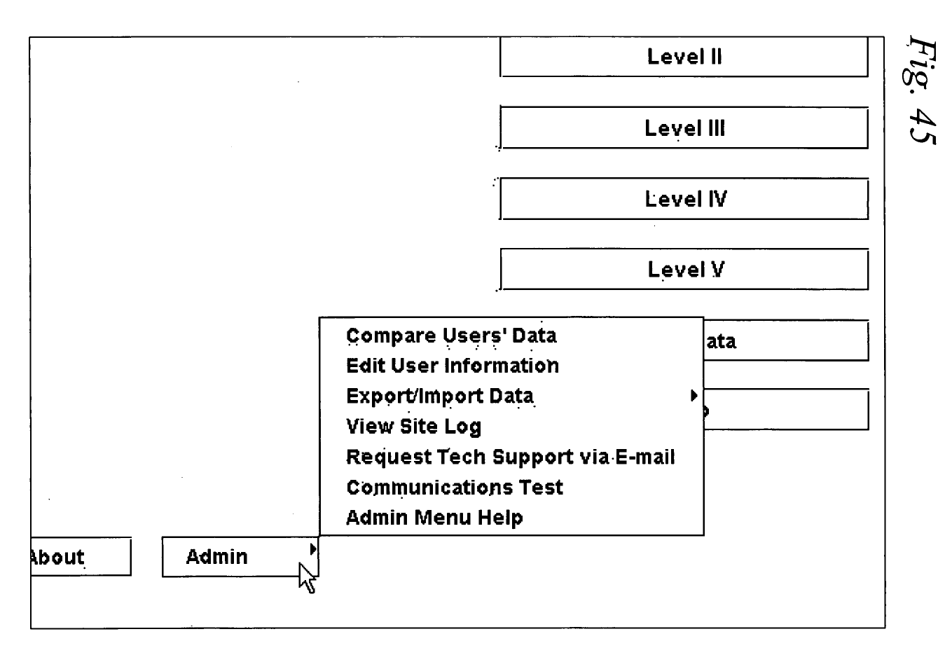

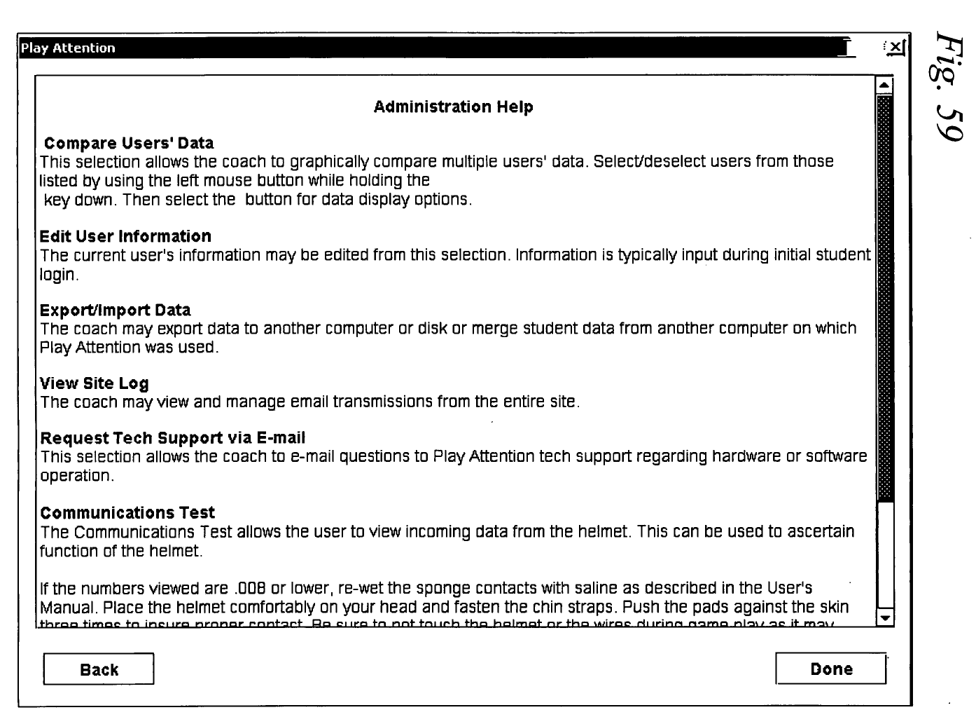

Selecting Admin as shown in FIG. 45 from the Main Menu (FIG. 23), accesses Compare User's Data, Edit User Information, Export/Import Data, View Site Log, Request Tech Support via E-mail, performs a Communications Test, or obtains the Admin Help Menu. The following pages specifically address each function under the <Admin> menu. Full site record editing can be done by logging in as System Administrator. FIG. 59 is a screen image of an Administration Help dialog box, describing various available options.

### Compare Student Data

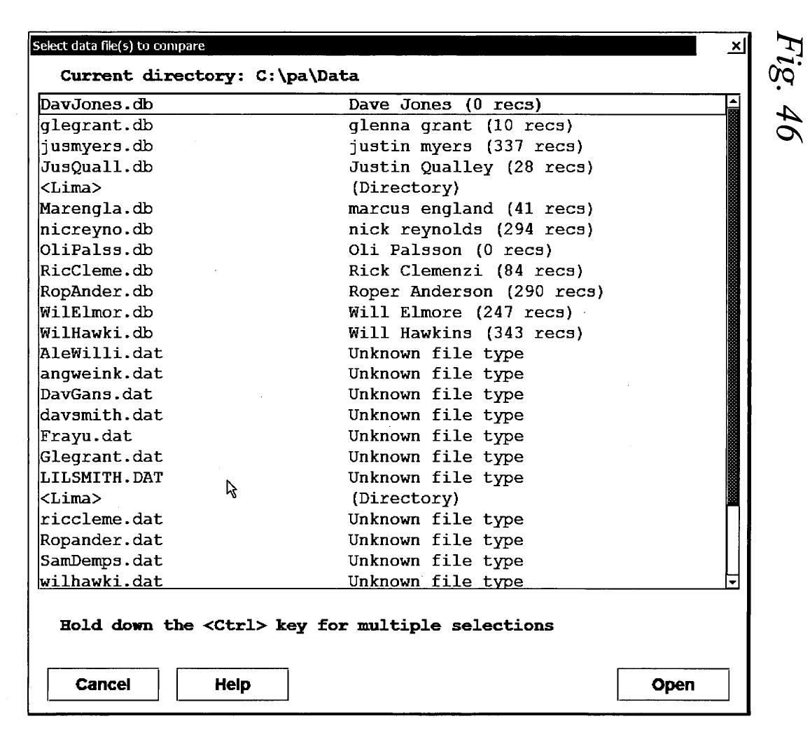

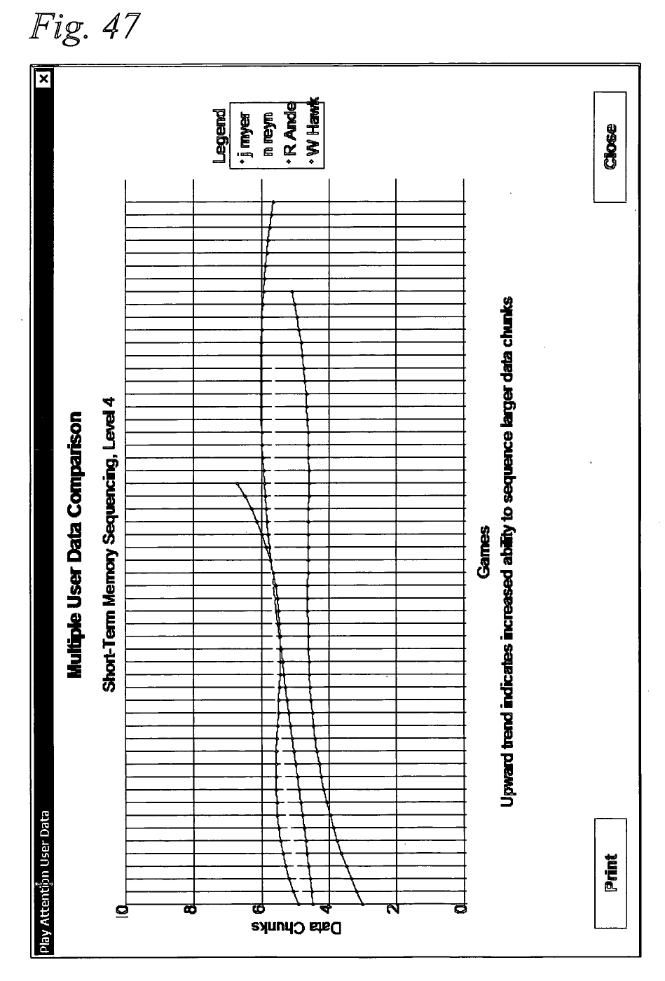

By selecting Compare Student Data from the User Data menu as referenced in FIG. 46, you can view, graph, and print multiple student data reports. This is a great feature to use if you need to demonstrate student progress or produce a report to an Administrator. Selecting Compare Student Data allows you to select multiple student data files. Hold down the <Ctrl> key to and click on the user files you wish to compare. Click <Open> and the menu is displayed as referenced in FIG. 39. Select the level that you want to compare and click Display. A graph will display multiple user data reports as shown in FIG. 47. Each student is graphed in a different color to distinguish data. Student reports in this example are numbered for confidentiality. Actual reports list the student file names under the legend. Print by clicking the <Print> button.

### Edit User Information

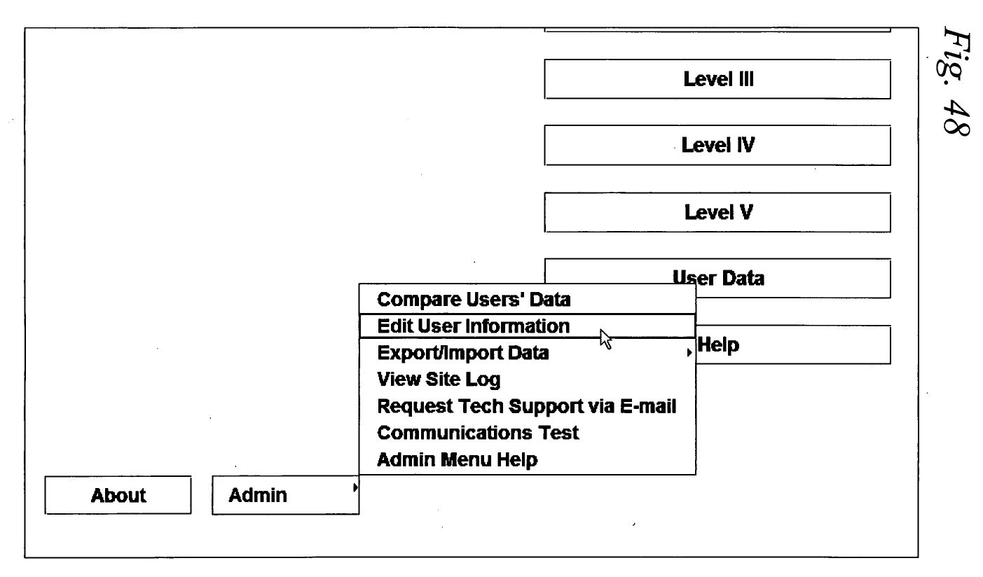

When Edit User Information as shown in FIG. 48 is selected under the Admin menu (FIG. 45), current user data can be edited. The standard User Record data screen is displayed and the data contained therein can be altered or completed if it is uncompleted. To fully edit all site information, you must login as System Administrator.

### General Information/Contact Information

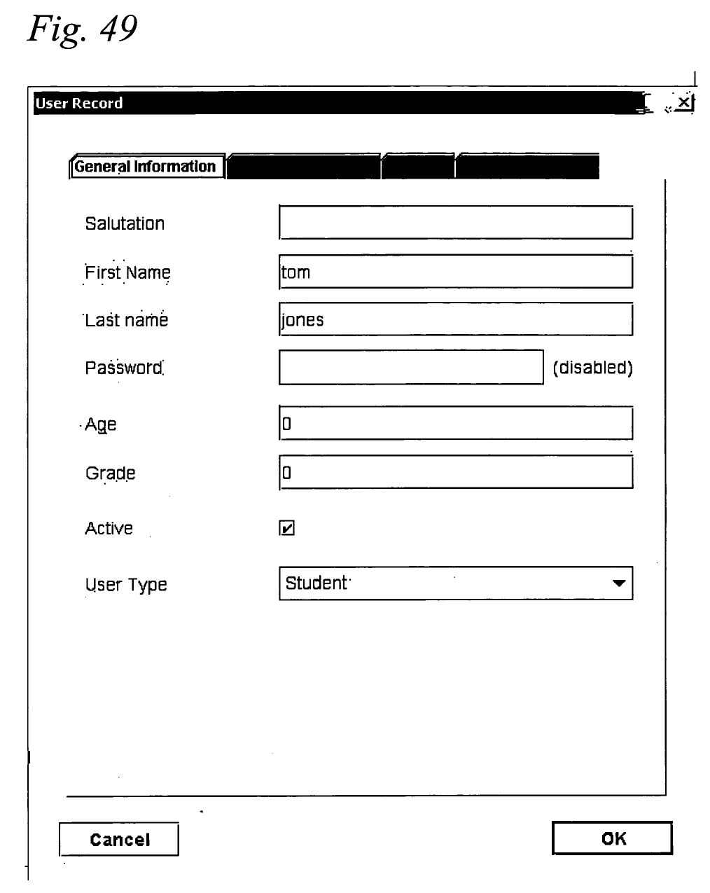

General Information as referenced in FIG. 49: Complete the name, age, and grade of the current student (user). A password is not required nor recommended. Be certain a check is placed in the box next to the Active menu selection. In the User Type field, identify the user as a coach or student.

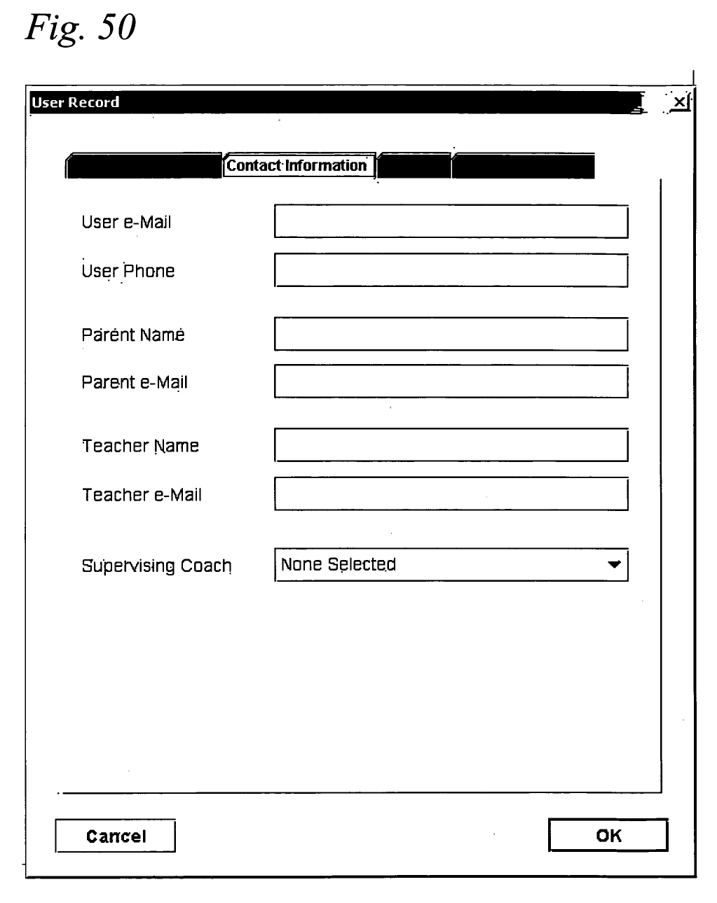

Contact Information as referenced in FIG. 50: Be certain to complete the user's name, telephone, and e-mail information. Complete the parent and teacher information if applicable. A supervising coach should also be selected. This ensures that all parties responsible for the student are kept informed of student progress. This also helps ensure transfer, generalization, and reinforcement of Play Attention training.

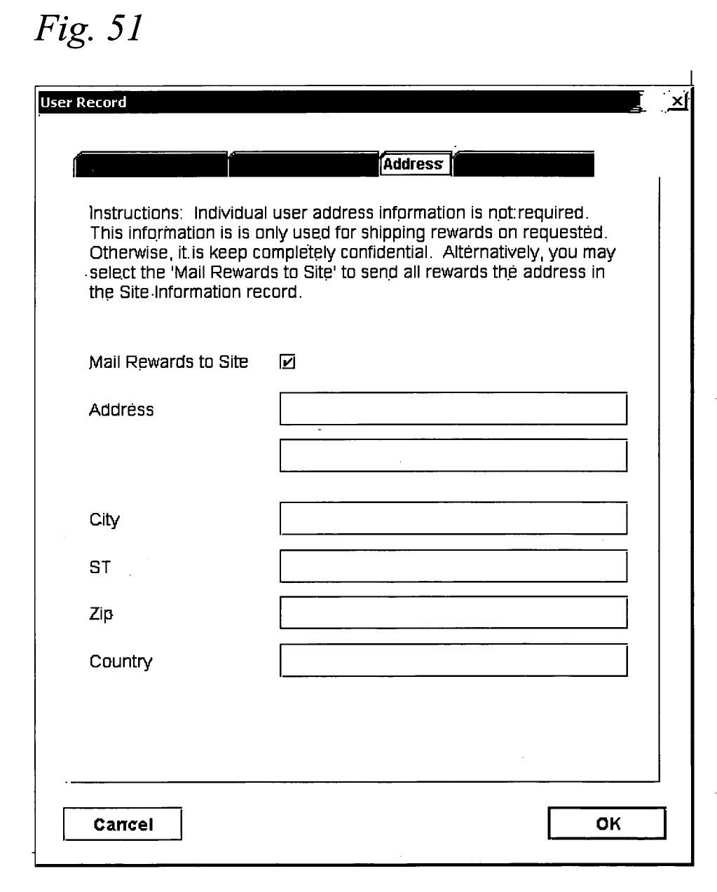

Address Information as referenced in FIG. 51: Type the address to which student rewards will be mailed. At predetermined intervals, Play Attention automatically prompts the coach to send an e-mail to Unique Logic and Technology, Inc. to retrieve student rewards.

Coach Control Information as referenced in FIG. 15: Play Attention is delivered with presets that provide the opportunity for greatest success. We strongly advise that they are not changed. However, if the coach desires to change the defaults, it can be done on this page. Click “Override Site Defaults” to customize the program for the current user. If the new user is logged in as coach, Play Attention requires the coach to input information. At various times, Play Attention sends product updates, patches, educational support messages, and valuable information to the coach. It is essential that this information be completed to provide the student the best possible opportunity for success.

### Export Data

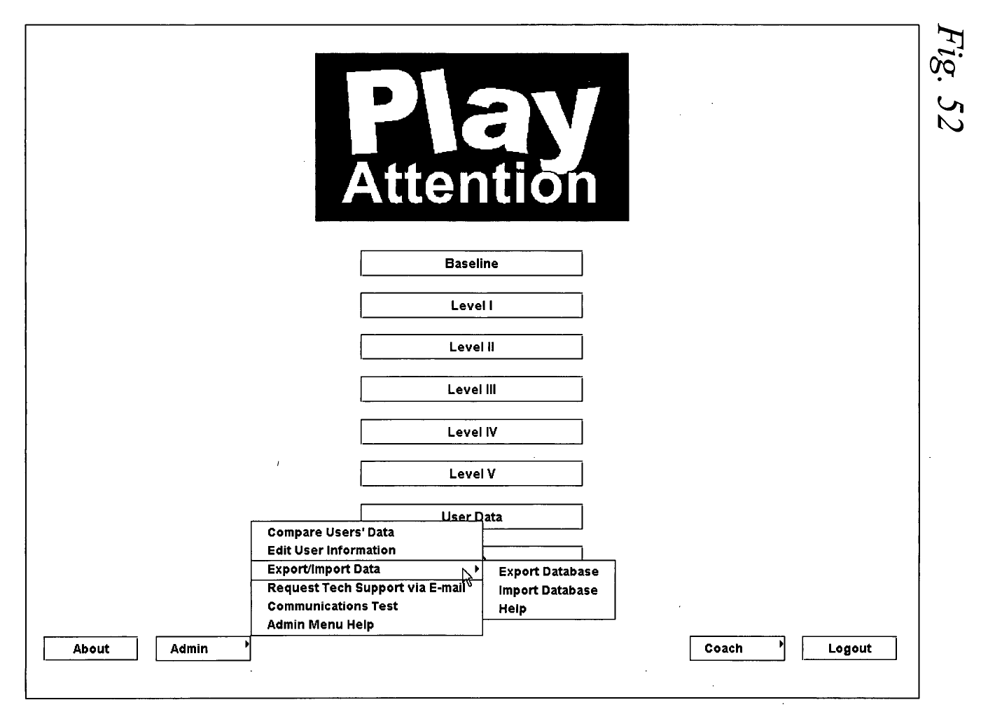

Sometimes it is necessary to export a file to another computer or to import files from another computer. To export data, click on Export/Import Data as shown in FIG. 52 from the Admin menu. Click on Export Database, and a menu is displayed requesting you to select a destination directory. Then select the directory or drive you wish to export the data by clicking on it. The file will be copied to the selected directory or drive when you click <Select>.

### Import Data

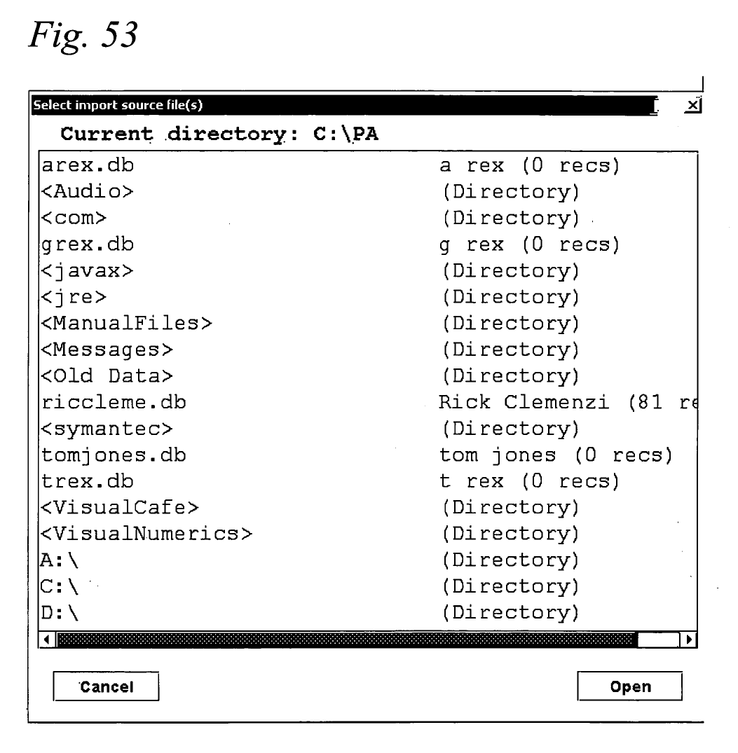

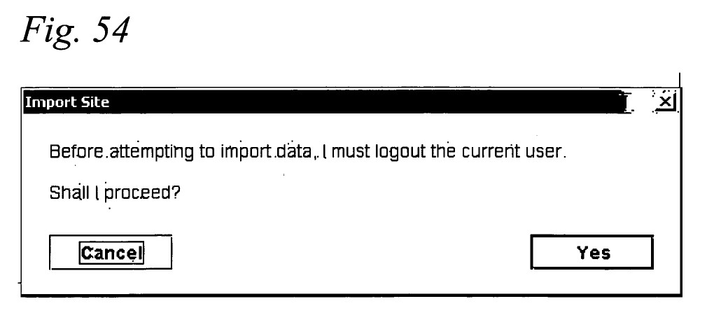

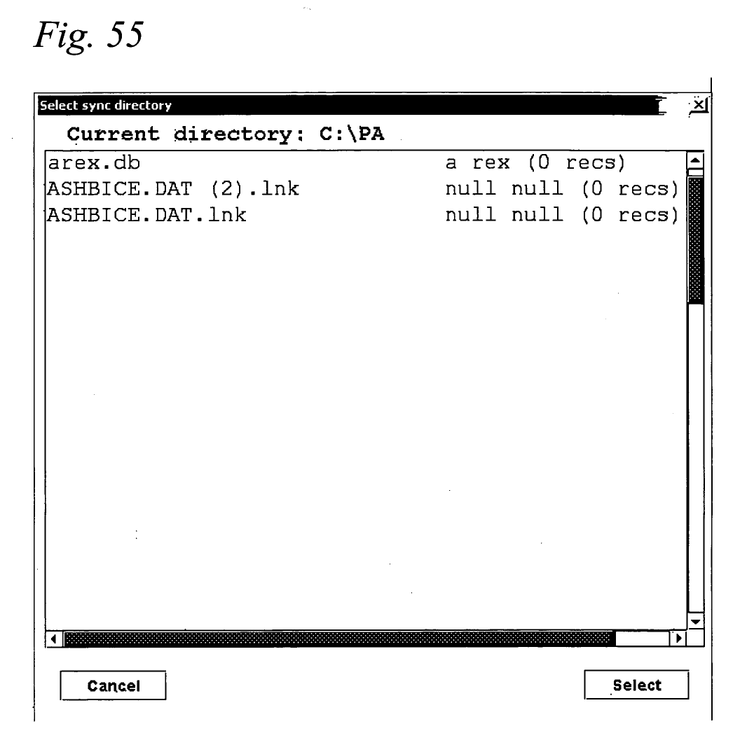

Often, schools must use more than one computer to train students due to logistics and scheduling constraints. Data generated on two non-networked machines (networked machines can use the shared folder option found under System Admin Site Record) can be combined using the Import Database function as referenced in FIG. 53 and found under the Admin menu (FIG. 45). Click on Import Database and a menu is displayed as referenced in FIG. 54. Select <Yes> to log out the current user and begin the import process.

Move to the directory as shown in FIG. 55 by clicking through the listed drives and directories. Select the directory or drive where the data file you want to import is located. Click on the appropriate file. Click <Select> and Play Attention will import the file in the PA directory of the current computer.

### View Site Log

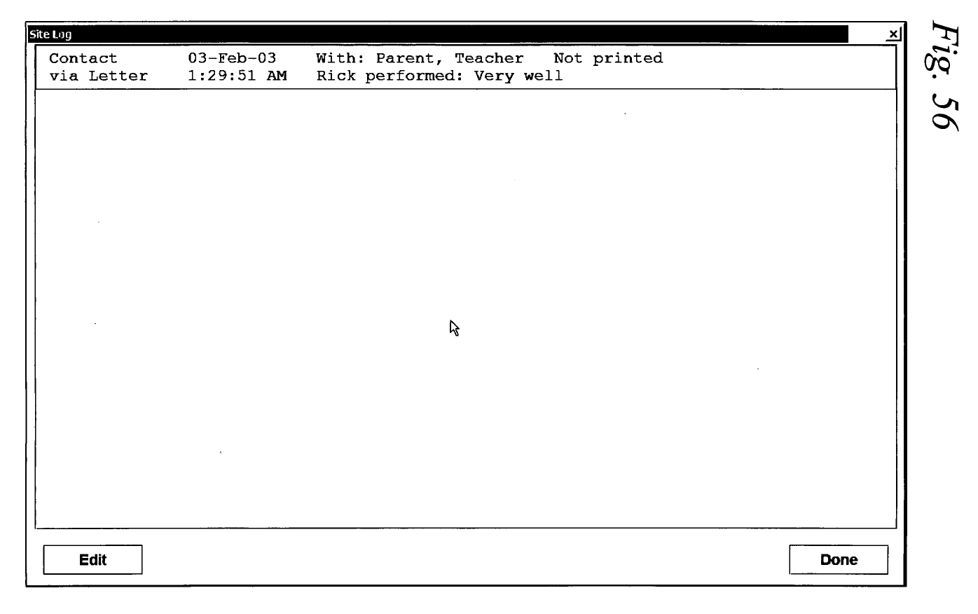

The View Site Log menu as shown in FIG. 56 is available under the Admin menu (FIG. 45). Its primary function is to assist the site administrator in managing and tracking e-mail. The coach or site administrator may view sent parent and teacher e-mails, and manage e-mails that failed to send correctly. Typically, this function may also be used by Play Attention tech support to assist the site administrator in correcting e-mail transmission files.

### Request Tech Support Via E-Mail

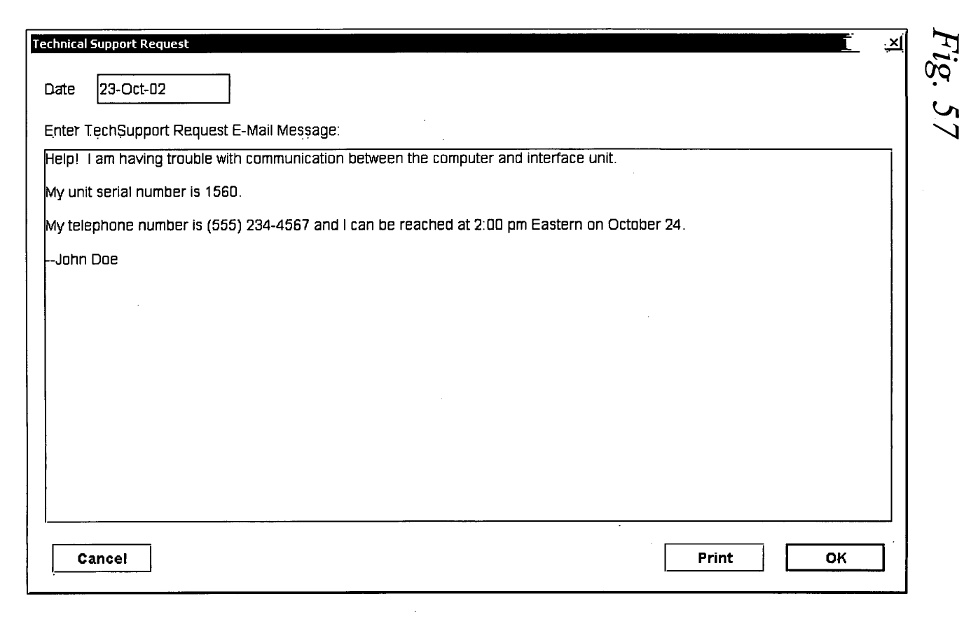

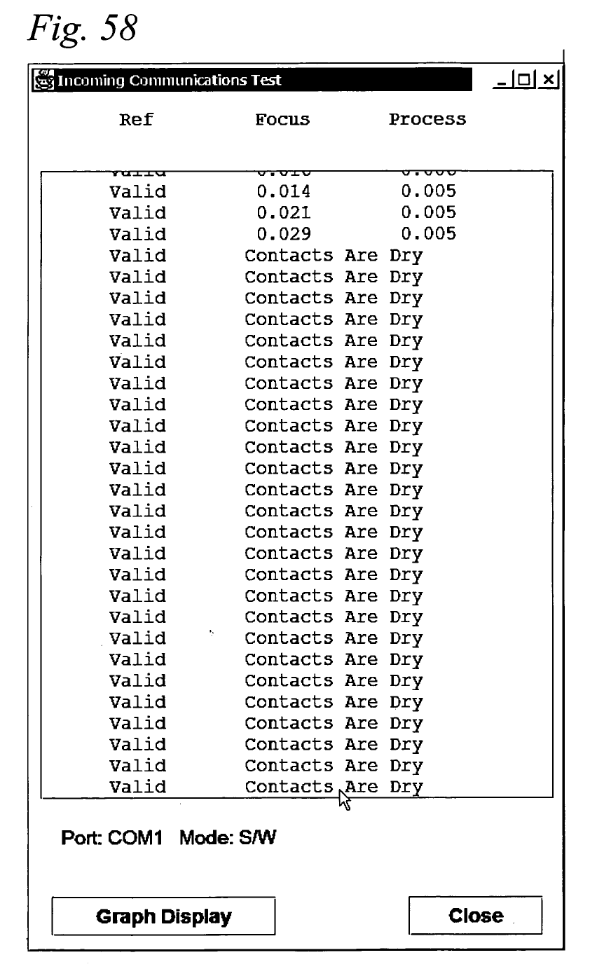

Selecting Request Tech Support via E-mail generates a screen as shown in FIG. 57. Type your message in the text box. As shown above, include an accurate description of the problem, your unit serial number found on the back of the interface box, and a time and telephone number where you can be reached. If you have entered your information in the site record database, your e-mail will be sent by clicking on<Send>. If you have not completed your site information, go to Edit User Information (FIG. 48) on the Admin menu, and complete the necessary information.

### Communications Test

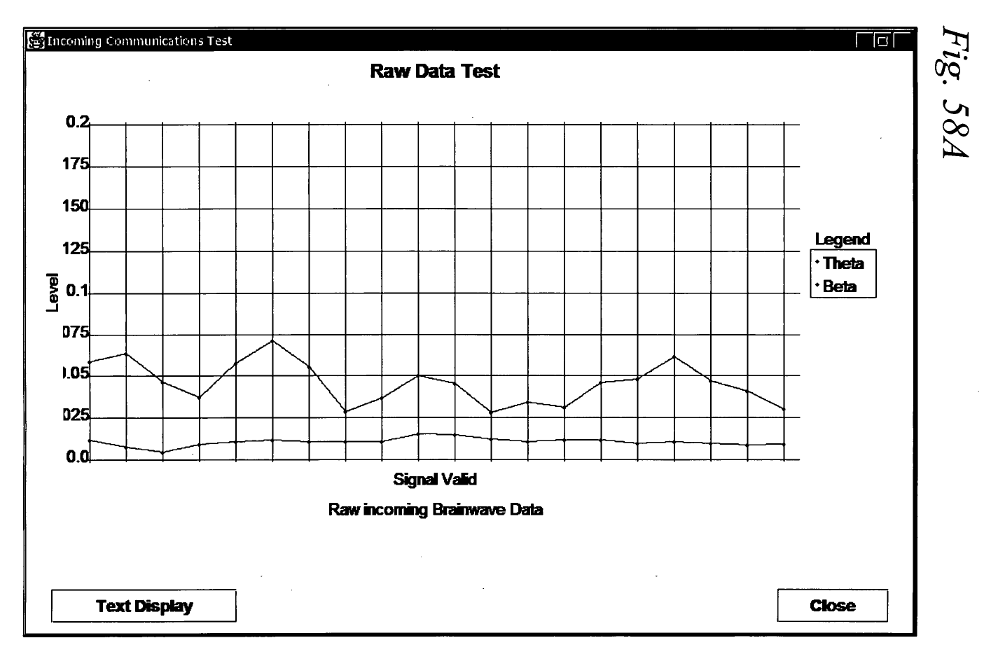

The Communications Test procedure helps diagnose communication problems between the Play Attention Interface Unit and the computer. Good contact and signal strength between user and computer are indicated by positive numbers on the display. When Communications Test is selected as shown in FIG. 58, you will observe incoming data. The Communications Test screen allows the user to see the data flow from the interface unit to the computer. If sensors are placed on the head and the interface unit is switched on, the data from the user is detailed on the screen. The reference should read—Valid or Invalid. By pressing ESC the user can terminate this screen. A graph of the incoming data may be viewed by selecting the appropriate screen during Communications Test as referenced in FIG. 58A.

### Coach

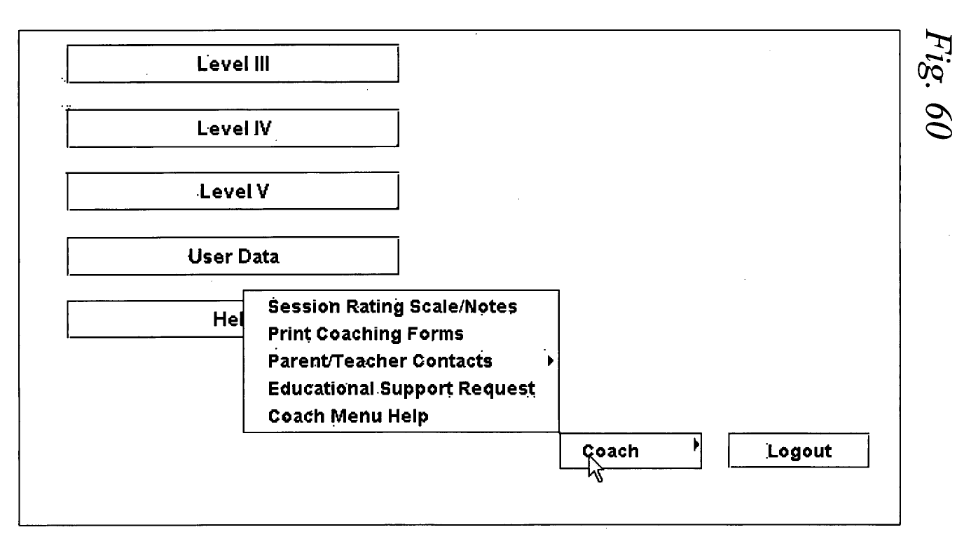

Clicking on the coach's button on the Main Menu page referenced in FIG. 60 provides the following selections:

Session Rating Scale/Notes allows the coach to modify session rating scale information or add specific notes about the current user.

Print Coaching Forms allows the coach to print forms for student records. Parent/Teacher Contact allows the coach to print or enter parent/teacher rating scale forms, compose & print a letter to the parent, e-mail parent or teacher, and enter a contact record containing notes from a parent or teacher meeting.

Educational Support Request allows the coach to e-mail Ed Support at Unique Logic and Technology, Inc. to obtain help with an educational problem or question.

Coach Menu Help reviews the options under the Coach menu.

Each of these selections is elaborated in the following sections.

### Coach's Session Rating Scale Notes

By selecting Coach's Session Rating Scale Notes, the following screen is displayed as referenced in FIG. 19. From this menu you may change totals for this session, print the CSRS, or add Notes.

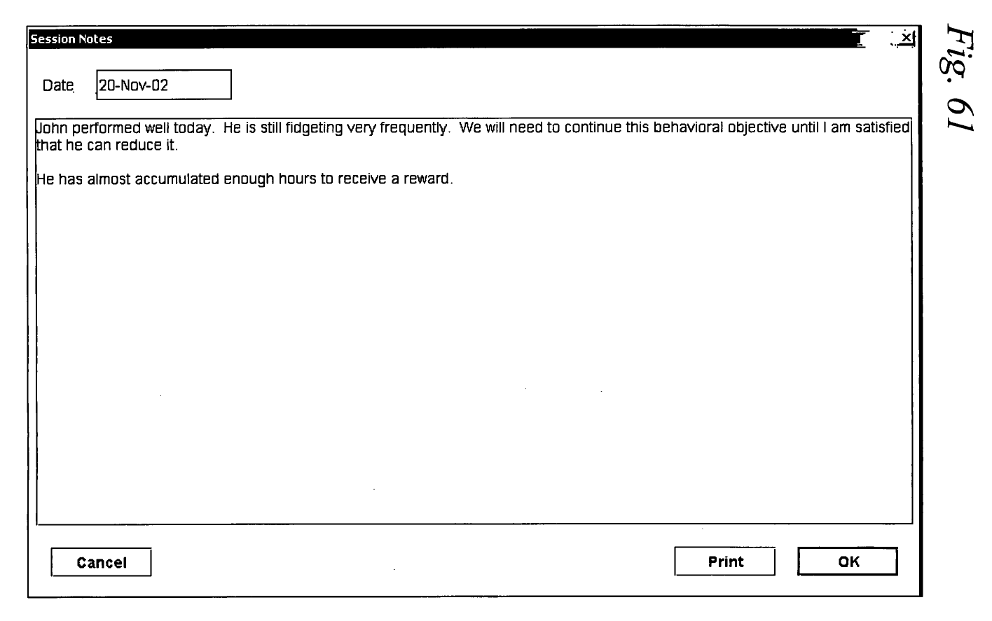

Selecting Notes displays the following screen as referenced in FIG. 61. It is used to maintain anecdotal records for the current session. This assists the coach in setting goals, providing continuity, and setting reminders.

### Print Coaching Forms

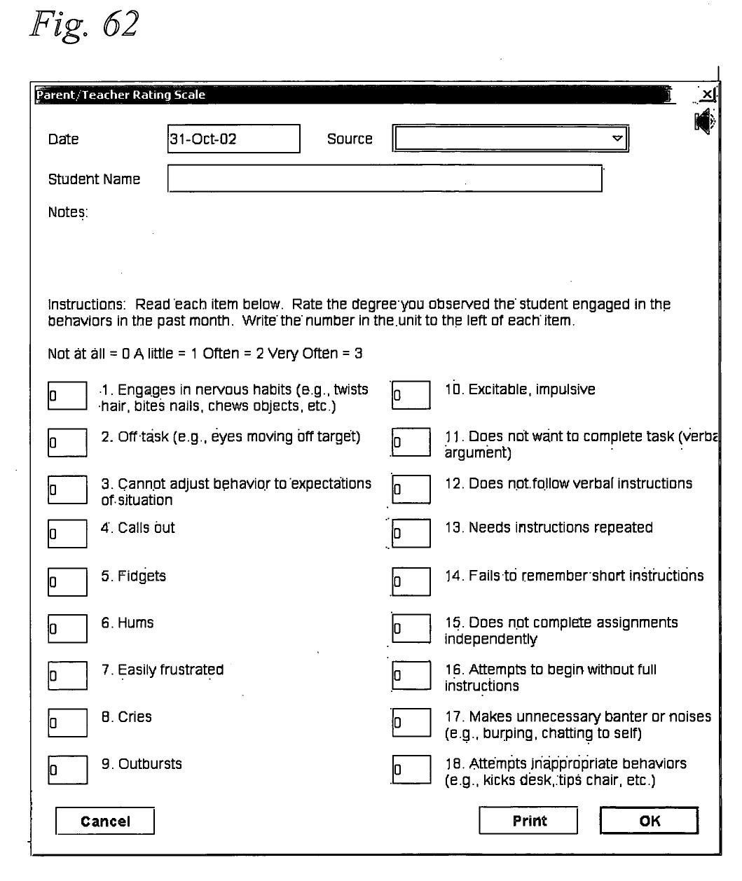

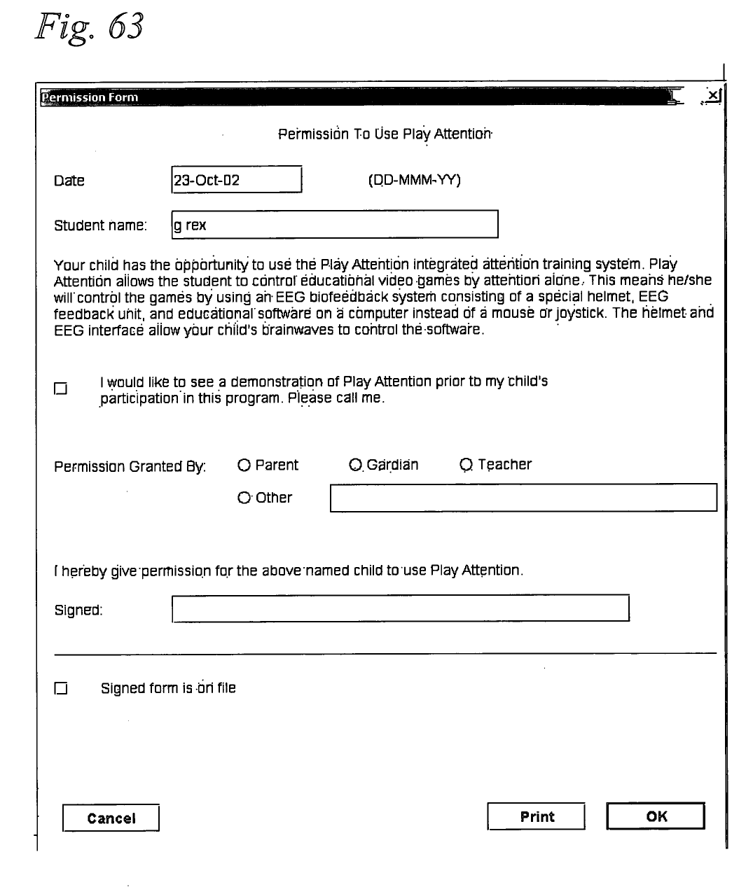

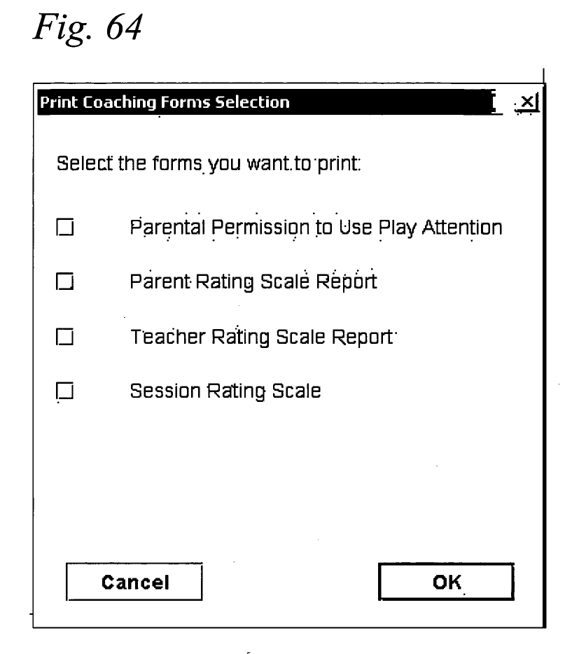

For the best possible assessment of your student and for proper administration, Parent/Teacher Rating Scales as referenced in FIG. 62 and the Play Attention permission form as referenced in FIG. 63 should be completed prior to beginning your Play Attention program. The forms can be printed from the Main Menu (FIG. 26) by clicking on<Coach > (FIG. 60) then selecting <Print Coaching Forms> as referenced in FIG. 64. Once <Print Coaching Forms> has been selected, a menu is displayed as referenced in FIG. 64A. Select the form you wish to print by clicking in the box next to your selection. A check mark will appear. Click <OK> to print.

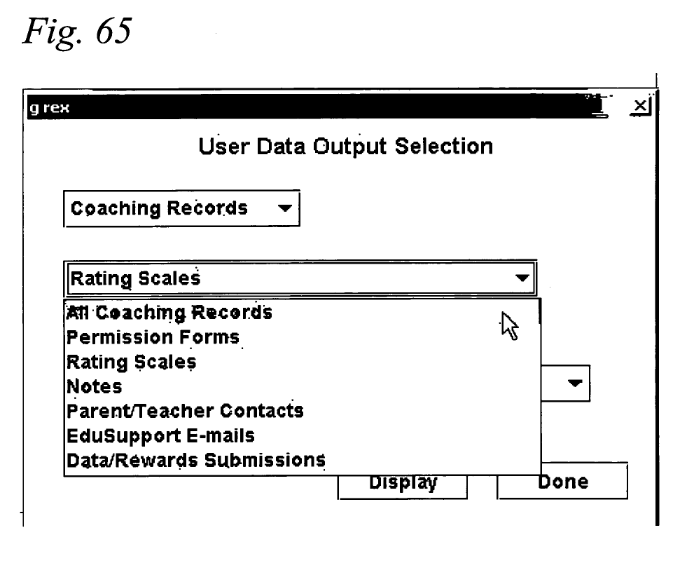

Once the printed Parent/Teacher Rating Scales have been completed and returned to the coach, this data may be entered under <Main Menu> (FIG. 26), <Coach> (FIG. 60), <Enter Parent/Teacher Contact> as referenced in FIG. 65.

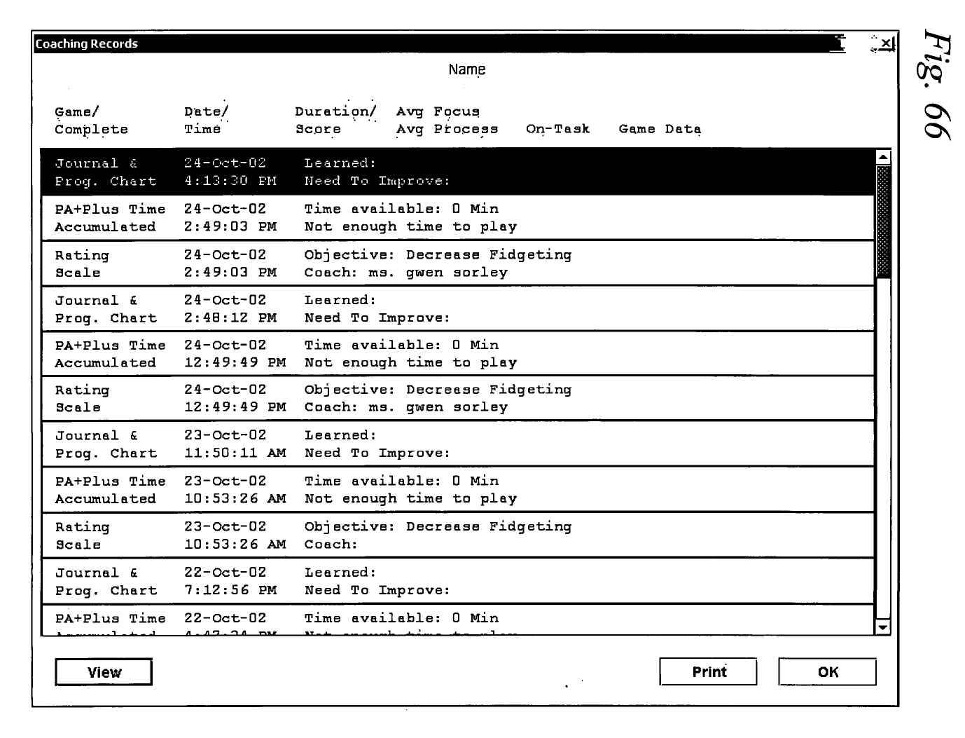

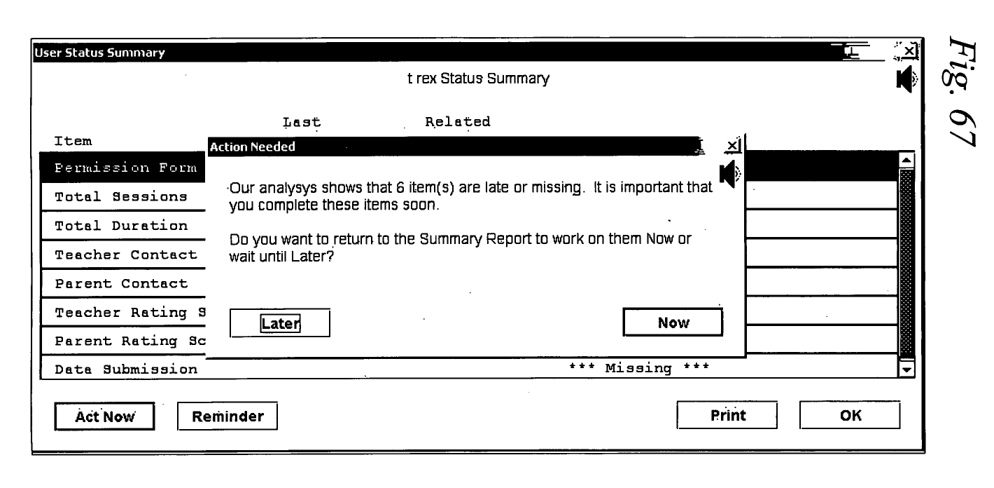

To add notes, review this data, or register receipt of the Parent Permission Form, go to <User Data> (FIG. 38) on the main menu and select <View All Data> as referenced in FIG. 66.

### Parent/Teacher Contacts

By selecting Parent/Teacher Contacts from the Coach menu, a menu is displayed as referenced in FIG. 65. You may select from Permission Form, Parent/Teacher Rating Scale, Letter to Parent/Teacher, E-mail to Parent Teacher, or Contact/Meeting Notes.

The following sections explain and elaborate each of these selections.

### Permission Form

A permission request is suggested before beginning Play Attention training in institutions. It notifies parents that their child has been selected to participate in the program due to attention difficulties. Since this particular child or student has been identified as having attention problems and administration has decided to alter his/her curriculum, it is reasonable and wise to inform parents of the change.

Clicking on the Permission Form button presents a menu as referenced in FIG. 63. Print the form, send it home to be signed, then return to this selection and click the box indicating the “Signed form is on file” when the form has been returned properly signed.

### Parent/Teacher Rating Scale

Play Attention will prompt the coach to have a Parent/Teacher Rating Scale Form completed during the initial training stages as referenced in FIG. 62. When completed, it offers the coach insight into the behaviors of the student as witnessed by parents and teachers. You may print the Parent/Teacher Rating Scale Form from either the training prompts or from this menu. Once completed and returned to the coach, enter the information from the printed forms here for reference. Note that the source of the rating scale can be entered here to identify it as either Parent or Teacher. Instructions to fill out the form are simple. Have the parent or teacher read the items listed, then rate the degree the student engaged in the behaviors as 0, meaning not at all; 1 indicating the behavior was witnessed a little; 2 indicating the behavior was witnessed often; and 3 indicating the behavior was witnessed very often.

Once the parents and teacher have completed these forms and returned them, the coach determines the behaviors that the student exhibits most frequently at home and school.

### Letter to Parent/Teacher

After a session, it is good practice to send a letter to the parent and teacher that describes what transpired during the session. The letter serves two purposes; (1) the student gets positive reinforcement for his efforts, and (2) the parent/teacher is informed of behavioral or academic goals that are to be reinforced at home or in the classroom.

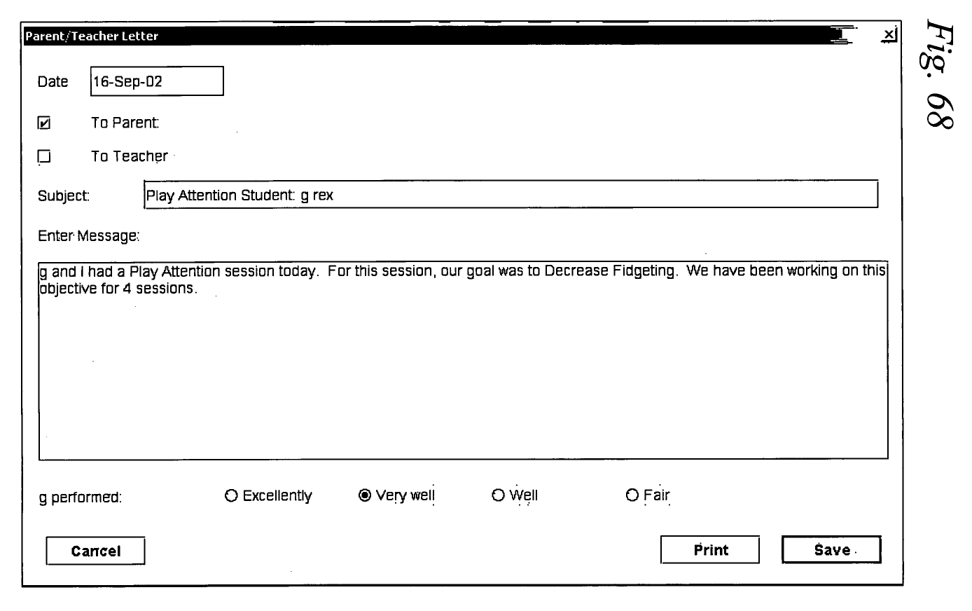

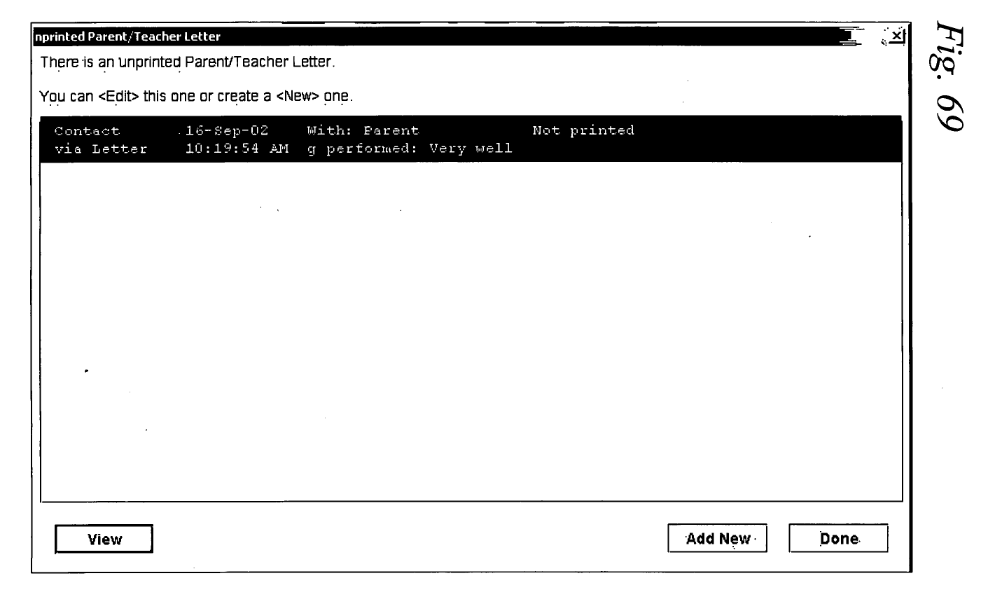

Click on the Letter to Parent/Teacher button and the following form is displayed as referenced in FIG. 68. Place a check by clicking in the box next to <To Parent and/or To Teacher> to indicate the recipient of the letter. Print the letter and send it with the student. If you have typed a letter and it was not printed, a screen will display a prompt as referenced in FIG. 69. Double click on the unprinted letter and you may either edit it or send it in the manner described previously under Letter to Parent/Teacher.

### E-mail to Parent/Teacher

Clicking on this option allows you to send a quick e-mail to either the parent or teacher. It can serve as valuable reinforcement for the student, a request for a meeting, or request for information that has not been completed like a missing parent or teacher rating scale.

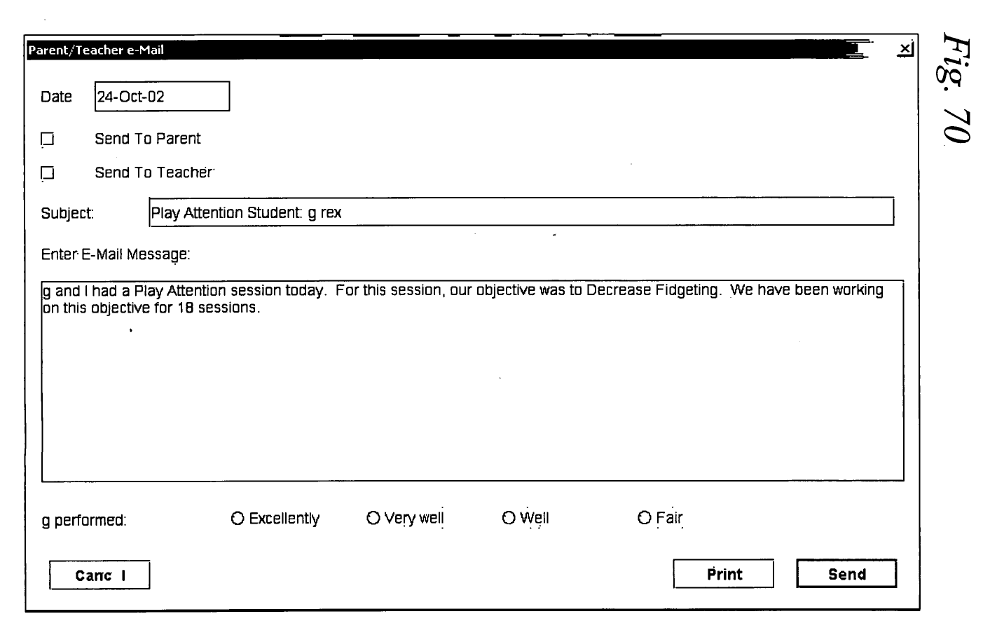

Clicking on E-mail to Parent/Teacher produces a menu as referenced in FIG. 70. Provided you have completed the User Information section found under the Admin menu and requested upon initial student login, you may send an e-mail after selecting parent or teacher and clicking on<Send>.

### Contact/Meeting Notes

For proper administration and record keeping, it is often necessary to keep notes after meeting with the student's parents or teachers. Click on Coach, then Parent/Teacher Contacts and select Contact/Meeting Notes. These Contact/Meeting Notes are also referred to herein as a Contact Record.

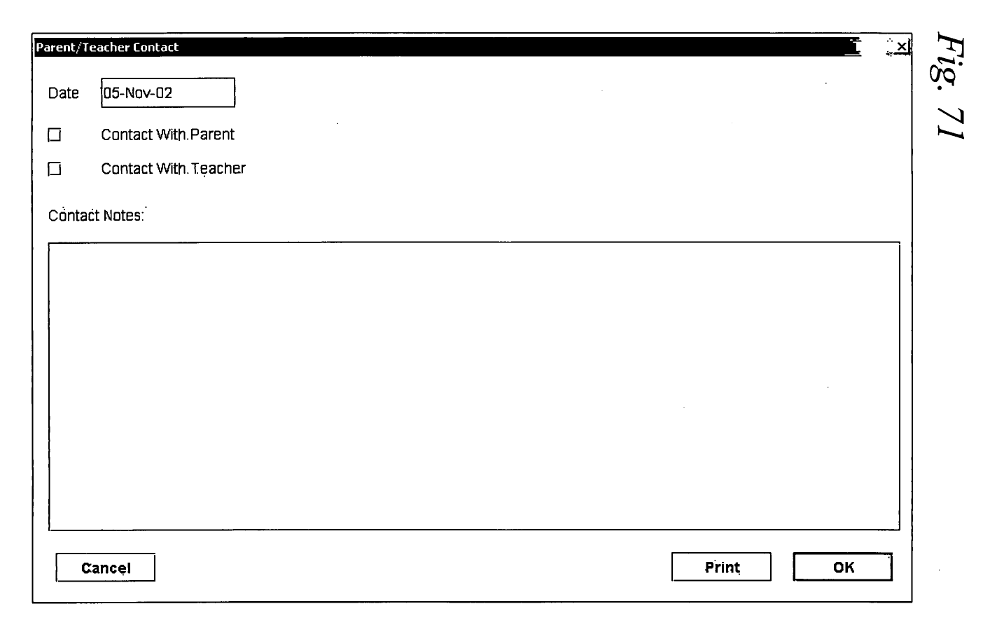

A screen is displayed as referenced in FIG. 71. Place a check in the box next to the Contact With Parent or Contact With Teacher selections to indicate who attended the meeting. Clicking in the space below Contact Notes will allow you to type your notes as needed. Press <Print> or <OK> when you've finished. If<OK> is selected, the file will be saved in the current user's database.

### Educational Support Request

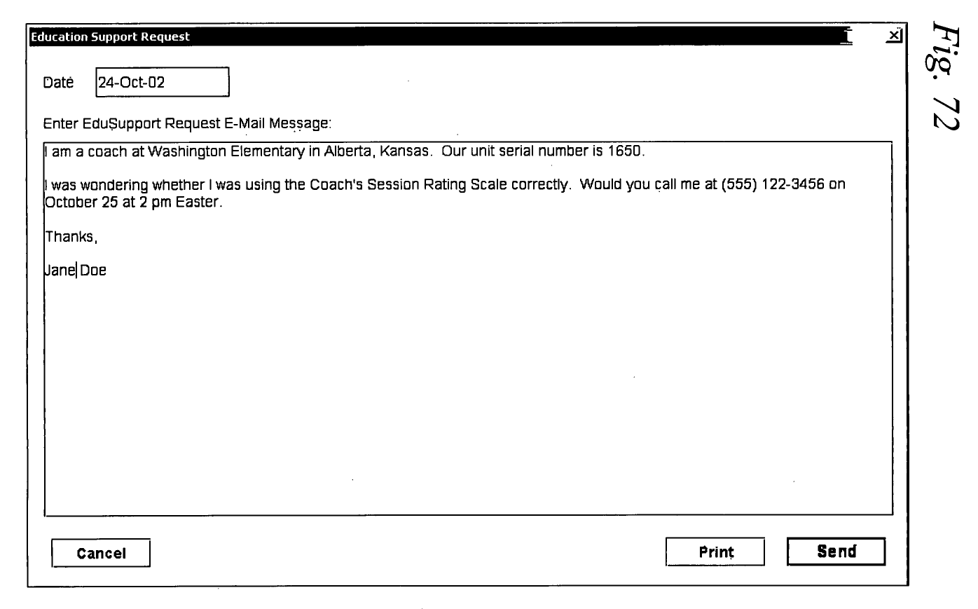

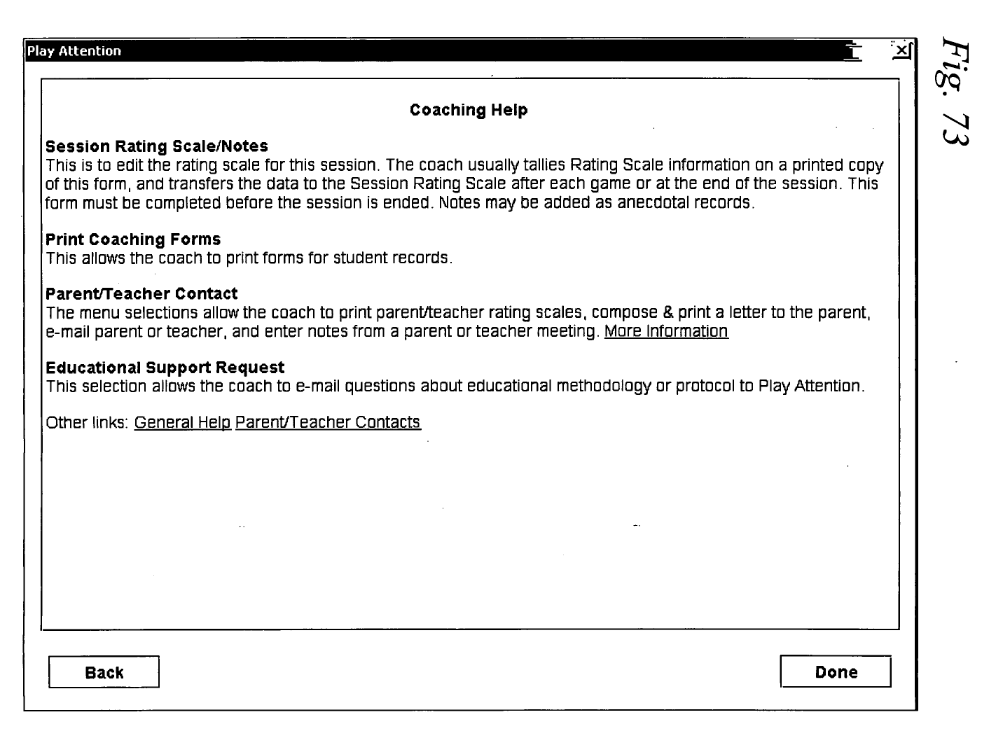

If the coach has questions regarding Play Attention's educational protocol, methodology, or strategies, response can be obtained via e-mail. Simply click on Educational Support Request and a menu is displayed as referenced in FIG. 72. Fill out the e-mail providing your:

Interface Unit ID (located on the back of the interface unit);

Site name and address;

Telephone number;

Your contact name;

A convenient data and time to call you; and

Your question.

Click <Send> to e-mail the note.

### Additional Description

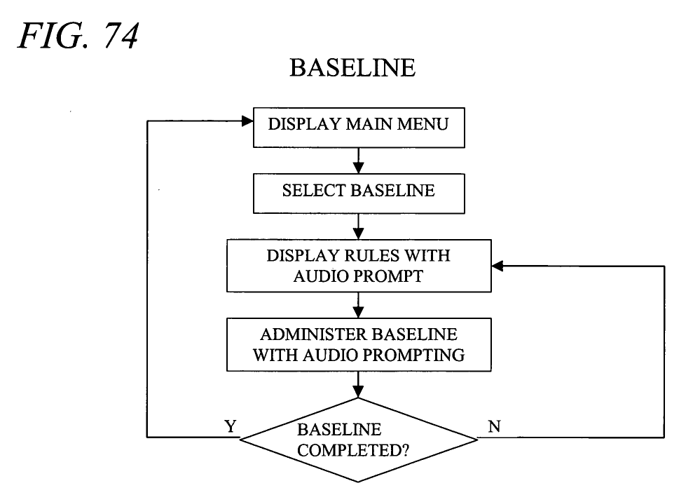

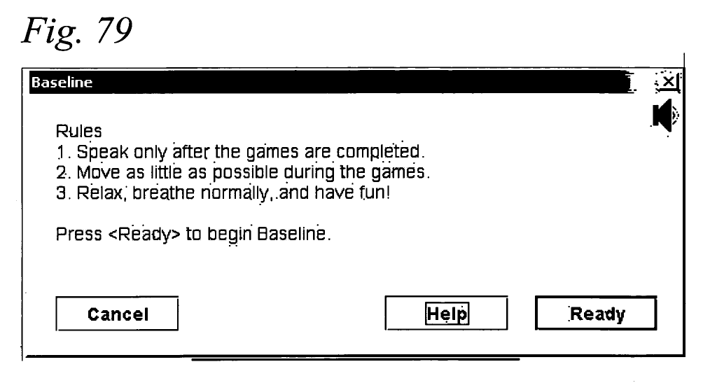

FIG. 74 shows the flowchart relating to taking the user's feedback baseline. Significant to taking the baseline is being certain the user reviews the rules beforehand as shown in FIG. 79. The exact nature of the Baseline display is not depicted here. However, the Baseline is specifically designed to require the user is at a moderate level of attention roughly similar to that level of attention for successfully completing the game Levels I-V. This more accurately guarantees that the baseline taken is appropriate for feedback during game play. The typical method of taking a baseline is a more passive instrument, and can easily be fooled to give an easier than appropriate baseline. The baseline implemented deliberate provides a series of random alternate stimuli which the user must respond to in a timely matter. If the user does not respond promptly to each random stimuli, the baseline will not complete, and it must be taken again. As said before, the currently implemented Baseline task is a series of blocks randomly placed on the screen and left in place, with an alternate color indicating the response stimuli. However, we intend to implement alternate forms of the baseline continuing the random and alternating stimuli paradigm.

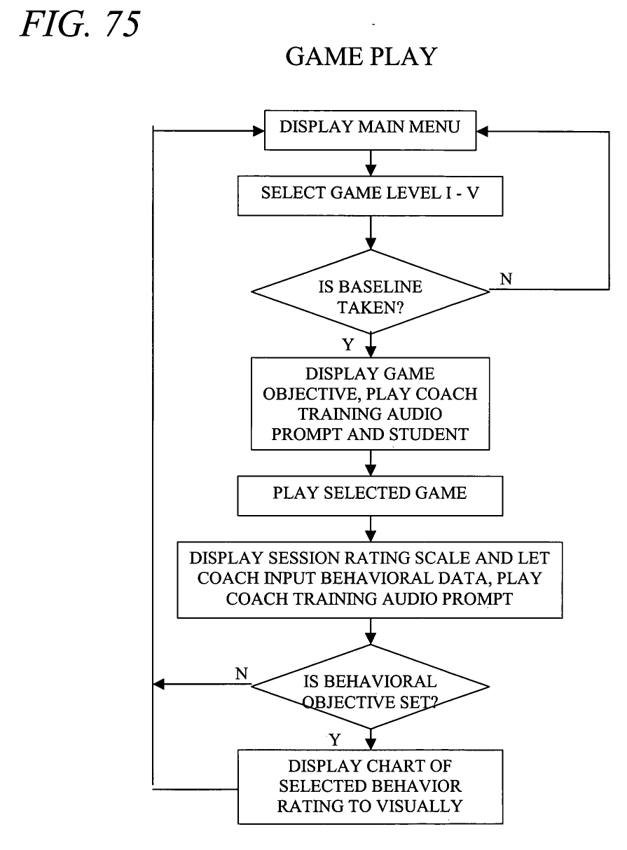

FIG. 75 shows the flowchart depicting the complete Game Play cycle. Many important components of the integrated attention training program are included in this cycle. The components of this cycle have been thoroughly presented elsewhere. The basic idea of the cycle is to assure a baseline has been taken, to assure the coach is prompted for behavioral data after the game for immediate recording with the student, and to further support that behavioral data by visually compiling data from this game with that from previous games played in this session. This lets the coach and student focus strongly on the objective that has been set and effectively work on it throughout the session, and to assure a multi-mode data presentation to better evoke an understanding in the student of the problem area being worked on.

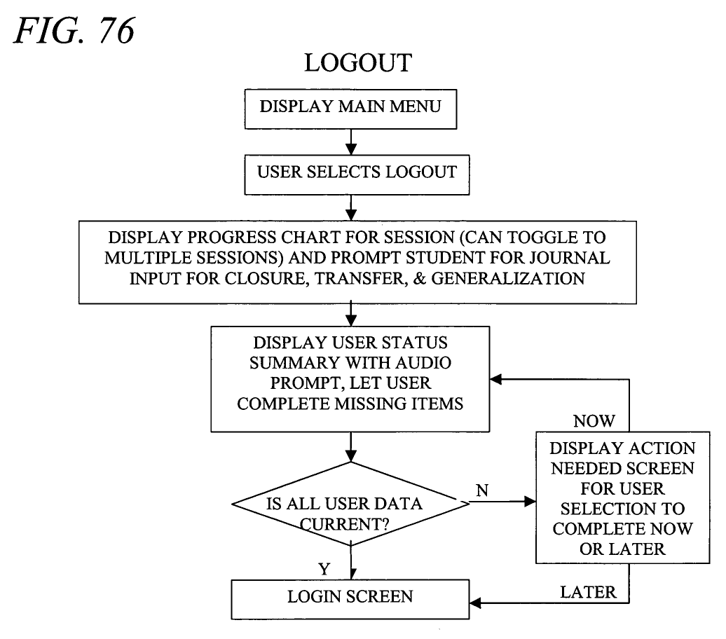

FIG. 76 shows the flowchart describing the Logout process. This process is particularly involved as many pieces and steps are involved to make sure time is taken with the user for closure and reflection. Also, it includes the User Status Summary which lets the coach/user know whether they are utilizing the system within the parameters that have been demonstrated to be effective elsewhere.

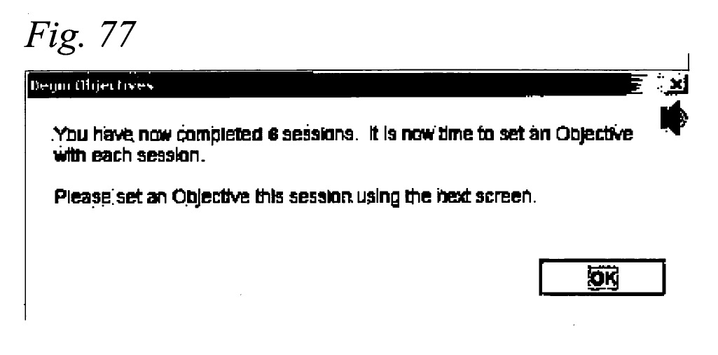

FIG. 77 shows the Time To Begin Objectives notice. The user receives this notice after a certain number of sessions to let them know it is time to begin setting a specific objective on the CSRS for each session. The number of sessions after which this message appears is set in the Coaching Controls page of the Site (FIG. 6), Coach (FIG. 15), or User Record (page not shown), with the Coach Record being able to override the default value given in the Site Record for all sessions lead by that coach, and the User Record being able to override the Coach or Site setting for that individual user.

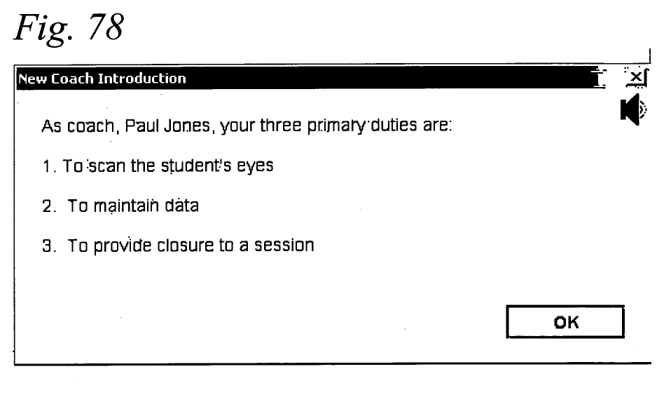

FIG. 78 shows the Coach Introduction message. This is to help coaches with all levels of experience and frequency of use with the system to be reminded of the important components of coaching. This is important as the system is specifically designed to accommodate users of all backgrounds and experience, while helping and guiding them to properly coach the attention training session for maximum effect. This and many other coach training screens and audio prompts will be configured to only appear for a limited number of times and then optionally not re-appear. This time-out mechanism also has a degree of intelligence to it with rules governing both the time-out and possibly re-appearance of each such prompt. For example, the coach training screens and audio prompts might become re-enabled if a certain coach has not used the system recently. Also, the coach training turn off and/or turn on controls may relate to the frequency of use by the coach, the age of the student, and the physical setting. It also may vary according to whether the coach or user demonstrates a degree of proficiency with the system through some sort of test means.

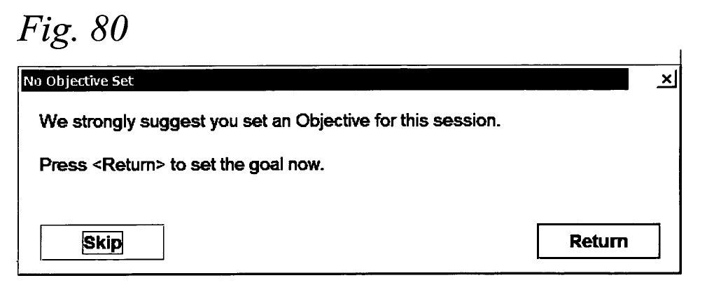

FIG. 80 shows the No Objective Set warning received when an objective is not set on the CSRS even though it is past the Time To Begin Objectives based on the various Coaching Controls. This form is designed to generally remind and guide the user and/or coach to return and set an objective on the CSRS, but allows continuing without setting an objective by affirmatively pressing the <Skip> button.

While specific embodiments of the invention have been illustrated and described herein, it is realized that numerous modifications and changes will occur to those skilled in the art. It is therefore to be understood that the appended claims are intended to cover all such modifications and changes as fall within the true spirit and scope of the invention.

What is claimed is:

1. Computerized training apparatus comprising:
a computer system including a display, an input device and a sound output device;
an attention training subsystem including a device for measuring electrical activity of the brain of a user and software within said computer system to provide real-time feedback to the user of the user's state of attention;
a behavior modification support subsystem including a database within said computer system for storage of data relating to behavior and behavioral goals, and computer software that presents automated forms for entry of the data into said database and retrieval and reporting the data from said database, the data including data to support one or more of behavioral rating scales, goal setting records, session journals, and progress charts; and
a coaching support subsystem including one or more of software within said computer system to generate coaching audio prompts through said sound output device, software within said computer system to generate training audio prompts through said sound output device, and software within said computer system to generate letters and e-mail messages for teambuilding support.

2. The apparatus of claim 1, wherein said attention training subsystem includes software within said computer system to implement at least one attention training exercise.

3. The apparatus of claim 2, wherein said attention training subsystem includes software within said computer system to implement a plurality of specific attention training exercises which are selected.

4. The apparatus of claim 2, wherein said attention training subsystem includes software within said computer system to implement specific attention training exercises which are selected and executed either for a specific duration or until a particular exercise is completed.

5. The apparatus of claim 2, wherein said attention training subsystem includes software within said computer system to implement at least one attention training exercise which is a cognitive skills exercise.

6. The apparatus of claim 5, wherein said attention training subsystem includes software within said computer system to implement at least one cognitive skills exercise selected from the group consisting of a short-term memory exercise, an attention stamina exercise, a task completion exercise, and a decision making exercise.

7. The apparatus of claim 3, wherein said computer system includes software to provide audio prompting to the user of an objective and method of play for the selected attention training exercise prior to beginning execution of the selected attention training exercise.

8. The apparatus of claim 1, wherein said database contains a behavioral rating scale which includes a list of commonly exhibited behaviors observed in people with attention problems.

9. The apparatus of claim 1, wherein said computer system includes software to provide a prompt to select a user behavioral objective from a list of commonly exhibited behaviors observed in people with attention problems.

10. The apparatus of claim 2, wherein
said database contains a behavioral rating scale which includes a list of commonly exhibited behaviors observed in people with attention problems; and wherein
said behavior modification support subsystem includes software within said computer system to display said behavioral rating scale following completion of execution of the attention training exercise.

11. The apparatus of claim 10 wherein said behavior modification support subsystem includes software within said computer system to allow entry via said input device of behavioral rating scale data into said database including the total number of observed instances of each exhibited behavior during execution of the attention training exercise.

12. The apparatus of claim 10 wherein said behavior modification support subsystem includes software within said computer system to allow entry via said input device of behavioral rating scale data into said database including the total number of observed instances of each exhibited behavior during execution of the attention training exercise and an identification of a coach observing the user during execution of the attention training exercise.

13. The apparatus of claim 11 wherein said behavior modification support subsystem includes software within said computer system to allow review of behavioral rating scale data previously entered into said database including the total number of observed instances of each exhibited behavior during a previous execution of the attention training exercise.

14. The apparatus of claim 13 wherein said behavior modification support subsystem includes software within said computer system to allow review of behavioral rating scale data previously entered into said database including the total number of observed instances of each exhibited behavior during a previous execution of the attention training exercise by presenting a multiple choice selector which lists only those attention training exercises executed during a session.

15. The apparatus of claim 11 wherein
said database contains a permanent data record of at least one user; and wherein
said behavior modification support subsystem includes software within said computer system to allow storage within said database of the behavioral rating scale data including the total number of observed instances of each exhibited behavior during execution of the attention training exercise as at least part of the permanent data record of the at least one user.

16. The apparatus of claim 8, wherein said database contains a behavioral rating scale which further includes a behavioral objective chosen for a session.

17. The apparatus of claim 8 wherein said behavior modification support subsystem includes software within said computer system to cause display of behavioral rating scale data as a template for selecting a behavioral objective.

18. The apparatus of claim 1, wherein said computer system includes software to provide a prompt to select a user behavioral objective after completion of a predetermined number of sessions.

19. The apparatus of claim 1, wherein said behavior modification support subsystem includes software within said computer system to provide a prompt to select a user behavioral objective, the prompt including at least one of totals of previously recorded exhibited behaviors from prior sessions depicted on a behavioral rating scale, and the behavioral objective chosen in an immediately prior session.

20. The apparatus of claim 19, wherein said behavior modification support subsystem includes software within said computer system to provide a warning that no behavioral objective is set for a current session in the event selection of a behavioral objective is skipped.

21. The apparatus of claim 1, wherein said behavior modification support subsystem includes software within said computer system to provide a prompt to select a user behavioral objective after completion of a selected number of prior sessions, the prompt including at least one of totals of previously recorded exhibited behaviors from prior sessions depicted on a behavioral rating scale, and to permit selection of the number of prior sessions included in the totals of previously recorded exhibited behaviors.

22. The apparatus of claim 1, wherein said behavior modification support subsystem includes software within said computer system to display a progress chart which shows the number of exhibited behaviors recorded with reference to a selected behavioral objective.

23. The apparatus of claim 1, wherein
said attention training subsystem includes software within said computer system to implement a plurality of specific attention training exercises; and wherein
said behavior modification support subsystem includes software within said computer system to display a progress chart which selectively shows the number of exhibited behaviors as recorded after each attention training exercises executed during a current session.

24. The apparatus of claim 1, wherein said behavior modification support subsystem includes software within said computer system to display, during a training session for which a particular behavior objective is selected, a progress chart which selectively shows the total number of exhibited behaviors as recorded during prior sessions for which the same behavioral objective was selected.

25. The apparatus of claim 1, wherein said behavior modification support subsystem includes software within said computer system to display a progress chart which shows the number of exhibited behaviors recorded with reference to a selected behavioral objective and which includes a valuation of the progress made by the user in controlling a selected behavioral objective.

26. The apparatus of claim 1, wherein said behavior modification support subsystem includes software within said computer system to present at the end of each session a journal entry form prompting the user to reflect on progress made with reference to a selected behavioral objective.

27. The apparatus of claim 1, wherein said behavior modification support subsystem includes software within said computer system to, on the same screen at the end of each session,
display a progress chart for visual review of progress made by the user based on the number of exhibited behaviors observed and recorded with reference to a selected behavioral objective, and
present a journal entry form prompting the user to reflect on progress made with reference to a selected behavioral objective.

28. The apparatus of claim 26 wherein said behavior modification support subsystem includes software within said computer system to present a journal entry form which also allows a behavioral objective to be suggested for the next session.

29. The apparatus of claim 26 wherein said behavior modification support subsystem includes software within said computer system to display the journal at the beginning of the next session to facilitate review of objectives previously established for that session.

30. The apparatus of claim 1, wherein said behavior modification support subsystem includes software within said computer system to maintain a rating scale form for periodic entry of external subjective behavioral rating assessments of the user, the rating scale form including a list of commonly exhibited behaviors observed in people with attention problems.

31. The apparatus of claim 1, wherein said behavior modification support subsystem includes software within said computer system to provide audio and visual prompting to the user of general attention training behavioral guidelines prior to attention training.

32. The apparatus of claim 1, wherein:
said attention training subsystem includes software within said computer system to implement at least one attention training exercise; and wherein
said behavior modification support subsystem includes software within said computer system cooperating with the attention training software to integrate on-screen and auditory randomized distracters into the attention training exercise during execution.

33. The apparatus of claim 32 wherein software within the system requires the user to respond to the distracters in an appropriate manner.

34. The apparatus of claim 32 wherein software within the system requires the user to respond to the distracters by pressing a key on the keyboard.

35. The apparatus of claim 1, wherein:
said attention training subsystem includes software within said computer system to implement at least one attention training exercise; and wherein
said behavior modification support subsystem includes software within said computer system cooperating with the attention training software to integrate on-screen and auditory randomized distracters into the attention training exercise during execution, the distracters being selected from the group consisting of an alternate screen character moving on a collision course with the primary screen character and requiring appropriate user response prior to collision, an alternate screen character moving in a tangential manner and requiring appropriate user response prior to the distracter leaving the screen, alternating color change of a primary character and requiring appropriate user response within a predetermined length of time, and an auditory prompt and requiring appropriate user response within a predetermined length of time.

36. The apparatus of claim 35 wherein software within the system requires the user to respond to the distracters by pressing a key on the keyboard.

37. The apparatus of claim 35 wherein software within the system can interrupt execution of the attention training exercise upon failure of the user to respond in the appropriate manner.

38. The apparatus of claim 1, wherein:
said attention training subsystem includes software within said computer system to implement at least one attention training exercise on said display; and wherein
said behavior modification support subsystem includes software within said computer system cooperating with the attention training software to integrate on-screen and auditory randomized distracters into the attention training exercise during execution, the distracters requiring the user to respond in an appropriate manner; and wherein
said computer system includes software to record the response of the user;
whereby response requiring and recording provide an automated coaching function where the attention of the user to the attention training exercise is determined by whether the user does or does not respond to a distracter.

39. The apparatus of claim 38 wherein software within the system requires the user to respond to the distracters by pressing a key on the keyboard.

40. The apparatus of claim 38 wherein software within the system can interrupt execution of the attention training exercise upon failure of the user to respond in the appropriate manner.

41. The apparatus of claim 1, wherein:
said attention training subsystem includes software within said computer system to implement at least one attention training exercise on said display; and wherein
said behavior modification support subsystem includes software within said computer system cooperating with the attention training software to integrate on-screen and auditory randomized distracters into the attention training exercise during execution, the distracters requiring the user to respond in an appropriate manner, and the distracters being selected from the group consisting of an alternate screen character moving on a collision course with the primary screen character and requiring appropriate user response prior to collision, an alternate screen character moving in a tangential manner and requiring appropriate user response prior to the distracter leaving the screen, alternating color change of a primary character and requiring appropriate user response within a predetermined length of time, and an auditory prompt and requiring appropriate user response within a predetermined length of time; and wherein
said computer system includes software to record the response of the user;
whereby response requiring and recording provide an automated coaching function where the attention of the user to the attention training exercise is determined by whether the user does or does not respond to a distracter.

42. The apparatus of claim 1, wherein said computer system includes software to require the user to login to identify a saved dataset and to begin a session.

43. The apparatus of claim 1, wherein said computer system includes software to require the user to login to identify a saved dataset and to begin a session, the login requiring at least one of identification of a coach for this session and identification of distraction level for an environment presented to the user.

44. The apparatus of claim 1, wherein said coaching support subsystem includes software within said computer system to provide a coach with a general reminder of the roles and responsibilities which the coach is expected to perform.

45. The apparatus of claim 1, wherein said computer system includes software to display a journal and progress chart from the previous session for a coach to review with the user.

46. The apparatus of claim 1, wherein said computer system includes software to present a form for entry by a coach of anecdotal information for a current session.

47. The apparatus of claim 1, wherein said computer system includes software for maintaining ongoing communication with parents and teachers of the user for external reinforcement of a selected behavioral objective.

48. The apparatus of claim 1, wherein said computer system includes software for maintaining ongoing communication with parents and teachers of the user for external reinforcement of a current behavioral objective, including communications which are automatically pre filled-in with a standard message relating to the current behavioral objective.

49. The apparatus of claim 47, wherein said computer system includes software for storing records of communications in said database.

50. The apparatus of claim 47, wherein the software for maintaining ongoing communication with parents and teachers of the user generates communications in a letter form that can be modified by a coach and then printed.

51. The apparatus of claim 47, wherein the software for maintaining ongoing communication with parents and teachers of the user generates communications in an e-mail form that can be modified by a coach and then sent.

52. The apparatus of claim 51, wherein the software for maintaining ongoing communication with parents and teachers of the user automatically retrieves e-mail addresses of the parents and teachers from a database record for the user, if available.

53. The apparatus of claim 51, wherein the software for maintaining ongoing communication with parents and teachers of the user, in the event the e-mail addresses of the parents and teachers are not available in a database record for the user, prompts for e-mail addresses for current use and saves the e-mail address in the database record for the user, whereby e-mail addresses need be entered only one time.

54. The apparatus of claim 1, wherein said computer system includes software for presenting a contact record form for input of notes from personal contact of a coach with parents and teachers of the user and storing information from the form in said database.

55. The apparatus of claim 1, wherein said computer system includes software for displaying saved coaching support records.

56. The apparatus of claim 1, wherein said computer system includes software for generating a user status summary indicating which coaching support items are currently up to date and which coaching support items are yet to be completed.

57. The apparatus of claim 1, wherein said computer system includes software for generating a user status summary indicating which coaching support items are currently up to date and which coaching support items are yet to be completed, the user status summary allowing direct selection of items needing completion, and for, once at least one item needing completion having been selected, directing a coach to an appropriate form for completing the selected coaching support item.

58. The apparatus of claim 1, wherein said computer system includes software for generating a user status summary indicating which coaching support items are currently up to date and which coaching support items are yet to be completed, and for prompting a coach, upon leaving the user status summary, to complete any coaching support items that are yet to be completed.

59. The apparatus of claim 1, wherein said coaching support subsystem includes software within said computer system which allows coaching support controls to be configured.

60. The apparatus of claim 1, wherein said coaching support subsystem includes software within said computer system which allows coaching support controls to be configured for all uses of the said apparatus at a single installed site.

61. The apparatus of claim 1, wherein said coaching support subsystem includes software within said computer system which allows coaching support controls to be configured for a specific coach and wherein the configuration will apply to all sessions where that coach is specified at a login.

62. The apparatus of claim 1, wherein said coaching support subsystem includes software within said computer system which allows coaching support controls to be configured for a specific user and wherein the configuration will apply to all sessions undertaken by that user.

63. The apparatus of claim 1, wherein said coaching support subsystem includes software within said computer system which allows coaching support controls to be configured, including setting whether audio coaching or training prompts will be used.

64. The apparatus of claim 1, wherein said coaching support subsystem includes software within said computer system which allows coaching support controls to be configured, including whether or not any particular coaching support or behavior modification support item will be required.

65. The apparatus of claim 1, wherein said coaching support subsystem includes software within said computer system which allows coaching support controls to be configured, including setting how many sessions are required before any particular coaching support or behavior modification support item will be required or displayed.

66. Computerized training apparatus comprising:
a computer system including a display and an input device;
an attention training subsystem including a device for measuring electrical activity of the brain of a user and software within said computer system to provide real-time feedback to the user of the user's state of attention; and
a behavior modification support subsystem including a database within said computer system for storage of data relating to behavior and behavioral goals, and computer software that presents automated forms for entry of the data into said database and retrieval and reporting the data from said database, the data including data to support one or more of behavioral rating scales, goal setting records, session journals, and progress charts.

67. The apparatus of claim 66, wherein said attention training subsystem includes software within said computer system to implement at least one attention training exercise.

68. The apparatus of claim 67, wherein said attention training subsystem includes software within said computer system to implement a plurality of specific attention training exercises which are selected.

69. The apparatus of claim 67, wherein said attention training subsystem includes software within said computer system to implement specific attention training exercises which are selected and executed either for a specific duration or until a particular exercise is completed.

70. The apparatus of claim 67, wherein said attention training subsystem includes software within said computer system to implement at least one attention training exercise which is a cognitive skills exercise.

71. The apparatus of claim 70, wherein said attention training subsystem includes software within said computer system to implement at least one cognitive skills exercise selected from the group consisting of a short-term memory exercise, an attention stamina exercise, a task completion exercise, and a decision making exercise.

72. The apparatus of claim 68, wherein said computer system includes software to provide audio prompting to the user of an objective and method of play for the selected attention training exercise prior to beginning execution of the selected attention training exercise.

73. The apparatus of claim 66, wherein said database contains a behavioral rating scale which includes a list of commonly exhibited behaviors observed in people with attention problems.

74. The apparatus of claim 66, wherein said computer system includes software to provide a prompt to select a user behavioral objective from a list of commonly exhibited behaviors observed in people with attention problems.

75. The apparatus of claim 67, wherein
said database contains a behavioral rating scale which includes a list of commonly exhibited behaviors observed in people with attention problems; and wherein
said behavior modification support subsystem includes software within said computer system to display said behavioral rating scale following completion of execution of the attention training exercise.

76. The apparatus of claim 75 wherein said behavior modification support subsystem includes software within said computer system to allow entry via said input device of behavioral rating scale data into said database including the total number of observed instances of each exhibited behavior during execution of the attention training exercise.

77. The apparatus of claim 75 wherein said behavior modification support subsystem includes software within said computer system to allow entry via said input device of behavioral rating scale data into said database including the total number of observed instances of each exhibited behavior during execution of the attention training exercise and an identification of a coach observing the user during execution of the attention training exercise.

78. The apparatus of claim 76 wherein said behavior modification support subsystem includes software within said computer system to allow review of behavioral rating scale data previously entered into said database including the total number of observed instances of each exhibited behavior during a previous execution of the attention training exercise.

79. The apparatus of claim 78 wherein said behavior modification support subsystem includes software within said computer system to allow review of behavioral rating scale data previously entered into said database including the total number of observed instances of each exhibited behavior during a previous execution of the attention training exercise by presenting a multiple choice selector which lists only those attention training exercises executed during a session.

80. The apparatus of claim 76 wherein
said database contains a permanent data record of at least one user; and wherein
said behavior modification support subsystem includes software within said computer system to allow storage within said database of the behavioral rating scale data including the total number of observed instances of each exhibited behavior during execution of the attention training exercise as at least part of the permanent data record of the at least one user.

81. The apparatus of claim 73, wherein said database contains a behavioral rating scale which further includes a behavioral objective chosen for a session.

82. The apparatus of claim 73, wherein said behavior modification support subsystem includes software within said computer system to cause display of behavioral rating scale data as a template for selecting a behavioral objective.

83. The apparatus of claim 66, wherein said computer system includes software to provide a prompt to select a user behavioral objective after completion of a predetermined number of sessions.

84. The apparatus of claim 66, wherein said behavior modification support subsystem includes software within said computer system to provide a prompt to select a user behavioral objective, the prompt including at least one of totals of previously recorded exhibited behaviors from prior sessions depicted on a behavioral rating scale, and the behavioral objective chosen in an immediately prior session.

85. The apparatus of claim 84, wherein said behavior modification support subsystem includes software within said computer system to provide a warning that no behavioral objective is set for a current session in the event selection of a behavioral objective is skipped.

86. The apparatus of claim 66, wherein said behavior modification support subsystem includes software within said computer system to provide a prompt to select a user behavioral objective after completion of a selected number of prior sessions, the prompt including at least one of totals of previously recorded exhibited behaviors from prior sessions depicted on a behavioral rating scale, and to permit selection of the number of prior sessions included in the totals of previously recorded exhibited behaviors.

87. The apparatus of claim 66, wherein said behavior modification support subsystem includes software within said computer system to display a progress chart which shows the number of exhibited behaviors recorded with reference to a selected behavioral objective.

88. The apparatus of claim 66, wherein
said attention training subsystem includes software within said computer system to implement a plurality of specific attention training exercises; and wherein
said behavior modification support subsystem includes software within said computer system to display a progress chart which selectively shows the number of exhibited behaviors as recorded after each attention training exercises executed during a current session.

89. The apparatus of claim 66, wherein said behavior modification support subsystem includes software within said computer system to display, during a training session for which a particular behavior objective is selected, a progress chart which selectively shows the total number of exhibited behaviors as recorded during prior sessions for which the same behavioral objective was selected.

90. The apparatus of claim 66, wherein said behavior modification support subsystem includes software within said computer system to display a progress chart which shows the number of exhibited behaviors recorded with reference to a selected behavioral objective and which includes a valuation of the progress made by the user in controlling a selected behavioral objective.

91. The apparatus of claim 66, wherein said behavior modification support subsystem includes software within said computer system to present at the end of each session a journal entry form prompting the user to reflect on progress made with reference to a selected behavioral objective.

92. The apparatus of claim 66, wherein said behavior modification support subsystem includes software within said computer system to, on the same screen at the end of each session,
display a progress chart for visual review of progress made by the user based on the number of exhibited behaviors observed and recorded with reference to a selected behavioral objective, and
present a journal entry form prompting the user to reflect on progress made with reference to a selected behavioral objective.

93. The apparatus of claim 91 wherein said behavior modification support subsystem includes software within said computer system to present a journal entry form which also allows a behavioral objective to be suggested for the next session.

94. The apparatus of claim 91 wherein said behavior modification support subsystem includes software within said computer system to display the journal at the beginning of the next session to facilitate review of objectives previously established for that session.

95. The apparatus of claim 66, wherein said behavior modification support subsystem includes software within said computer system to maintain a rating scale form for periodic entry of external subjective behavioral rating assessments of the user, the rating scale form including a list of commonly exhibited behaviors observed in people with attention problems.

96. The apparatus of claim 66, wherein said behavior modification support subsystem includes software within said computer system to provide audio and visual prompting to the user of general attention training behavioral guidelines prior to attention training.

97. The apparatus of claim 66, wherein:
said attention training subsystem includes software within said computer system to implement at least one attention training exercise; and wherein
said behavior modification support subsystem includes software within said computer system cooperating with the attention training software to integrate on-screen and auditory randomized distracters into the attention training exercise during execution.

98. The apparatus of claim 97 wherein software within the system requires the user to respond to the distracters in an appropriate manner.

99. The apparatus of claim 97 wherein software within the system requires the user to respond to the distracters by pressing a key on the keyboard.

100. The apparatus of claim 66, wherein:
said attention training subsystem includes software within said computer system to implement at least one attention training exercise; and wherein
said behavior modification support subsystem includes software within said computer system cooperating with the attention training software to integrate on-screen and auditory randomized distracters into the attention training exercise during execution, the distracters being selected from the group consisting of an alternate screen character moving on a collision course with the primary screen character and requiring appropriate user response prior to collision, an alternate screen character moving in a tangential manner and requiring appropriate user response prior to the distracter leaving the screen, alternating color change of a primary character and requiring appropriate user response within a predetermined length of time, and an auditory prompt and requiring appropriate user response within a predetermined length of time.

101. The apparatus of claim 100 wherein software within the system requires the user to respond to the distracters by pressing a key on the keyboard.

102. The apparatus of claim 100 wherein software within the system can interrupt execution of the attention training exercise upon failure of the user to respond in the appropriate manner.

103. The apparatus of claim 66, wherein:
said attention training subsystem includes software within said computer system to implement at least one attention training exercise on said display; and wherein
said behavior modification support subsystem includes software within said computer system cooperating with the attention training software to integrate on-screen and auditory randomized distracters into the attention training exercise during execution, the distracters requiring the user to respond in an appropriate manner; and wherein
said computer system includes software to record the response of the user;
whereby response requiring and recording provide an automated coaching function where the attention of the user to the attention training exercise is determined by whether the user does or does not respond to a distracter.

104. The apparatus of claim 103 wherein software within the system requires the user to respond to the distracters by pressing a key on the keyboard.

105. The apparatus of claim 103 wherein software within the system can interrupt execution of the attention training exercise upon failure of the user to respond in the appropriate manner.

106. The apparatus of claim 66, wherein:
said attention training subsystem includes software within said computer system to implement at least one attention training exercise on said display; and wherein
said behavior modification support subsystem includes software within said computer system cooperating with the attention training software to integrate on-screen and auditory randomized distracters into the attention training exercise during execution, the distracters requiring the user to respond in an appropriate manner, and the distracters being selected from the group consisting of an alternate screen character moving on a collision course with the primary screen character and requiring appropriate user response prior to collision, an alternate screen character moving in a tangential manner and requiring appropriate user response prior to the distracter leaving the screen, alternating color change of a primary character and requiring appropriate user response within a predetermined length of time, and an auditory prompt and requiring appropriate user response within a predetermined length of time; and wherein
said computer system includes software to record the response of the user;
whereby response requiring and recording provide an automated coaching function where the attention of the user to the attention training exercise is determined by whether the user does or does not respond to a distracter.

107. The apparatus of claim 66, wherein said computer system includes software to require the user to login to identify a saved dataset and to begin a session.

108. The apparatus of claim 66, wherein said computer system includes software for maintaining ongoing communication with parents and teachers of the user for external reinforcement of a selected behavioral objective.

109. The apparatus of claim 108, wherein the software for maintaining ongoing communication with parents and teachers of the user generates communications in a letter form that can be modified by a coach and then printed.

110. The apparatus of claim 108, wherein the software for maintaining ongoing communication with parents and teachers of the user generates communications in an e-mail form that can be modified by a coach and then sent.

111. The apparatus of claim 110, wherein the software for maintaining ongoing communication with parents and teachers of the user automatically retrieves e-mail addresses of the parents and teachers from a database record for the user, if available.

112. The apparatus of claim 1110, wherein the software for maintaining ongoing communication with parents and teachers of the user, in the event the e-mail addresses of the parents and teachers are not available in a database record for the user, prompts for e-mail addresses for current use and saves the e-mail address in the database record for the user, whereby e-mail addresses need be entered only one time.

113. The apparatus of claim 66, wherein said computer system includes software for maintaining ongoing communication with parents and teachers of the user for external reinforcement of a current behavioral objective, including communications which are automatically pre filled-in with a standard message relating to the current behavioral objective.

114. The apparatus of claim 108, wherein said computer system includes software for storing records of communications in said database.

115. The apparatus of claim 66, wherein said behavior modification support subsystem includes software within said computer system which allows behavior modification support controls to be configured, including whether or not any particular behavior modification support item will be required.

116. The apparatus of claim 66, wherein said behavior modification support subsystem includes software within said computer system which allows behavior modification support controls to be configured, including setting how many sessions are required before any particular behavior modification support item will be required or displayed.

117. Computerized training apparatus comprising:
a computer system including a display, an input device and a sound output device;
an attention training subsystem including a device for measuring electrical activity of the brain of a user and software within said computer system to provide real-time feedback to the user of the user's state of attention; and
a coaching support subsystem including one or more of software within said computer system to generate coaching audio prompts through said sound output device, software within said computer system to generate training audio prompts through said sound output device, and software within said computer system to generate letters and e-mail messages for teambuilding support.

118. The apparatus of claim 117, wherein said attention training subsystem includes software within said computer system to implement at least one attention training exercise.

119. The apparatus of claim 118, wherein said attention training subsystem includes software within said computer system to implement a plurality of specific attention training exercises which are selected.

120. The apparatus of claim 1 18, wherein said attention training subsystem includes software within said computer system to implement specific attention training exercises which are selected and executed either for a specific duration or until a particular exercise is completed.

121. The apparatus of claim 1 18, wherein said attention training subsystem includes software within said computer system to implement at least one attention training exercise which is a cognitive skills exercise.

122. The apparatus of claim 121, wherein said attention training subsystem includes software within said computer system to implement at least one cognitive skills exercise selected from the group consisting of a short-term memory exercise, an attention stamina exercise, a task completion exercise, and a decision making exercise.

123. The apparatus of claim 119, wherein said computer system includes software to provide audio prompting to the user of an objective and method of play for the selected attention training exercise prior to beginning execution of the selected attention training exercise.

124. The apparatus of claim 117, wherein said coaching support subsystem includes software within said computer system to maintain a rating scale form for periodic entry of external subjective behavioral rating assessments of the user, the rating scale form including a list of commonly exhibited behaviors observed in people with attention problems.

125. The apparatus of claim 117, wherein said coaching support subsystem includes software within said computer system to provide audio and visual prompting to the user of general attention training behavioral guidelines prior to attention training.

126. The apparatus of claim 117, wherein:
said attention training subsystem includes software within said computer system to implement at least one attention training exercise; and wherein
said coaching support subsystem includes software within said computer system cooperating with the attention training software to integrate on-screen and auditory randomized distracters into the attention training exercise during execution.

127. The apparatus of claim 126 wherein software within the system requires the user to respond to the distracters in an appropriate manner.

128. The apparatus of claim 126 wherein software within the system requires the user to respond to the distracters by pressing a key on the keyboard.

129. The apparatus of claim 117, wherein:
said attention training subsystem includes software within said computer system to implement at least one attention training exercise on said display; and wherein
said coaching support subsystem includes software within said computer system cooperating with the attention training software to integrate on-screen and auditory randomized distracters into the attention training exercise during execution, the distracters requiring the user to respond in an appropriate manner; and wherein
said computer system includes software to record the response of the user;
whereby response requiring and recording provide an automated coaching function where the attention of the user to the attention training exercise is determined by whether the user does or does not respond to a distracter.

130. The apparatus of claim 129 wherein software within the system requires the user to respond to the distracters by pressing a key on the keyboard.

131. The apparatus of claim 129 wherein software within the system can interrupt execution of the attention training exercise upon failure of the user to respond in the appropriate manner.

132. The apparatus of claim 117, wherein:
said attention training subsystem includes software within said computer system to implement at least one attention training exercise on said display; and wherein
said coaching support subsystem includes software within said computer system cooperating with the attention training software to integrate on-screen and auditory randomized distracters into the attention training exercise during execution, the distracters requiring the user to respond in an appropriate manner, and the distracters being selected from the group consisting of an alternate screen character moving on a collision course with the primary screen character and requiring appropriate user response prior to collision, an alternate screen character moving in a tangential manner and requiring appropriate user response prior to the distracter leaving the screen, alternating color change of a primary character and requiring appropriate user response within a predetermined length of time, and an auditory prompt and requiring appropriate user response within a predetermined length of time; and wherein
said computer system includes software to record the response of the user;
whereby response requiring and recording provide an automated coaching function where the attention of the user to the attention training exercise is determined by whether the user does or does not respond to a distracter.

133. The apparatus of claim 117, wherein said computer system includes software to require the user to login to identify a saved dataset and to begin a session.

134. The apparatus of claim 117, wherein said computer system includes software to require the user to login to identify a saved dataset and to begin a session, the login requiring at least one of identification of a coach for this session and identification of distraction level for an environment presented to the user.

135. The apparatus of claim 117, wherein said coaching support subsystem includes software within said computer system to provide a coach with a general reminder of the roles and responsibilities which the coach is expected to perform.

136. The apparatus of claim 117, wherein said computer system includes software to display a journal and progress chart from the previous session for a coach to review with the user.

137. The apparatus of claim 117, wherein said computer system includes software to present a form for entry by a coach of anecdotal information for a current session.

138. The apparatus of claim 117, wherein said computer system includes software for maintaining ongoing communication with parents and teachers of the user for external reinforcement of a selected behavioral objective.

139. The apparatus of claim 117, wherein said computer system includes software for maintaining ongoing communication with parents and teachers of the user for external reinforcement of a current behavioral objective, including communications which are automatically pre filled-in with a standard message relating to the current behavioral objective.

140. The apparatus of claim 138, wherein said computer system includes software for storing records of communications in said database.

141. The apparatus of claim 138, wherein the software for maintaining ongoing communication with parents and teachers of the user generates communications in a letter form that can be modified by a coach and then printed.

142. The apparatus of claim 138, wherein the software for maintaining ongoing communication with parents and teachers of the user generates communications in an e-mail form that can be modified by a coach and then sent.

143. The apparatus of claim 142, wherein the software for maintaining ongoing communication with parents and teachers of the user automatically retrieves e-mail addresses of the parents and teachers from a database record for the user, if available.

144. The apparatus of claim 142, wherein the software for maintaining ongoing communication with parents and teachers of the user, in the event the e-mail addresses of the parents and teachers are not available in a database record for the user, prompts for e-mail addresses for current use and saves the e-mail address in the database record for the user, whereby e-mail addresses need be entered only one time.

145. The apparatus of claim 117, wherein said computer system includes software for presenting a contact record form for input of notes from personal contact of a coach with parents and teachers of the user, and storing information from the form in said database.

146. The apparatus of claim 117, wherein said computer system includes software for displaying saved coaching support records.

147. The apparatus of claim 117, wherein said computer system includes software for generating a user status summary indicating which coaching support items are currently up to date and which coaching support items are yet to be completed.

148. The apparatus of claim 117, wherein said computer system includes software for generating a user status summary indicating which coaching support items are currently up to date and which coaching support items are yet to be completed, the user status summary allowing direct selection of items needing completion, and for, once at least one item needing completion having been selected, directing a coach to an appropriate form for completing the selected coaching support item.

149. The apparatus of claim 117, wherein said computer system includes software for generating a user status summary indicating which coaching support items are currently up to date and which coaching support items are yet to be completed, and for prompting a coach, upon leaving the user status summary, to complete any coaching support items that are yet to be completed.

150. The apparatus of claim 117, wherein said coaching support subsystem includes software within said computer system which allows coaching support controls to be configured.

151. The apparatus of claim 117, wherein said coaching support subsystem includes software within said computer system which allows coaching support controls to be configured for all uses of the said apparatus at a single installed site.

152. The apparatus of claim 117, wherein said coaching support subsystem includes software within said computer system which allows coaching support controls to be configured for a specific coach and wherein the configuration will apply to all sessions where that coach is specified at a login.

153. The apparatus of claim 117, wherein said coaching support subsystem includes software within said computer system which allows coaching support controls to be configured for a specific user and wherein the configuration will apply to all sessions undertaken by that user.

154. The apparatus of claim 117, wherein said coaching support subsystem includes software within said computer system which allows coaching support controls to be configured, including setting whether audio coaching or training prompts will be used.

155. The apparatus of claim 117, wherein said coaching support subsystem includes software within said computer system which allows coaching support controls to be configured, including whether or not any particular coaching support item will be required.

156. The apparatus of claim 117, wherein said coaching support subsystem includes software within said computer system which allows coaching support controls to be configured, including setting how many sessions are required before any particular coaching support item will be required or displayed.
